(19) United States
(12) Patent Application Publication
(10) Pub. No.: US 2020/0151675 A1
(43) Pub. Date: May 14, 2020

(54) Scheduling System and Method

(71) Applicant: Mark Jonathon Joseph McCormack, Bonnyville (CA)

(72) Inventor: Mark Jonathon Joseph McCormack, Bonnyville (CA)

(21) Appl. No.: 16/517,646

(22) Filed: Jul. 21, 2019

Related U.S. Application Data
(63) Continuation of application No. 15/129,527, filed on Sep. 27, 2016, now abandoned.
(60) Provisional application No. 61/975,264, filed on Apr. 4, 2014.
(60) Provisional application No. 61/975,264, filed on Apr. 4, 2014.

(51) Int. Cl. G06Q 10/10; G09G 5/00; G06Q 10/06; G06T 11/20; G06F 3/0484

(52) U.S. Cl. CPC G06Q 10/1097; G09G 5/00; G06Q 10/06; G06F 2203/04806; G06F 3/04845; G09G 2340/14; G06T 11/206

(57) ABSTRACT

A scheduling system is provided, including: a server hosting a database, the database including a record associated with a task, the task having a deadline; and a display, the display associated with a processor in communication with the server; wherein the processor is configured to display on the display circle having a plurality of rings, the rings corresponding to days in the future, the task indicated as a node positioned in the ring associated with the deadline.

### RELATED APPLICATIONS

This application is a continuation of U.S. application Ser. No. 15/129,527 filed Sep. 27, 2016 and claims the benefit of the filing date of Ser. No. 15/129,527. U.S. Ser. No. 15/129,527 is a national stage application based on International Application PCT/CA2015/000245 filed on Apr. 7, 2015 and was filed under 35 USC 363 and 371 and which claimed benefit of the filing date of U.S. Provisional Patent Application No. 61/975,264, filed Apr. 4, 2014. This application claims the benefit of the filing date of provisional application 61/975,264 and of all the related applications noted above. The contents of U.S. application Ser. No. 15/129,527, PCT/CA2015/000245, and 61/975,264 are hereby incorporated by reference.

### FIELD OF THE INVENTION

The system and method according to the invention relates to scheduling systems, and more particularly to scheduling systems with a display component for users.

### BACKGROUND OF THE INVENTION

High quality scheduling systems are often expensive, limited and list based. They rely on personal motivation or need to accomplish tasks. They lack both a social networking component to involve other parties and a method of display that clearly demarcates the tasks as well as other information.

### SUMMARY OF THE INVENTION

The system according to the invention uses visuals to display lists of information in an intuitive and easy to process medium for users. The system allows users to see micro-details about scheduled tasks while also being able to coordinate with related macro-details, with both individuals and groups. The user profile and data generated by the system also create incentives that increase productivity of users.

The system according to the invention includes a set of methods and processes that organize information including but not limited to a rates ticker, a user profile (also referred to herein as a “hero profile”), a task galaxy, a task universe, an administration tab, an action feed a main menu as particularized below.

The task galaxy is a visual representation of a schedule (for example a user's or organizations schedule) containing internal layers, such as rings (in the case the task galaxy is represented as a circle) that can represent different variables. Each ring contains a node, referred to as a “task”. Each task can be linked to other tasks. Task galaxies can be updated and the size, shape and location of data (or nodes) displayed in the task galaxy can be changed.

At the center of the task galaxy is a representation of an entity that operates the galaxy and which can subdivide the galaxy into sections. Task galaxies can be divided into sections using a divider mechanism, including but not limited to a line extending from the edge of the outer ring of the galaxy to the inner ring. In the case that the rings in the task galaxy correspond to time and date variables, the outer ring can correspond to the current date and time and each ring moving toward the center of the task galaxy can represent a day, hour, year, or month in the future (alternatively the inner ring could represent the current time and date and the outer ring is the future).

Each task includes one or more task actions that can be performed and the task can be updated as an action is performed, the updated task then indicated visually in the task galaxy. In an embodiment of the invention, the task galaxy can be viewed at a plurality of levels, allowing users to zoom in or out of a particular task galaxy. Thus different information can be displayed at different zoom levels of the task galaxy.

Users can “own”, and thereby operate more than one task galaxies and create each with an entity at the center identifying the galaxy for tasks related an individual, an organization, or some other entity. The task galaxy may contain other task galaxies in relation to one another.

The system may also include a main menu that can be used to track task actions that the user performs. Tasks contain information that users use to perform actions. Such actions include rates that assign a numerical value to the action type. Each time a user performs an action the rates ticker updates based on the rate associated with the action.

The system may include an award panel that lists and tracks user data and assigns awards to a user based on actions performed in the system, either automatically or through an administrator. A user profile (referred to in the Figures as a “hero profile”) and rates ticker form an information base to assist users in deciding what actions to take and to assist administrators in determining what privileges or awards to assign to users. The system may contain a news feed (also referred to as an action feed) that updates based on filters provided by a user from data generated from task actions performed in the system. The news feed may be visually displayed in task galaxies within a task universe, which is a plurality of task galaxies. Information displayed to non-operators of a task galaxy is controlled by privacy settings set by the user who is the operator of the task gallery.

Users may perform transactions. The system may include one or both of a THistory and RHistory page to track interactions between users, such as but not limited to, transaction type (also referred to as Task Action Type), date of transaction, or whether the transaction has been processed (e.g. accepted, denied or commented on) by the other user. Actions performed in the THistory and RHistory pages update the status of tasks in the task galaxy and also send notifications to any other users involved or connected to the task or who have commented.

The system may further include an information archive of the history of the users, and trends and tasks. Users can create tasks and complete task trees. Such task trees (which may contain several tasks) can be saved in the information archive as a rendition. Other users can then see all the comments and information associated with the task tree and can implement the same task tree in task galaxy, and may make changes and create a similar but different version that is also linked and tracked to the original tree in the information archive.

### DESCRIPTION OF THE DRAWINGS

FIG. 1 shows a representation of an embodiment of a main screen user interface for the system according to the invention.

FIGS. 1A, 1B and 1C show enlarged sections of FIG. 1 and are respectively a representation of an embodiment of an interactive dynamic task galaxy information system, an action menu and a search function according to the invention.

FIGS. 2, 2A and 2B shows a representation of an embodiment of a score layout according to the invention.

FIGS. 3, 3A, and 3B shows a representation of an embodiment of a display of user scores and averages according to the invention.

FIG. 4 shows representations of a graphs representing user activity according to the invention.

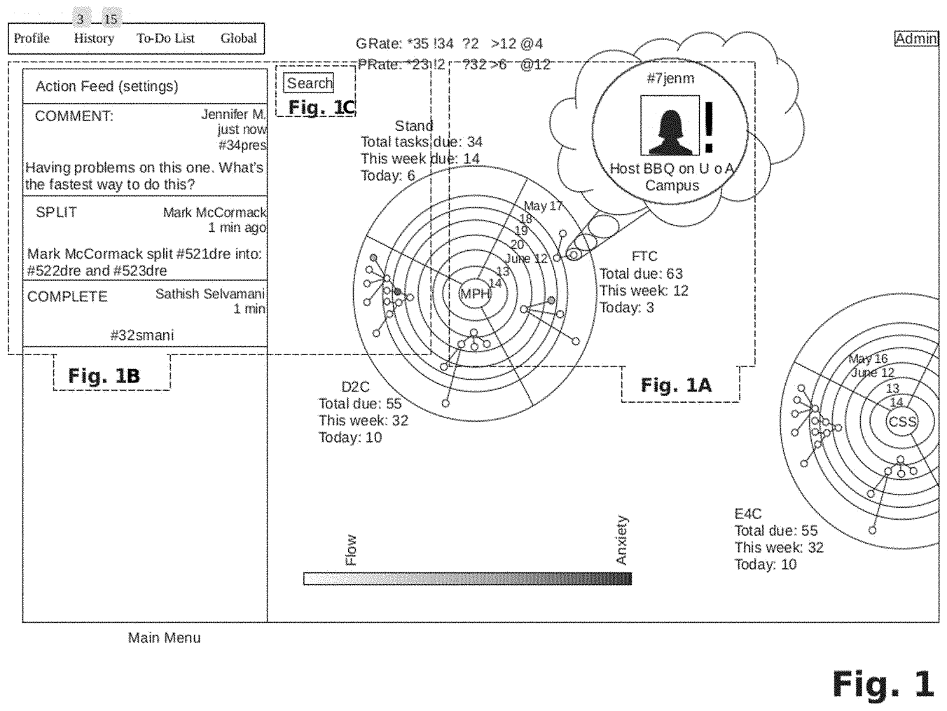

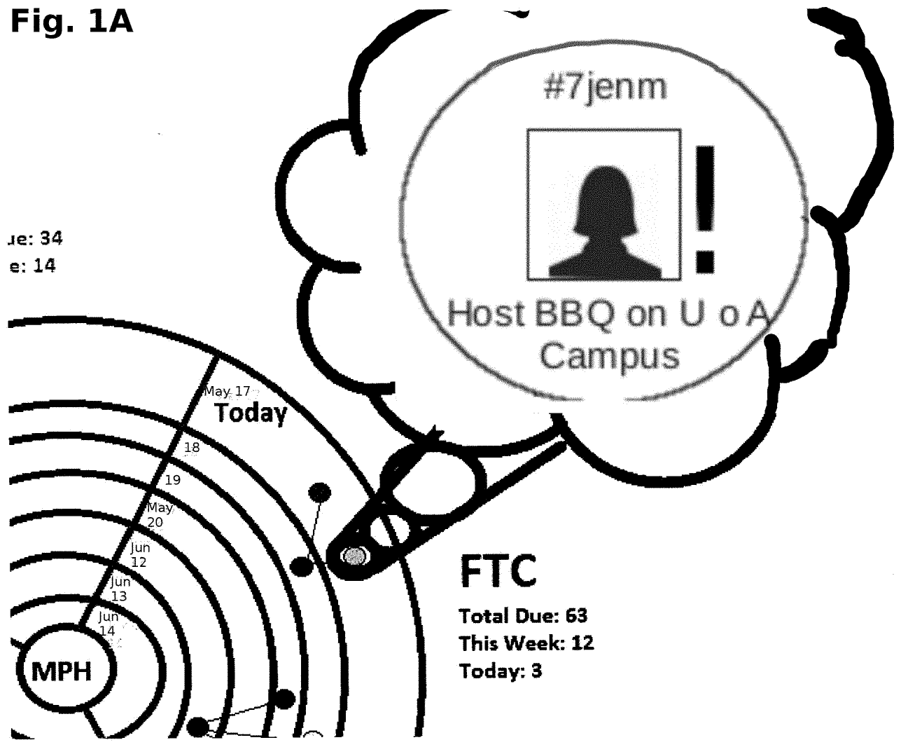

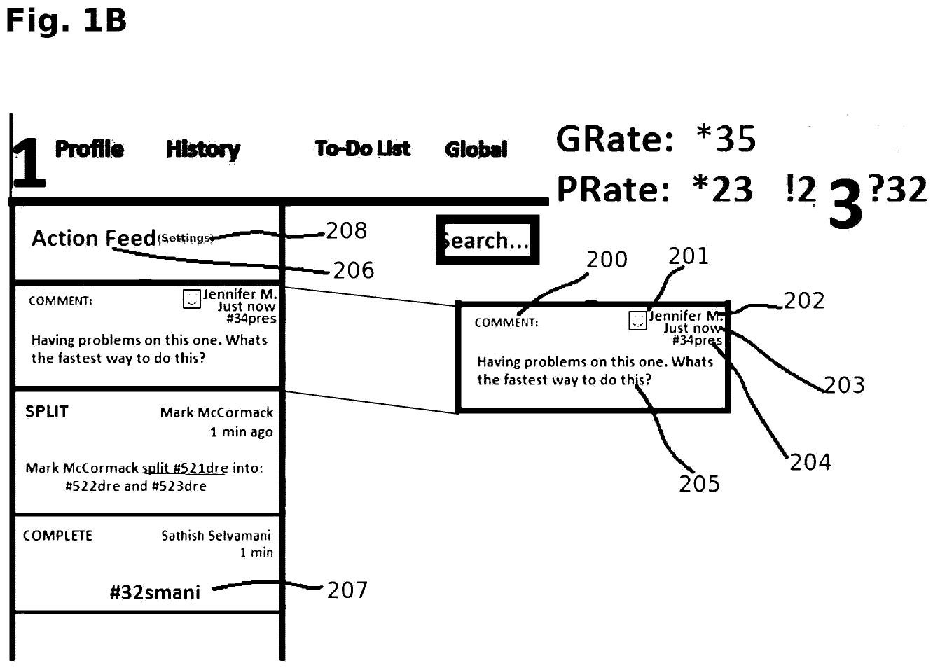

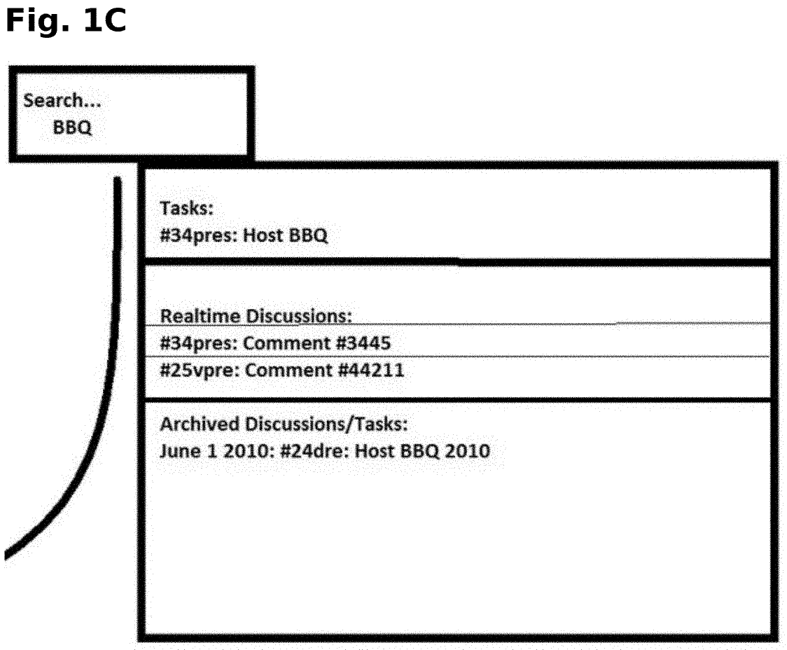

FIG. 1C shows a representation of an embodiment of a search drop down menu with menu according to the invention.

FIG. 5 shows a representation of an embodiment of a user status report according to the invention.

FIG. 6 shows a representation of an embodiment of a user ownership status report according to the invention.

FIG. 7 shows a representation of an embodiment of a profile page of analytics of an organization according to the invention.

FIG. 7A shows a representation of an embodiment of an analytics report for a group according to the invention.

FIGS. 7B, 7C, 7D and 7E shows representations of embodiments of graphs showing performance according to the invention.

FIG. 7F shows representations of an embodiment of displays of information or an organization according to the invention.

FIG. 1B shows an embodiment of a display of an action feed according to the invention.

FIG. 8 displays an embodiment of a settings menu of an action feed according to the invention.

FIG. 9 displays an embodiment of a rate ticker according to the invention.

FIGS. 10, 10A and 10B display an embodiment of an administrator display according to the invention.

FIGS. 11, 11A, 11B display an embodiment of an administrator display relating to awards according to the invention.

FIG. 12 displays an embodiment of a row of variables and statistics about users of the system according to the invention.

FIGS. 13, 13A and 13B displays an embodiment of a detailed view of a Task Galaxy, its rings and a TAT menu according to the invention.

FIG. 13C displays an embodiment of a display showing information related to an Org Galaxy profile according to the invention.

FIG. 14 displays an embodiment of a task menu with viewable and changeable task variables and attributes according to the invention.

FIG. 15 displays an embodiment of a task universe according to the invention.

FIG. 16 displays an embodiment of task action rate balancing equations according to the invention.

FIG. 17 displays an alternative embodiment of a task galaxy according to the invention.

FIGS. 17 and 18 display alternative embodiments of user screens showing tasks galaxies and a task universe respectively.

FIGS. 19 through 19B display embodiments of screen shots showing flow according to the invention.

FIG. 20 display embodiments of screen shots showing a flow channel according to the invention.

FIG. 21 displays a graph representing a task outside the current capability of human knowledge.

FIGS. 22 through 33 display embodiments of an inspiration interface according to the invention.

FIG. 34 displays a sphere representing moments of time and related tasks according to the invention.

FIGS. 35 through 37 display an embodiment of a three dimensional task galaxy according to the invention.

FIGS. 38 through 42 displays an embodiment of a transcendental synchronicity system according to the invention.

FIG. 43 and FIG. 43A displays an embodiment of a dispute resolution system according to the invention.

FIG. 44, FIG. 44A, and FIG. 44B displays an embodiment of a dreamfinder according to the invention.

[This paragraph is intentionally left blank.]

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The methods and displays with the applications described herein are not inherently related to any particular mobile computing device or other apparatus. Various general-purpose systems may be used with programs in accordance with the teachings herein, or it may prove convenient to construct more specialized apparatus to perform the required machine-implemented method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

An embodiment of the invention may be implemented as a method or as a machine readable non-transitory storage medium that stores executable instructions that, when executed by a data processing system, causes the system to perform a method. An apparatus, such as a data processing system, can also be an embodiment of the invention. Other features of the present invention will be apparent from the accompanying drawings and from the detailed description which follows.

### Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “alternate embodiment”, “another embodiment” and the like mean “one or more (but not all) embodiments of the disclosed invention(s)”, unless expressly specified otherwise.

A reference to “another embodiment”, “alternative” embodiment”, “alternate embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains. For example, in a sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract is required under applicable patent legislation. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

The following discussion provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including mobile computing devices, such as smart phones, tablets and phablets, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers, such as mobile computing devices, will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

A computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application in the preferred embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft. The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In one embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links. While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

In the system according to the invention, users operating computer systems, for example a smart phone or tablet, access a service which in turn provides access to the system according to the invention. The service is typically found on one or more servers accessed by the user's computer system via a network. Alternatively the system may be operating on the user's computer system and a network used to access other user's data.

FIGS. 1 through 7F display the main menu of a system according to the invention, by which the user views a display of tasks (also referred to as “GSDs” herein) and related information. Tasks are categorized into “task actions”, which are actions a user can perform on a task. These task actions may include: Creating, Splitting, Pushing, Linking, and Completing.

Creating occurs when user brings a new task into existence. Splitting occurs when a user divides a task into two or more children tasks that are linked to the parent task as dependents. Pushing occurs when a user changes the due date of the task. Linking occurs when a user indicates that another task is dependent upon the task, or that the task is dependent upon another task. Completing occurs when sufficient evidence is provided so that a user can mark a task as finished. These task actions are used to trace the history of interactions as described below and can serve as the basis for a dispute resolution system also as described below.

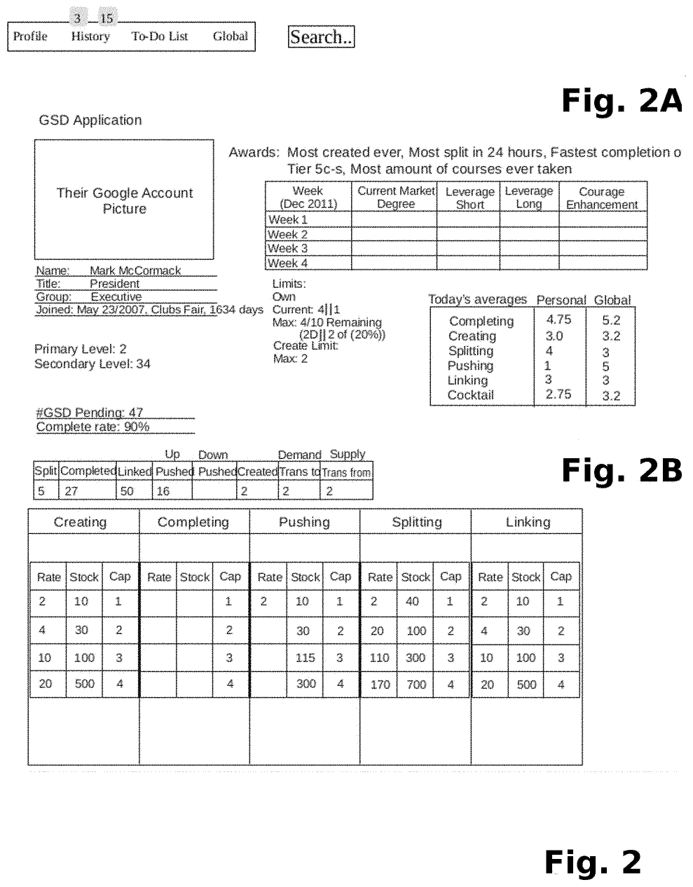

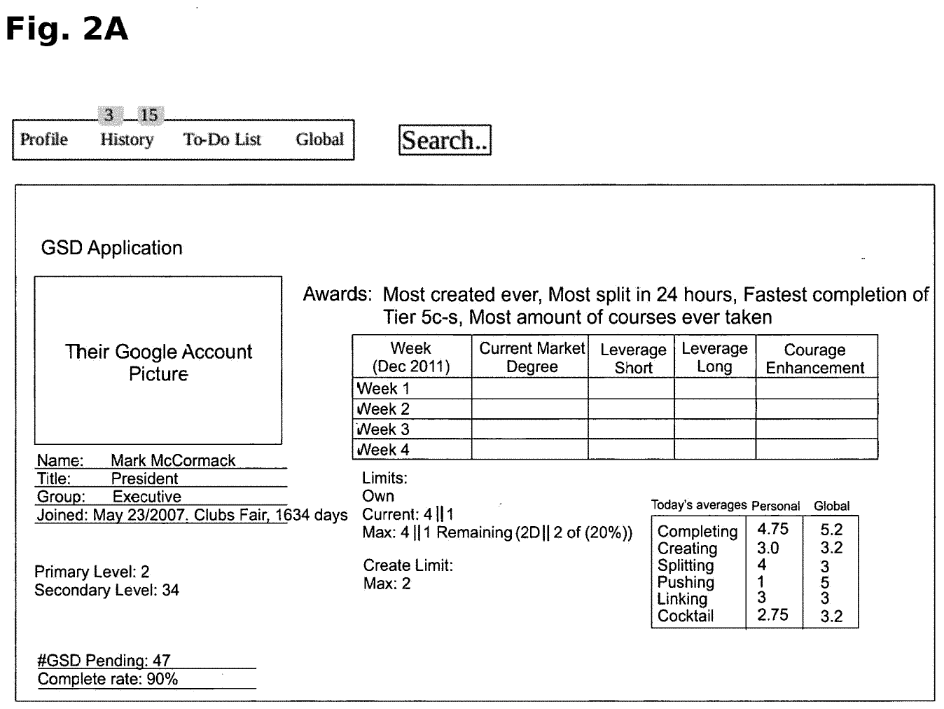

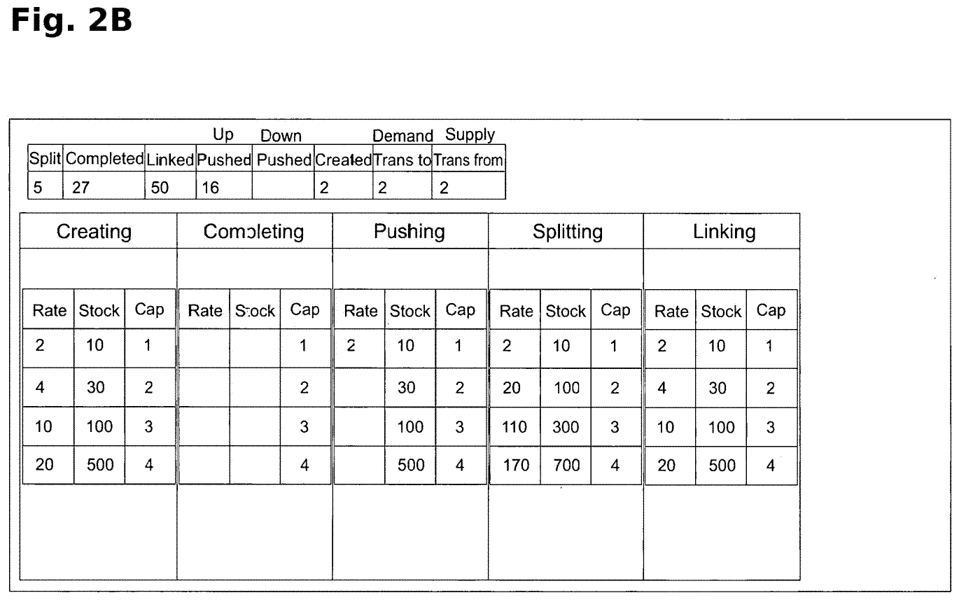

Every time a user performs a task action the system tracks and tallies the action so that the user can see their totals as displayed (as shown in FIG. 2). The system may also provide an incentive for users. In each task action type, there are “rates” that represent a value a user receives each time they complete a task action. The rates differ per type depending on the current “task economy” but each type of task action also has levels, wherein if the user performs a certain amount of each task type (referred to as “stock” in FIG. 5) they reach the next level (referred to as “Cap” in FIG. 5) where provides the user a higher rate (for example “2 points” for each action, or maybe “20 points”).

The incentive system may work as a market in that a user can effectively “buy and sell” tasks, and receive points for each action dependent on the type of action. Each user has a “RHistory and THistory” tab which tracks their task transactions and pending “orders”. The RHistory tab tracks the “buying” and “selling” history of a user. All the actions and transactions the user initiates are tracked here. All other transactions, both for buying from the user and selling to the user, as well as action types that are initiated by other users, are tracked in the THistory tab. The tabs organize what the user has done or wants to do, what the user initiated, and/or what other users are expecting or requesting from the user.

FIG. 1C shows an embodiment of a search function drop down and can be used much like a search in the stock market. If a user searches for a keyword like “BBQ”, which represents a [what does it represent?] three sections pop up: a first section providing information about tasks that include the keyword and that are in the “Pending completion” phase; a second section containing comments (as opposed to GSDs) that include the keyword; and a third section containing archived comments and a list of tasks that are marked as complete and are therefore only available for review. The results are shown in a specific format beginning with an identity code (every user has a unique code which can be accented with organization galaxy codes and custom codes) followed by a short description or a comment number. The archive section will also include dates. All search settings can be customized to include more information in the drop down (such as due dates or by adding another section which may include tasks with an impending due date (for example of the day of the search) to help the user select tasks to do for the day. Other times and dates can also be used along with other searches.

They system tracks the personal users points and the task “universe”, which represents all of the users of the system. The system also performs aggregate task action tasking for the organization galaxies, meaning that for each task action performed in a galaxy, the points associated with the action are calculated, tallied and analyzable in a similar way as others in the universe. Task galaxies are subsections of the universe in terms of the analysis. The system thus provides a balancing mechanism through an incentive system that works both in the universe as a whole and the galaxy. The goal of the incentive system is to balance the supply demand side of the task economy. If there are too many tasks created in the system then the system tries to increase the rate for the “complete” task type by providing more points for completing a task than for creating a new task. Once more users complete the tasks then the system rebalances and starts to increase the rate on the create task type.

FIG. 7 displays an embodiment of a profile page showing some of the analytics related to an organization based on its tasks.

FIG. 7A displays an embodiment of an information display related to an organization's tasks. Section 26 displays the tasks pending and pending limit of the organization. The first number is the number of real created existing tasks that have had the create task action performed and the second number is the pending task limit of all members of the organization as a sum of their personal limits or those dedicated to the specified organization. Each user has a limit to the number of tasks that can be pending at any given time. In this example the 200 denotes not the real tasks currently in existence, but the potential maximum number of tasks in pending status. The number of tasks in pending status can be reduced by completing tasks. Section 27 denotes the number of users that are members of the organization. Section 28 denotes the number of contributing members out of number of members. Not all members may be contributing over a specified time interval that the organization uses to determine participation.

Section 29 denotes the average rating of all tasks performed by the organization and its members as they are rated by the system. Internal quality ratings may be managed by the organization and may also be displayed. Table 30 displays the then current rates as they fluctuate for action types. In particular row 31 indicates the current rate of each action type. This rate is added to personal scores across each respective action type on completion of the action. The rates fluctuate based on balancing equations predominantly between the creating and completing action types. Examples of such balancing equations are displayed in FIG. 16.

The system makes immediate adjustments. In an embodiment of the invention, for example, as soon as a user somewhere in the task universe creates a task the system reduces the point value of that create action type by a calculated amount and increases the completion point value for that action type by the same amount. Example equations for an embodiment of the invention are shown in FIG. 16. Row 32 shows the rate change for that day (or during a different specified time interval). The values shown represent the actual point values determined using the equations shown in FIG. 16, wherein x=15. For example, adding up all the completed tasks during the day as given by the rate “15/total pending max points” would result in the increase noted. If there are 10 users who all have pending task limits of 10 tasks, then the total pending task limit would be 100 potential tasks. So 15/100 is how much each action type is worth in rate points. So if one of those 10 people completes a task, then 15/100 would be subtracted from the 15 of completing rate and added to creating rate. Then in the second row, this 15/100 is added to the 0. Each day is assumed to start at midnight. So with that one completed task, the second row under complete would read −15/100 and +15/100 in creating. If two tasks were completed then it would be 15/100+15/100 as the amount add to second row under compete and subtracted from the created row. Row 33 shows the percent change in the rate since the previous day.

Columns 34, for example the leverage long column, show the number of times the task action was performed since the user joined the system or organization divided by a specified number of days, giving an average of this task type performed over time. The column shows the top 5 people with a leverage score.

Column 35, for example the leverage short column, is calculated weekly. To determine the listed order, an upper limit of tasks to be completed each week is determined. The organization average of completed tasks PER PERSON is then calculated (for example using the average of how many tasks were completed each week in the last 12 weeks and divided by the number of “contributing members” in that week) resulting in a number, for example 30 tasks completed on average per person per week. If a user completes the average (30 in this case) then receive the normal rate. But if the user completes MORE than 30 tasks, then each task completed gets an additional “point” of stock per completed task. So if the user completed 30 tasks, then they receive the normal rate. If the user completes 31, then for that 31st task they receive their normal rate plus the leverage long rate, plus the macro-rate plus their leverage short which is 1+1(1) or 2. If the user completes 32 tasks, then the leverage short value is 1+1(2)=3, and so on to 1+1 (n) wherein n is the number of tasks created past the average for the organization.

FIGS. 7B to 7E displays a number of graphs relating to action types. Graph 36 shows performance curves for each action type over time, and their totals across the organization, the week's total performance of each type, change rates and other analysis. Graph 37 is a performance graph of each action type performed across project groups of organizations. Clicking on each group name (for example FTC, Stand, MV, DC or UAEM) shows their curves across selected action types.

Graph 38 shows the performance graph of groups, organizations and spheres outside the organization. The spheres in this example are categories of organizations, such as politicians, governance, academics, faith groups, labour unions, NGOs, media, businesses, and community leagues across the “complete” action type. The columns show the total completed tasks since a specified time interval, average per week, change in performance since previous week, and number of leaders (calculated by tasks, outreach, titles and other metrics).

Graph 39 shows the same performances as in graph 38 but in relation to a single organization and displays the number of each action type the organization has performed externally in the spheres noted above or other organizations. The statistics shown are the total the organization has performed of the complete task type, average per week, change in expected events, average leaders engaged, and workload still remaining in each sphere (measured in tasks).

FIG. 7F shows a variety of charts relating to tasks and individuals within an organization. Pie chart 40 is a visual representation of the action types performed in the organization. Table 41 displays the top 10 internal demand for skills, knowledge and talents inside the organization. The number in brackets is the number of tasks currently pending that requires the skill, knowledge or talent in order to complete the task. Chart 42 shows the top 10 users who can supply the variables needed in the demand table 41. Personality types and other variables may be shown in the tables and charts. Table 43 shows the top 10 supplied skills, knowledge, talents from the members inside the organization or the system. The number in the bracket represents the number of users who have the variable in their profiles. These tables and charts can be used to determine where an organization needs different skills, knowledge and talent and can be of assistance when hiring.

Users have some control over the rates they receive and may “level” up their own personal rate as they perform more and more of each task type. Thus there may be global rates attached to each performance of each task action type and a personal rate for the user which is added to the global rates. The extrinsic motivating incentive for the user is to get as many rate points as possible because then the user's task actions are “worth more” in points when the user “sells” them and others will have to “pay” the user more when they ask the user to perform a task. The incentives for individual rates can also be extended to tasks with certain skill sets attached. Ultimately the extrinsic motivators serve as a calibrating tracking system for intrinsic motivators, particularly for flow states in the flow economy as described below.

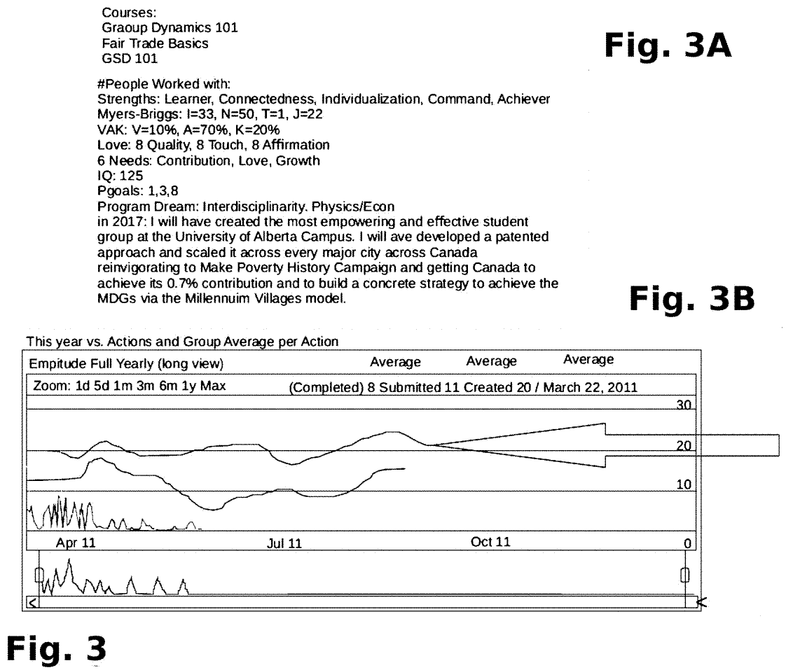

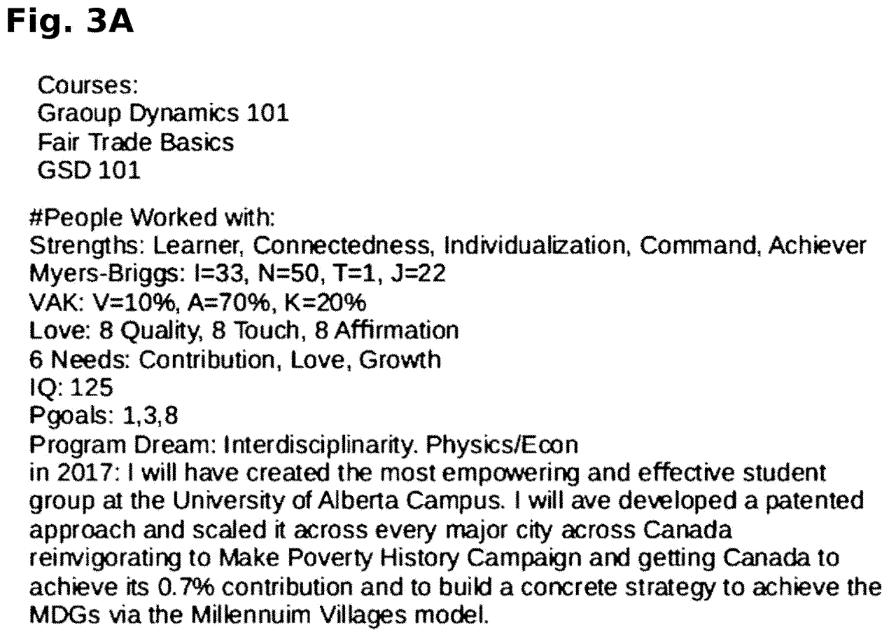

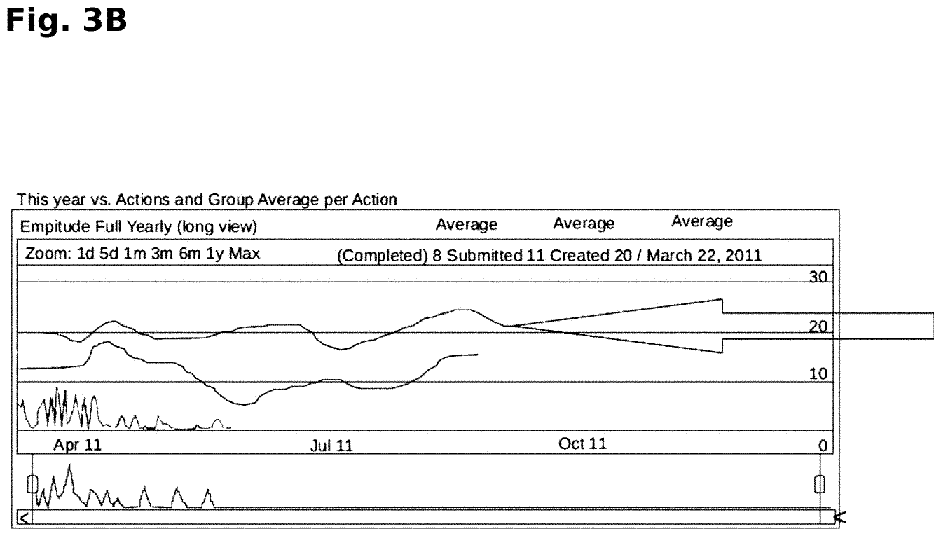

The user can view a graph, as shown in FIG. 3B, displaying the average numbers of tasks submitted and completed over a period of time. FIG. 3B shows average curves from across the organization galaxy in comparison with the user's scores and averages based on tasks. The system calculates the average by calculating the number of tasks performed each day/hour/minute or other time interval and averages it across members who submitted them, or competed for them, or split them, linked, pushed etc. This graph and its lines can be toggled on and off, or made visible or not visible.

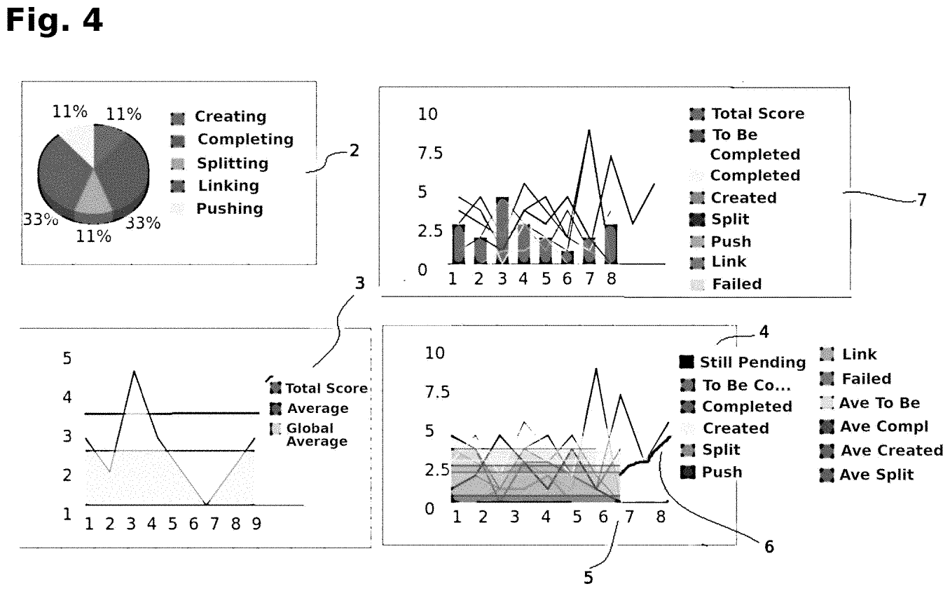

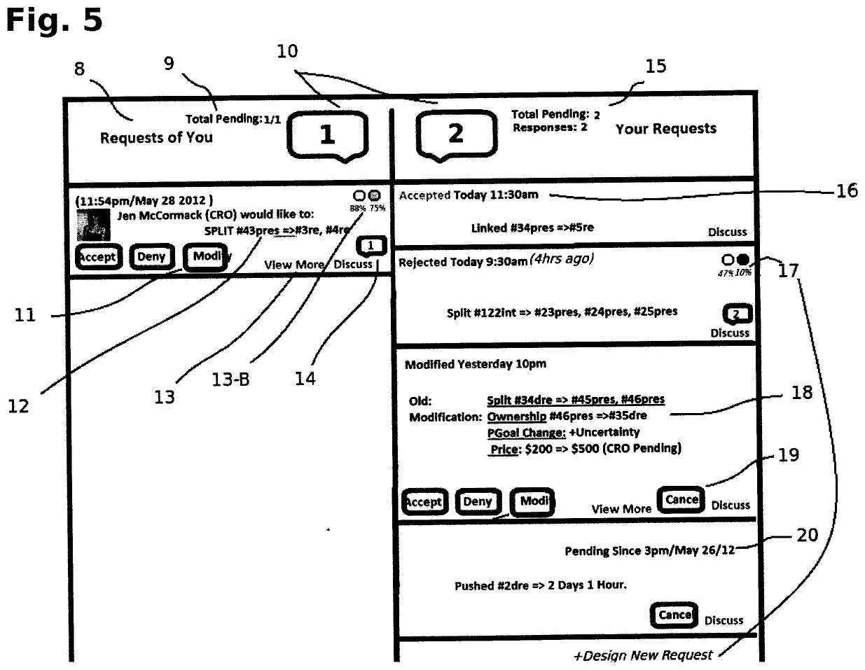

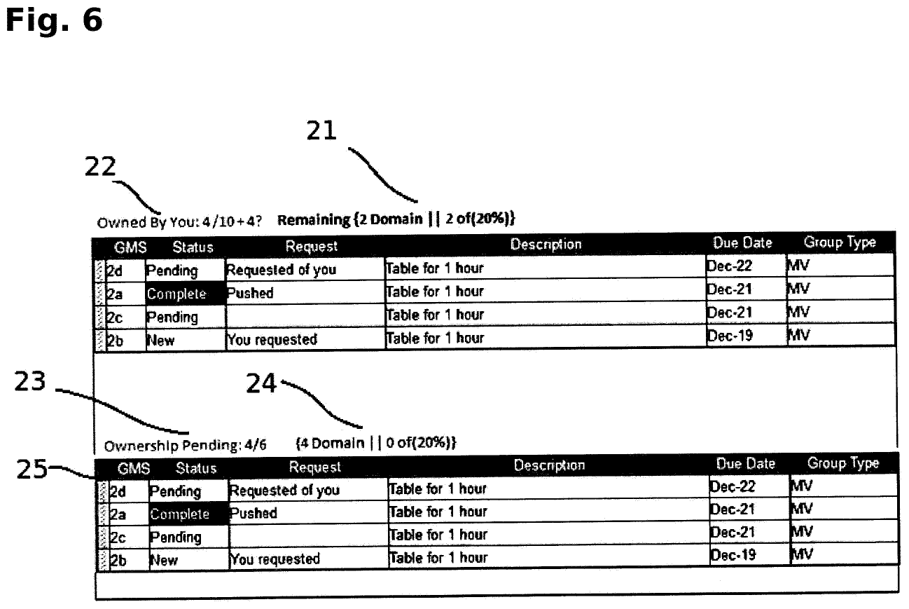

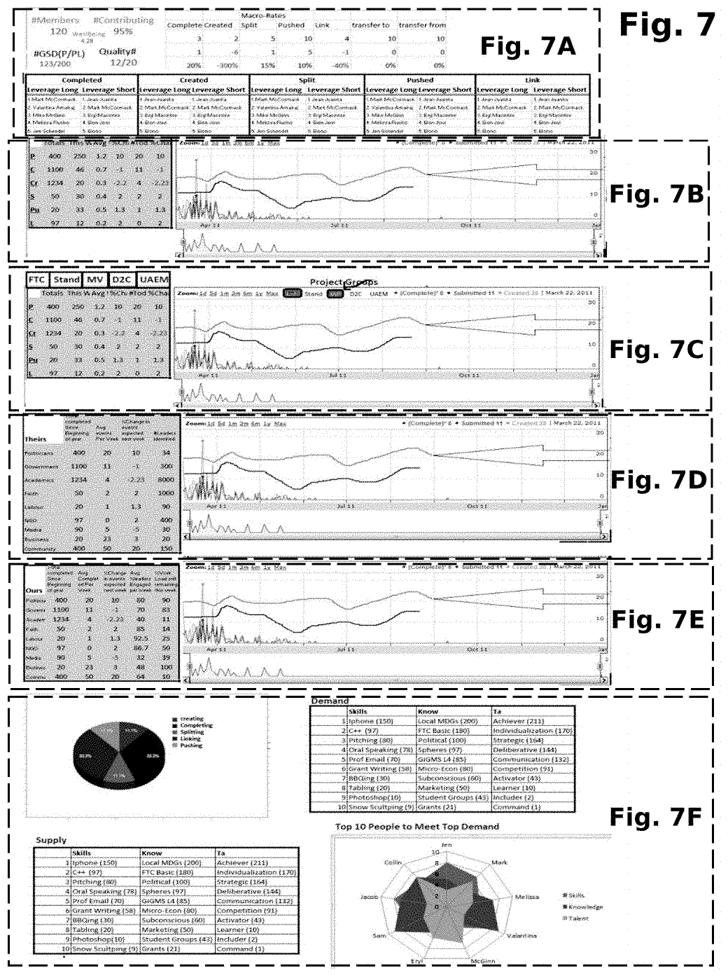

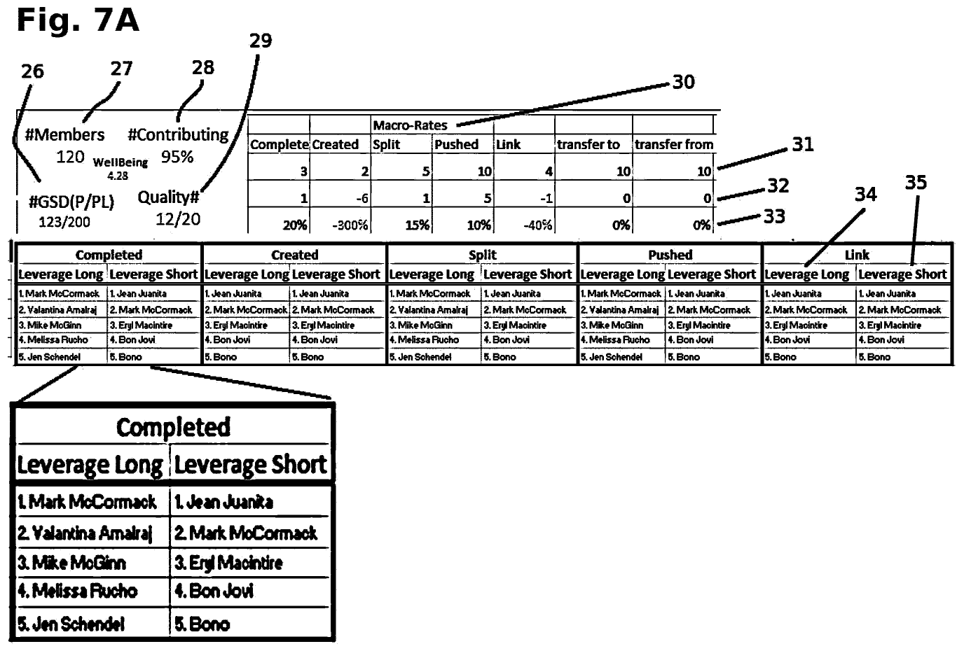

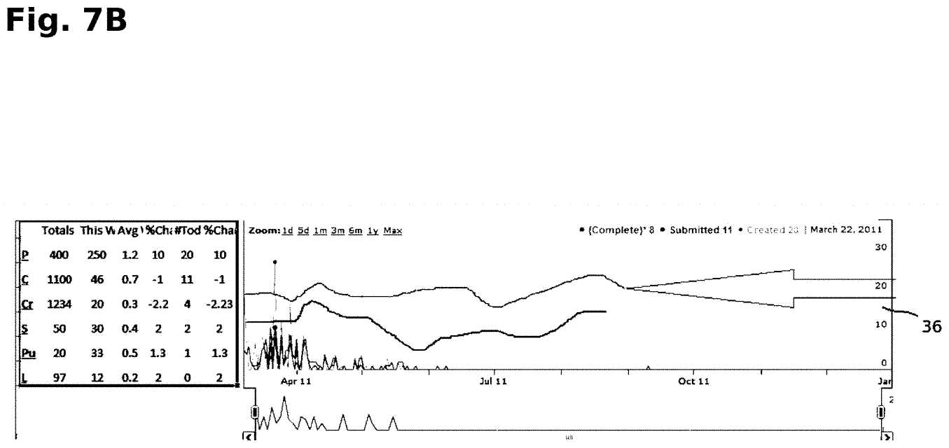

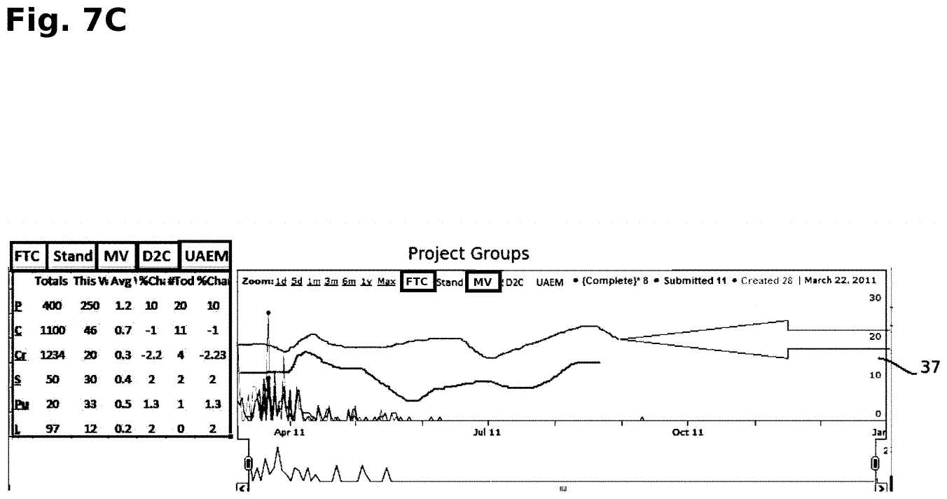

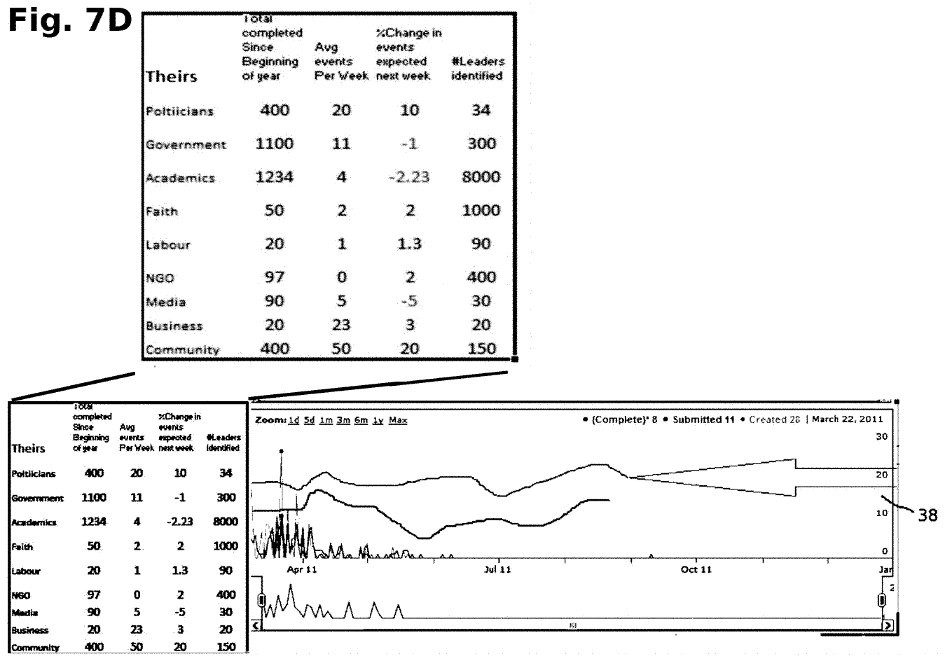

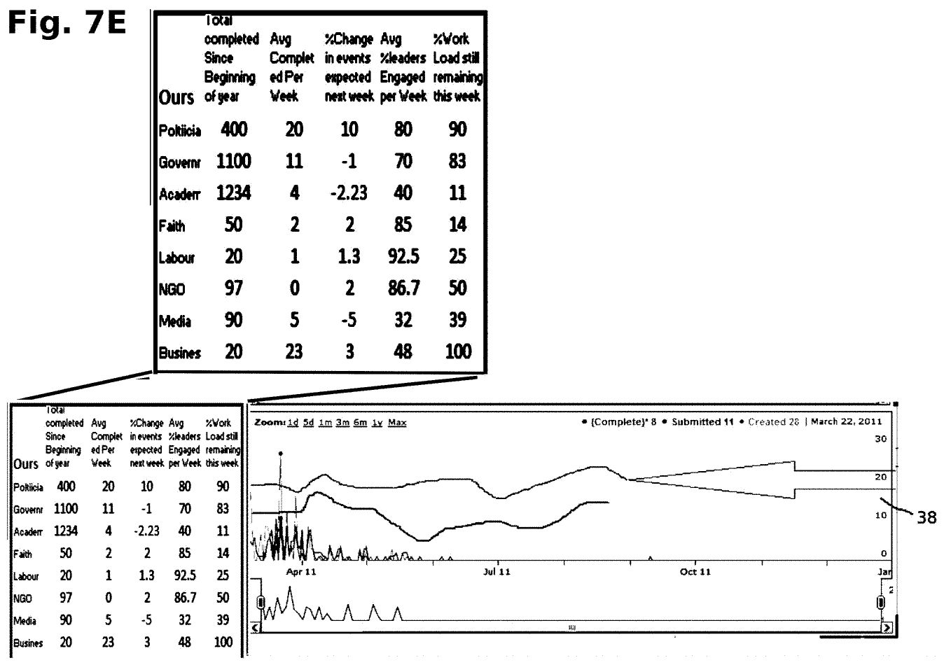

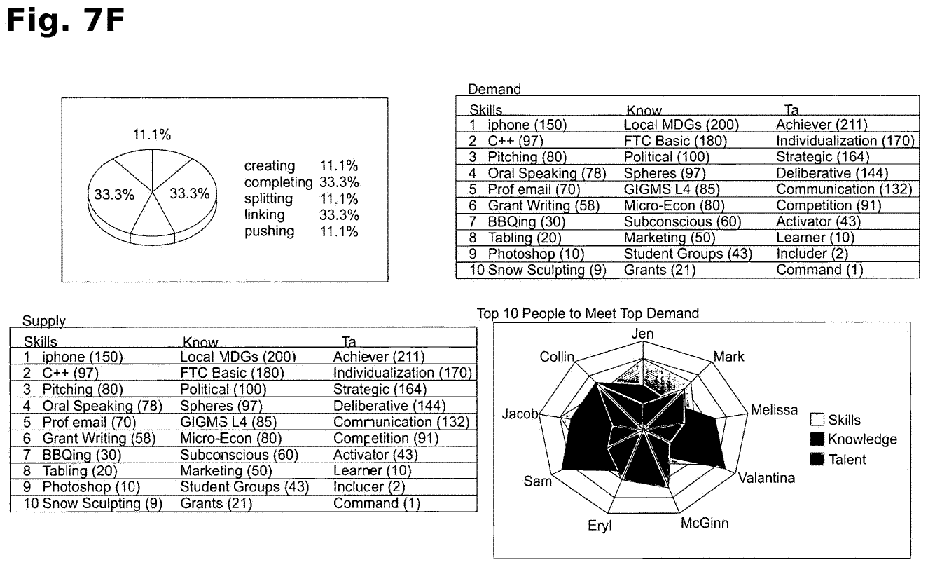

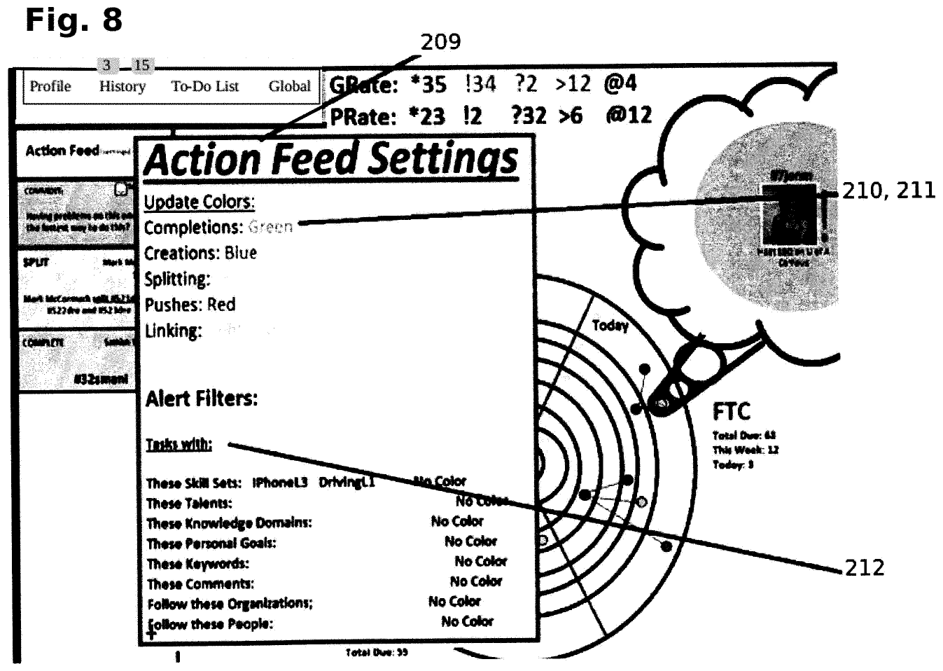

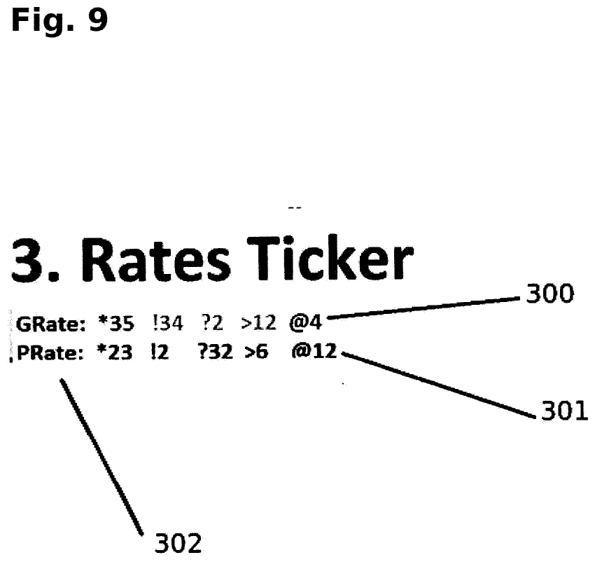

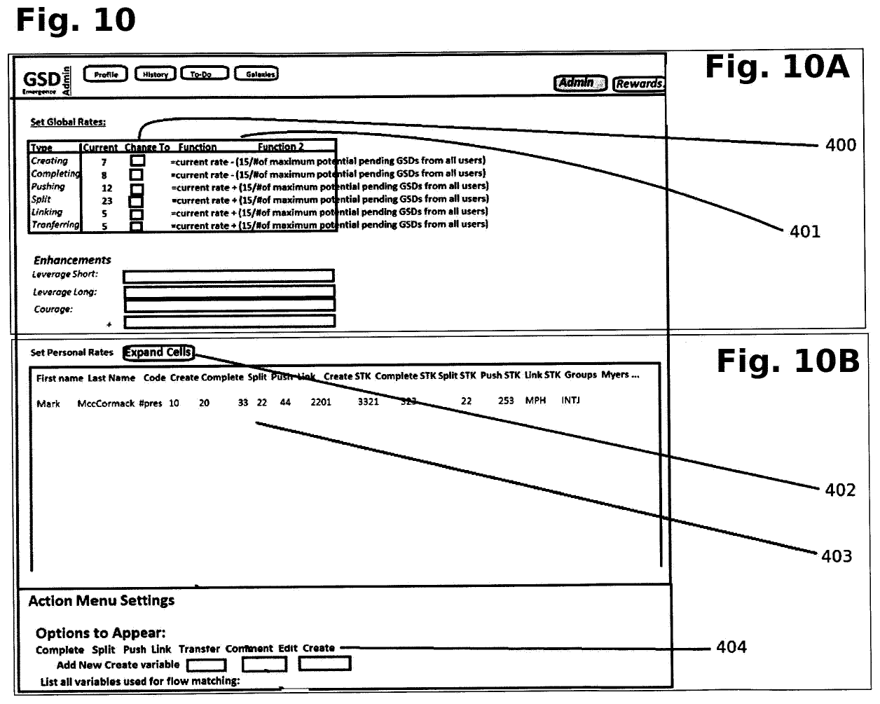

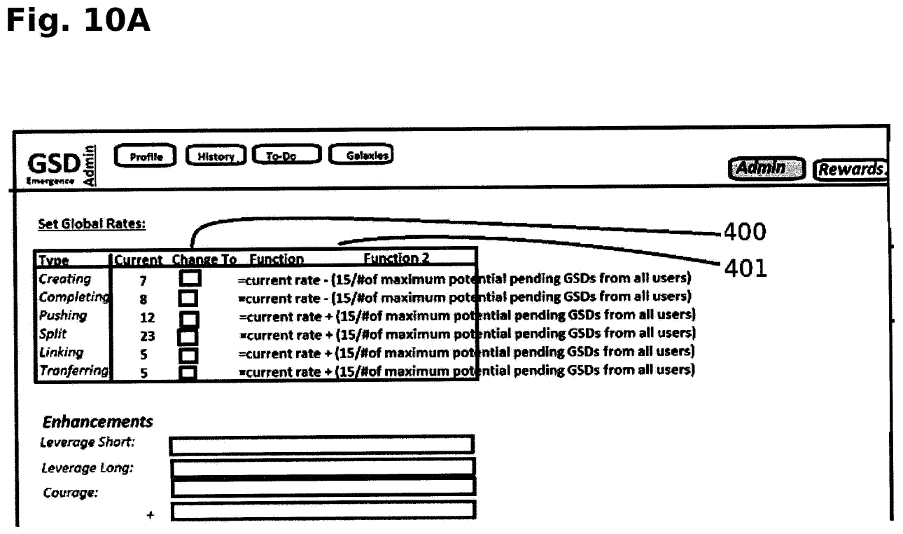

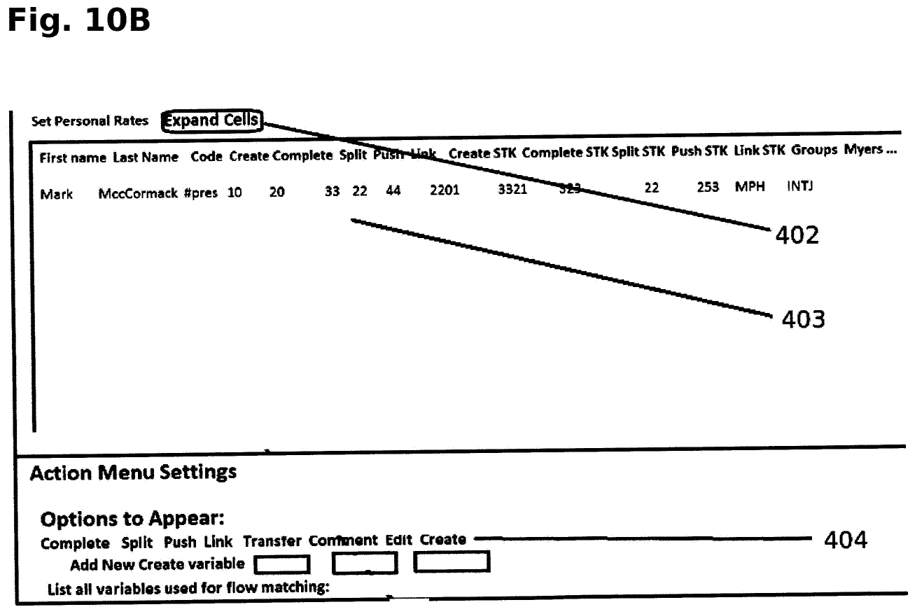

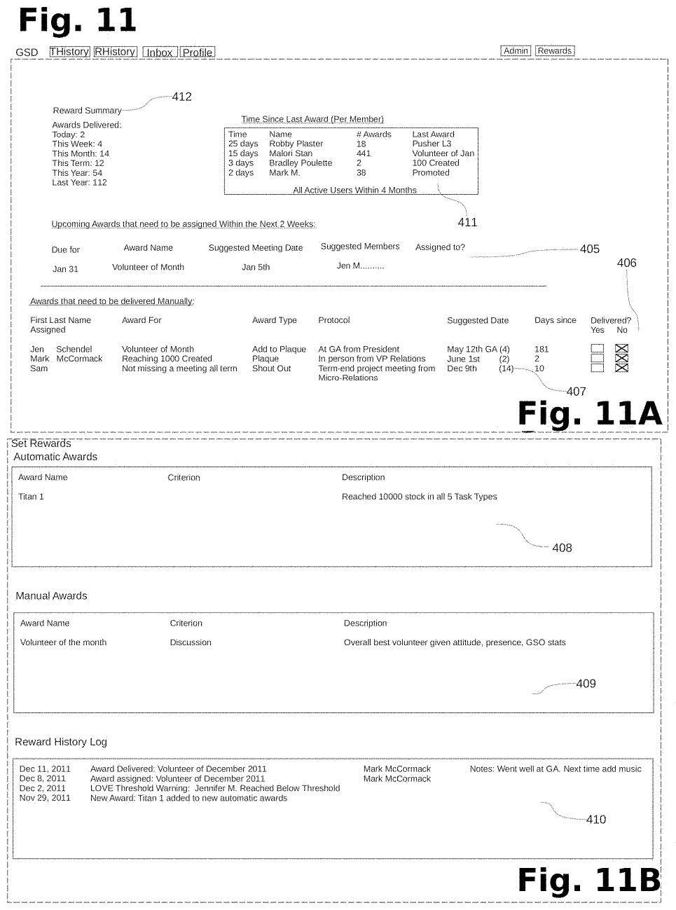

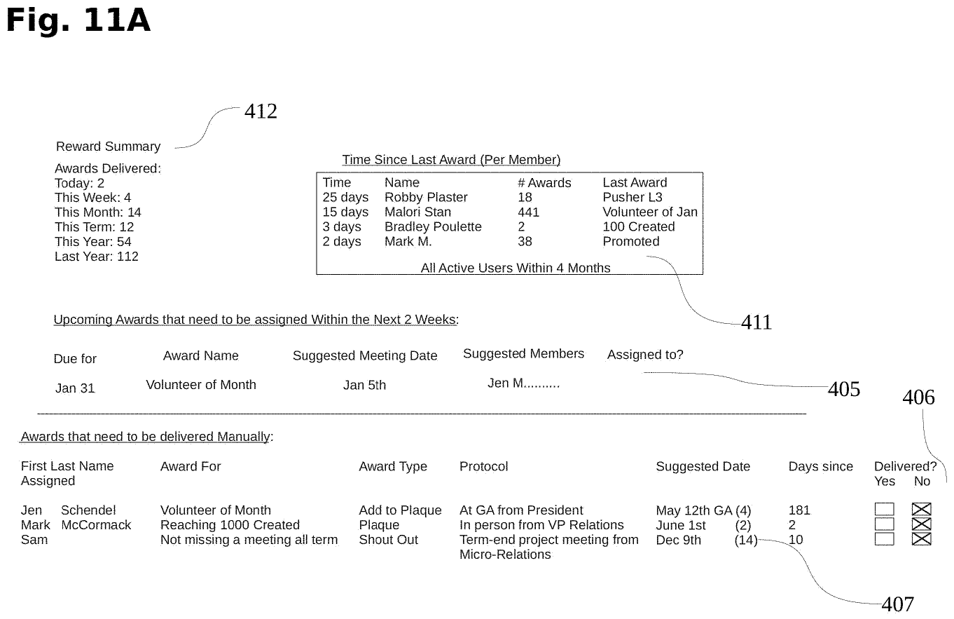

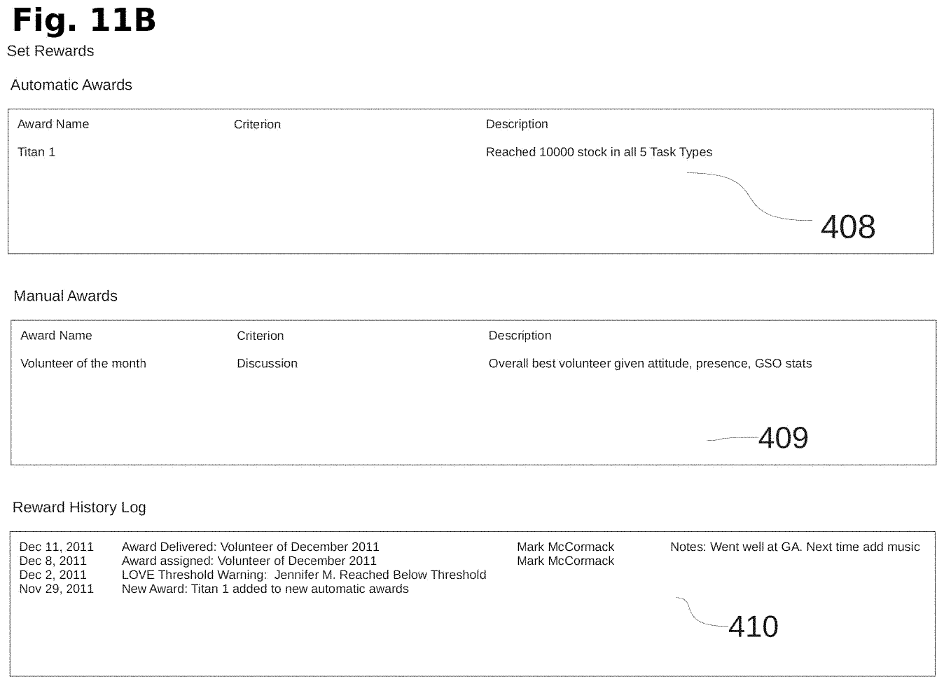

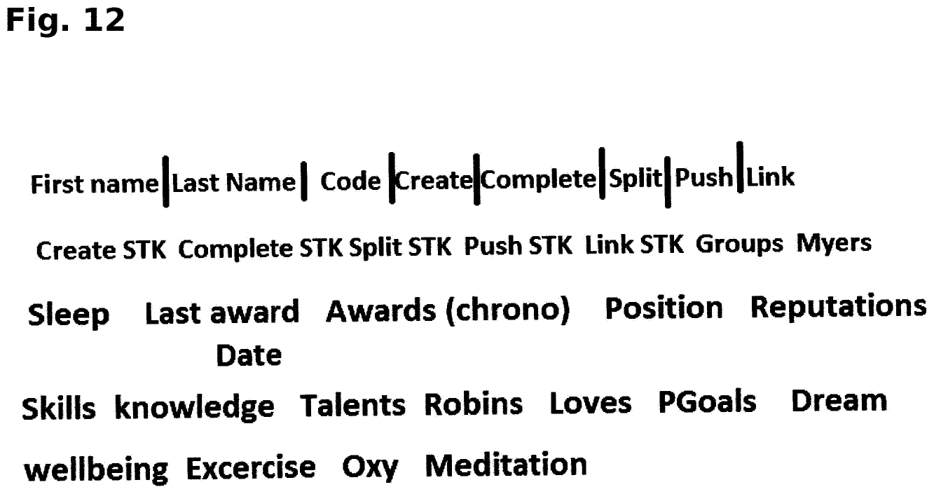

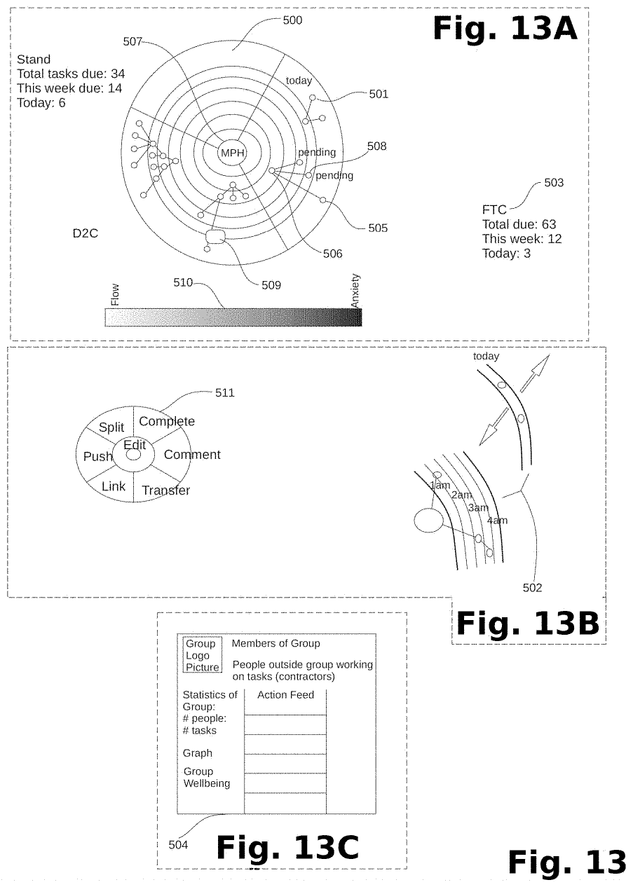

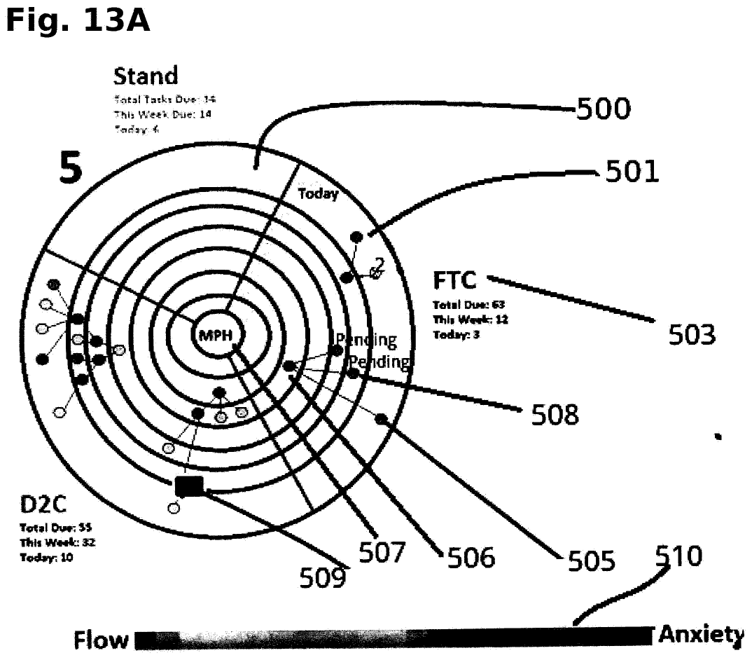

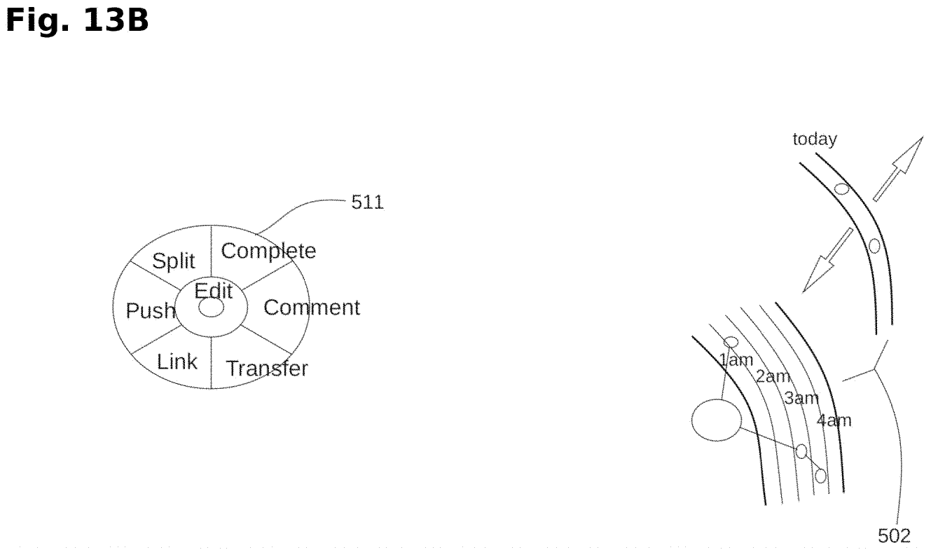

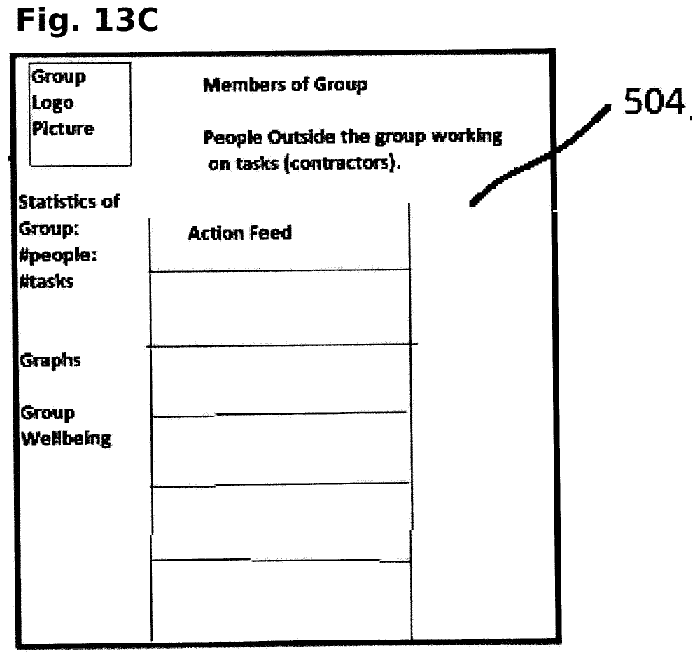

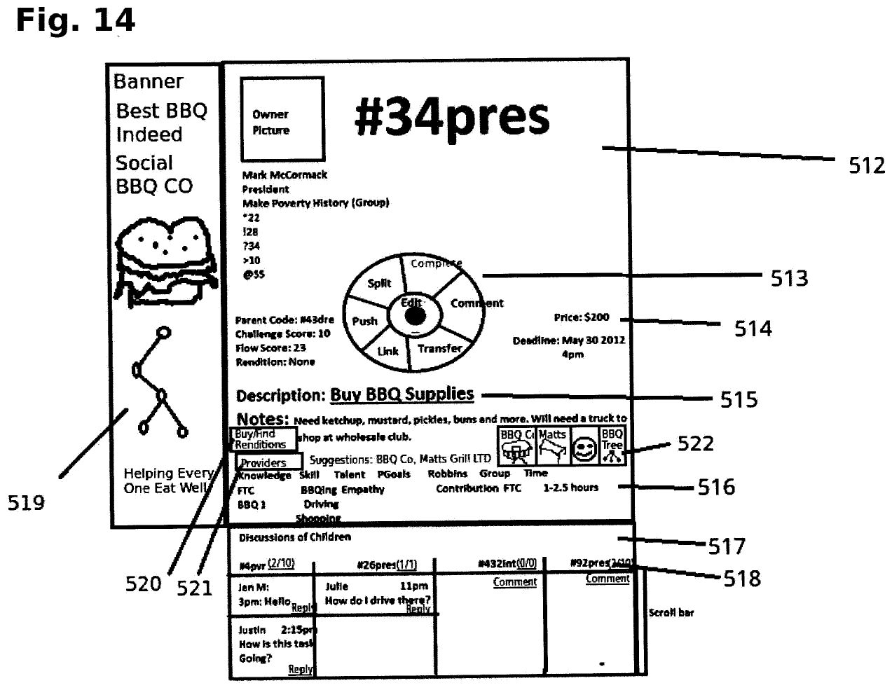

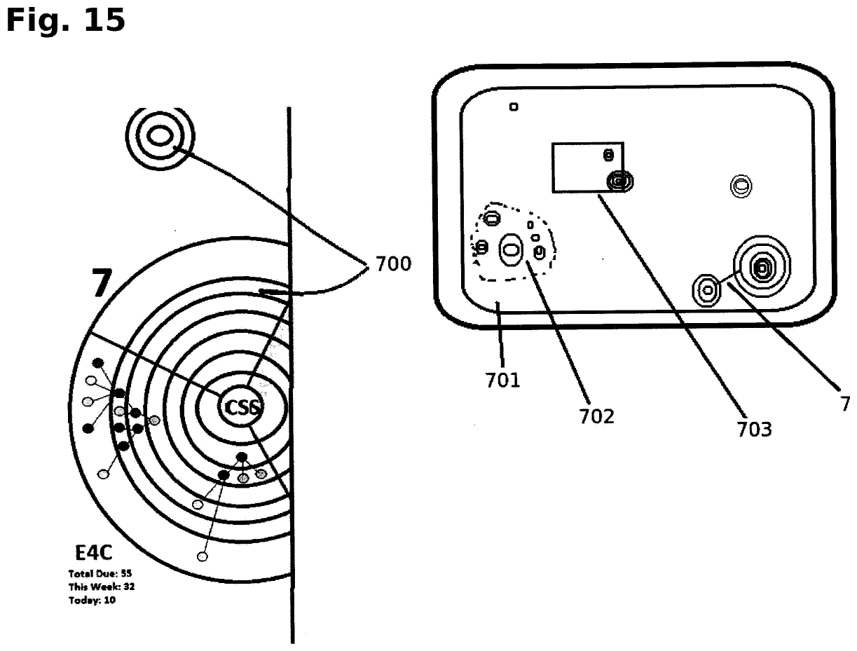

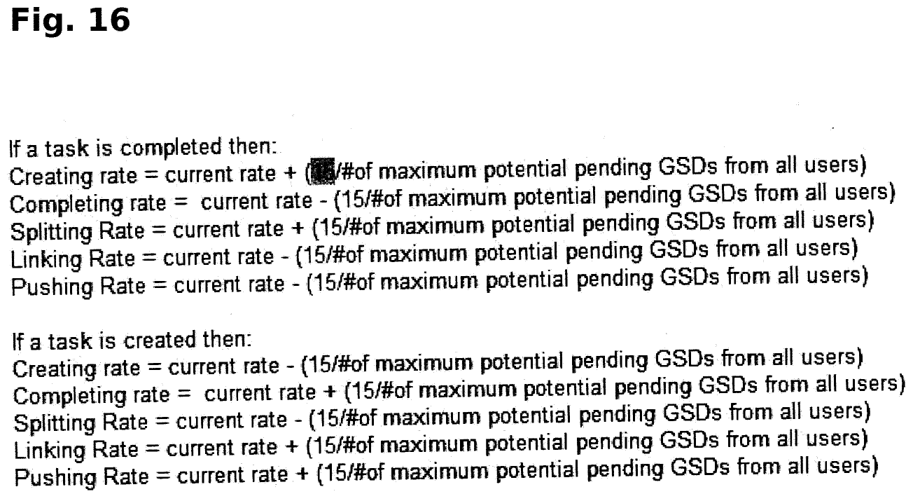

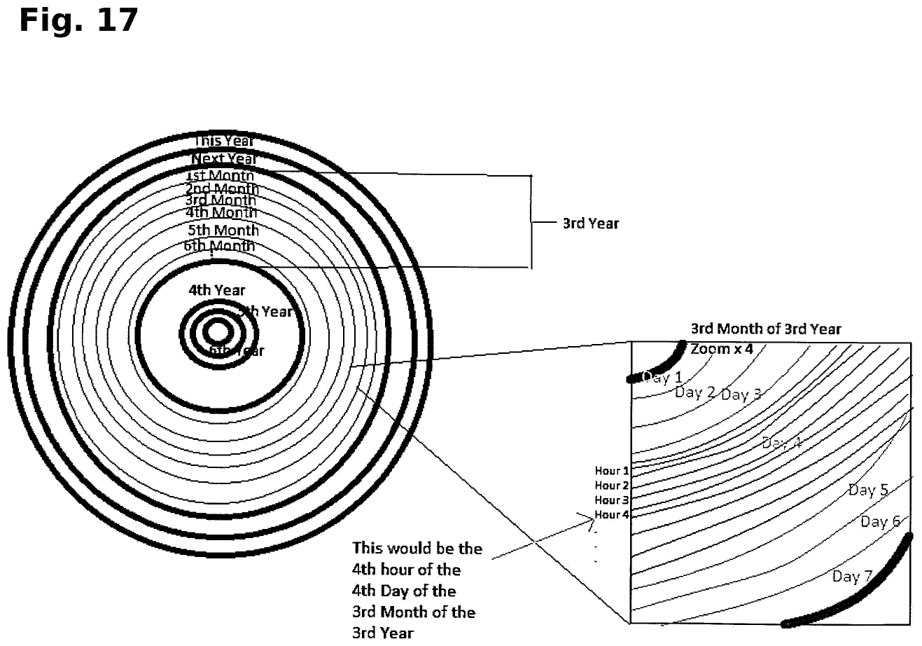

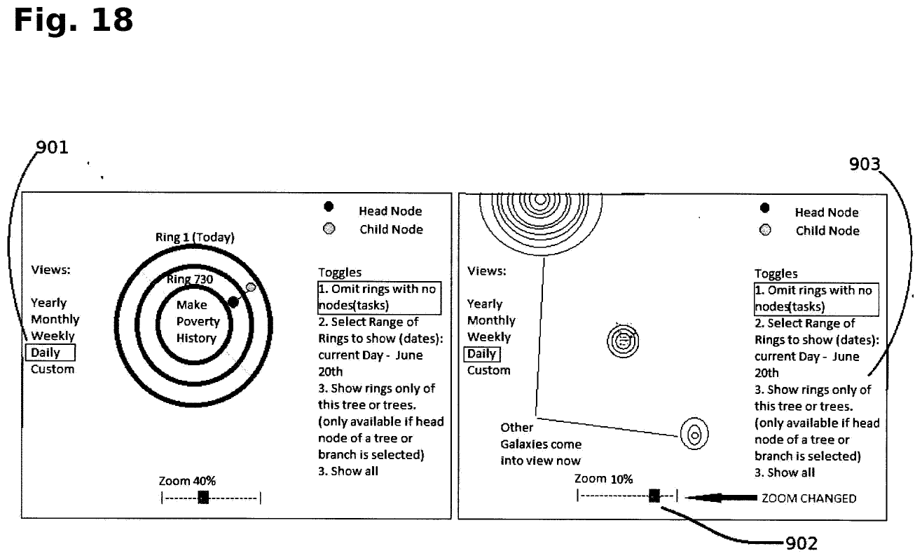

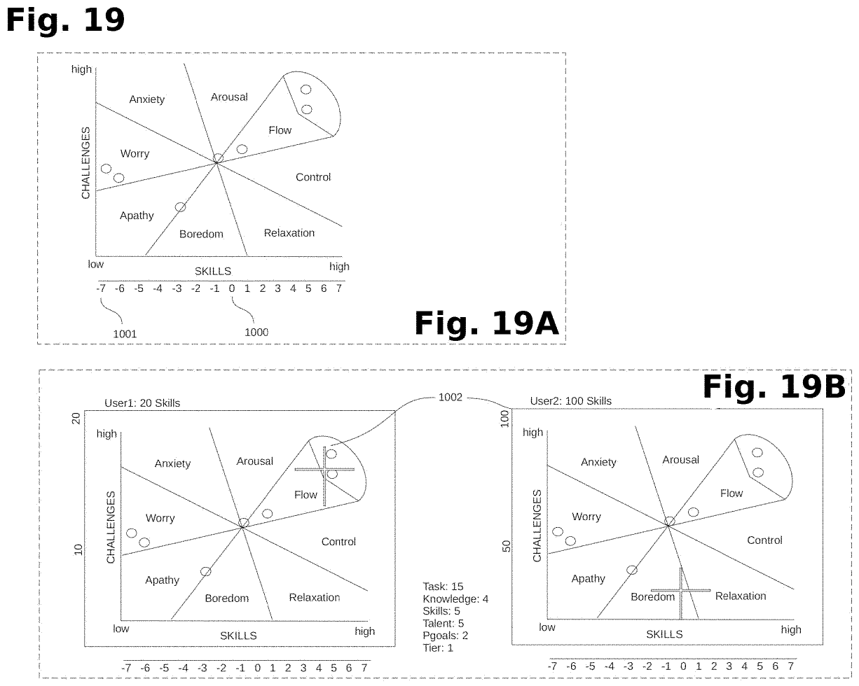

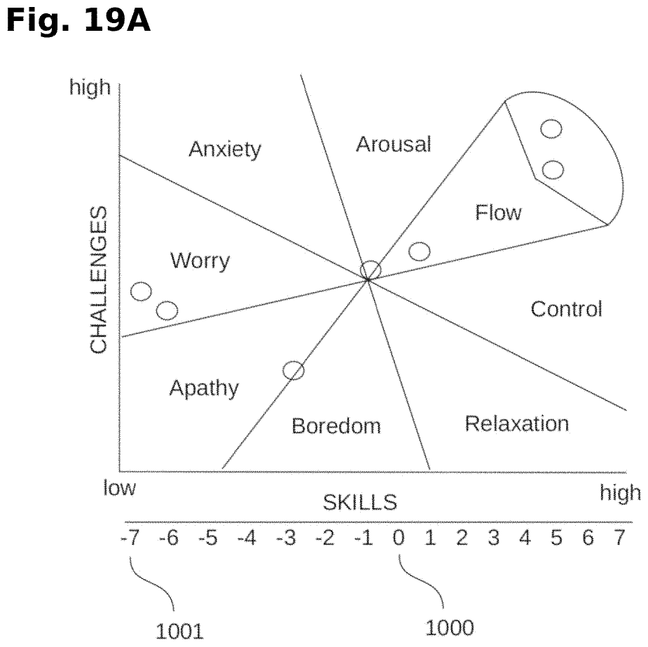

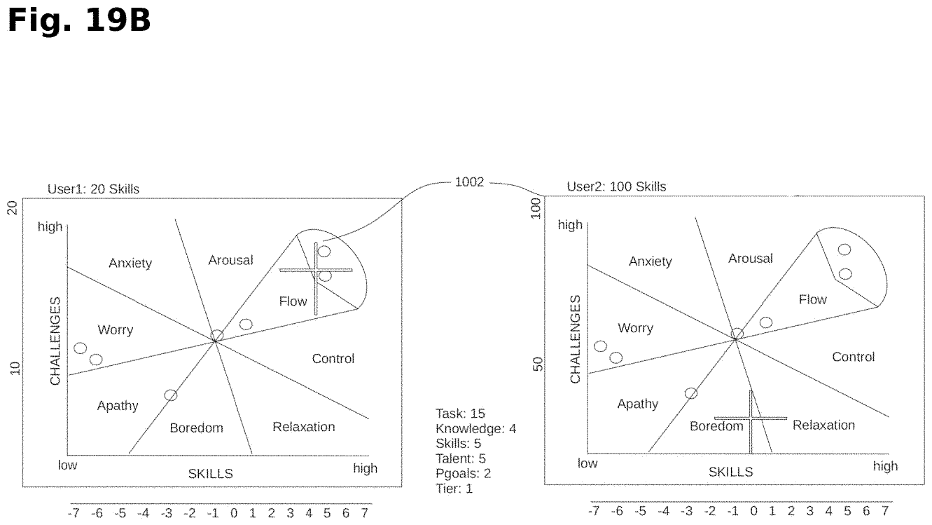

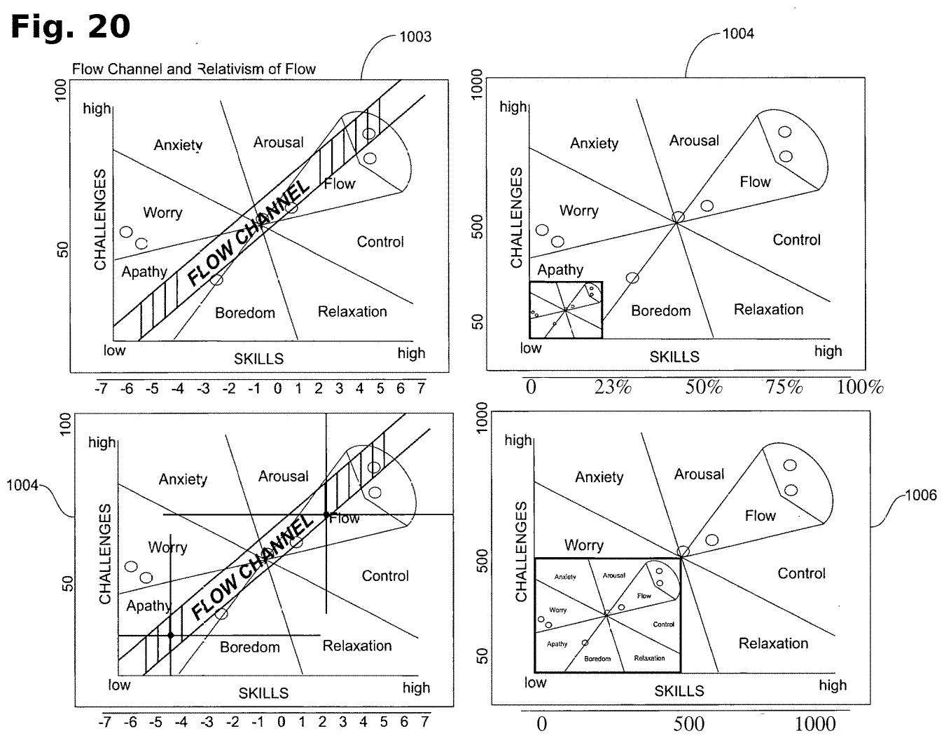

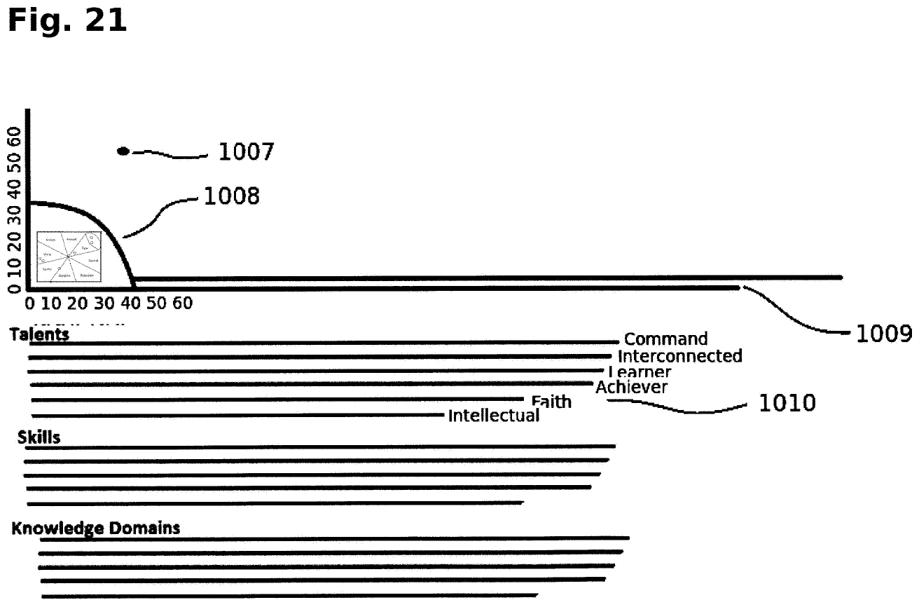

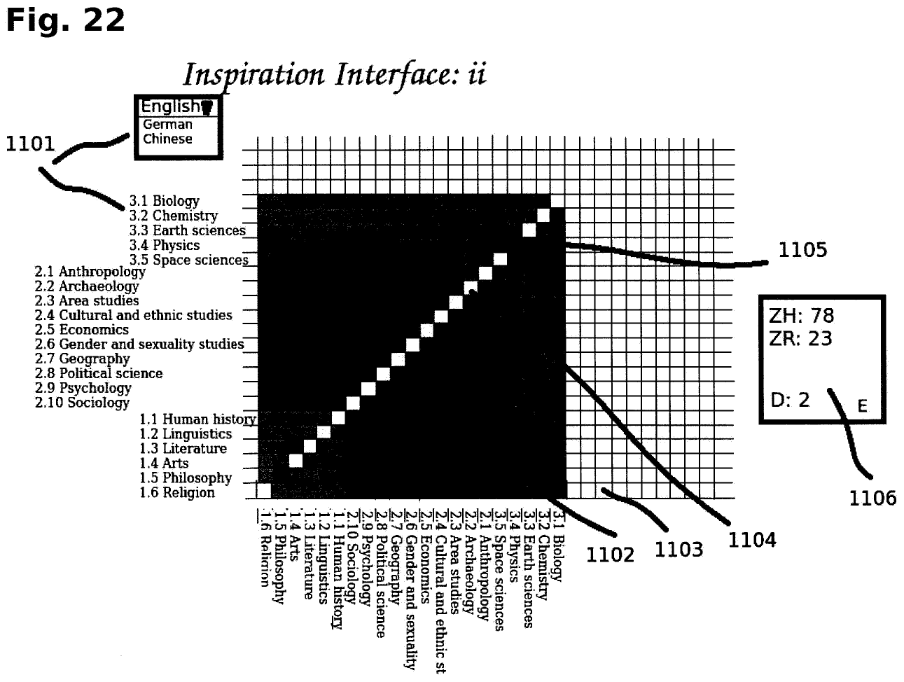

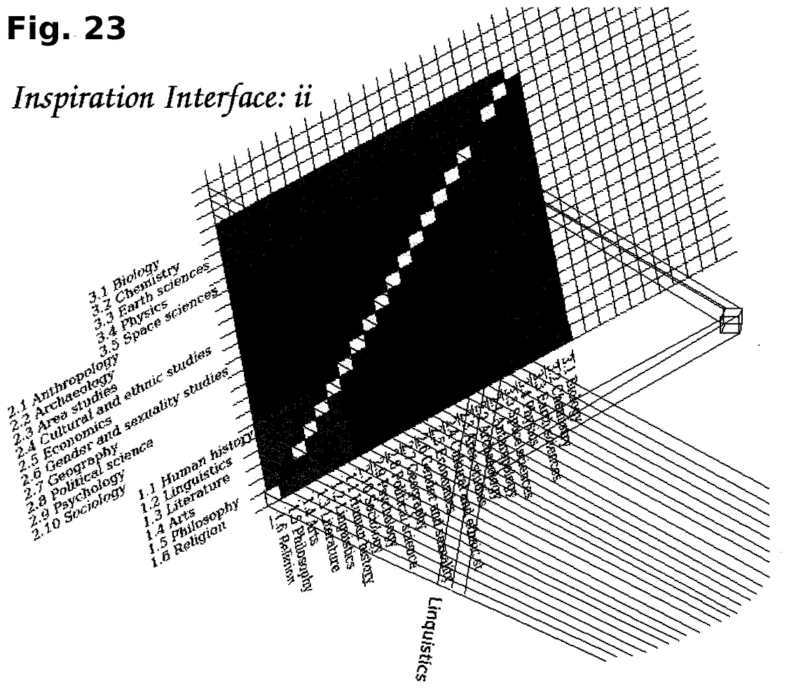

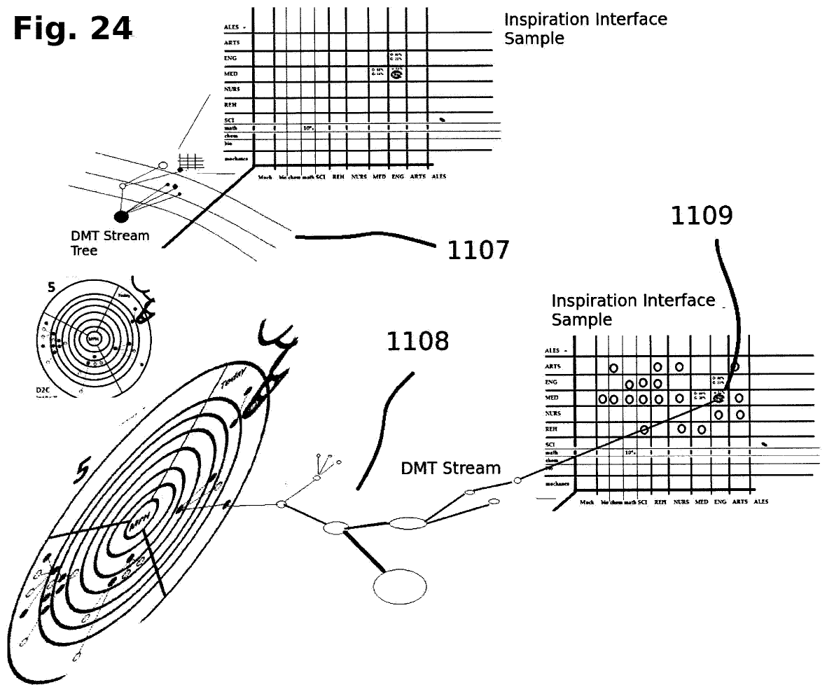

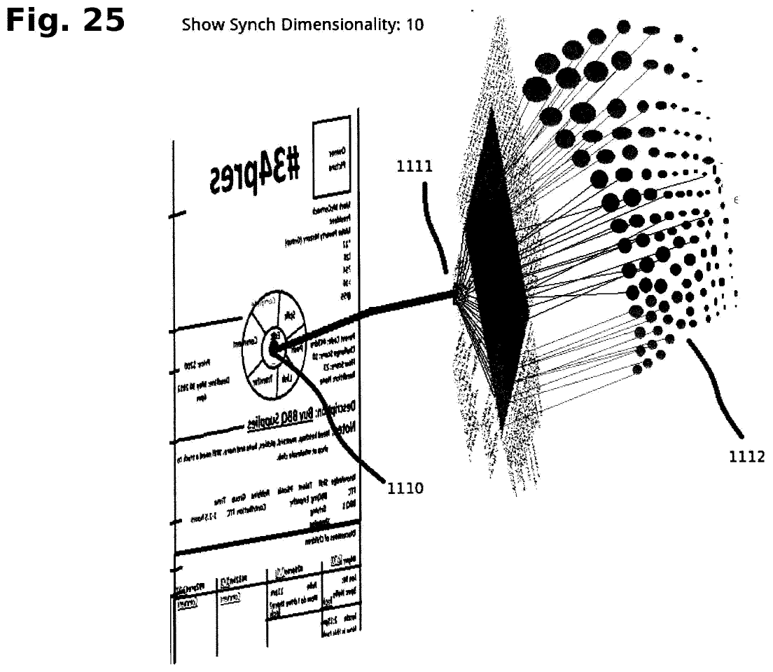

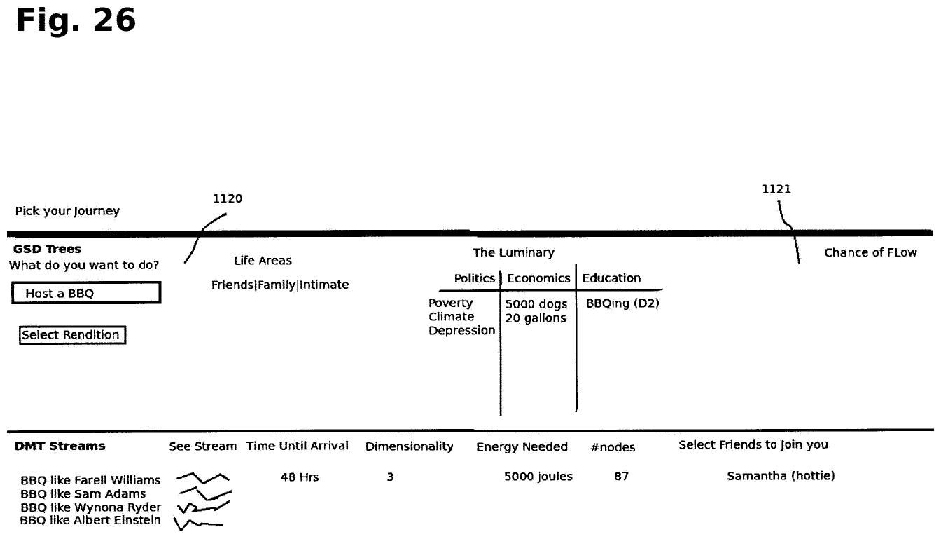

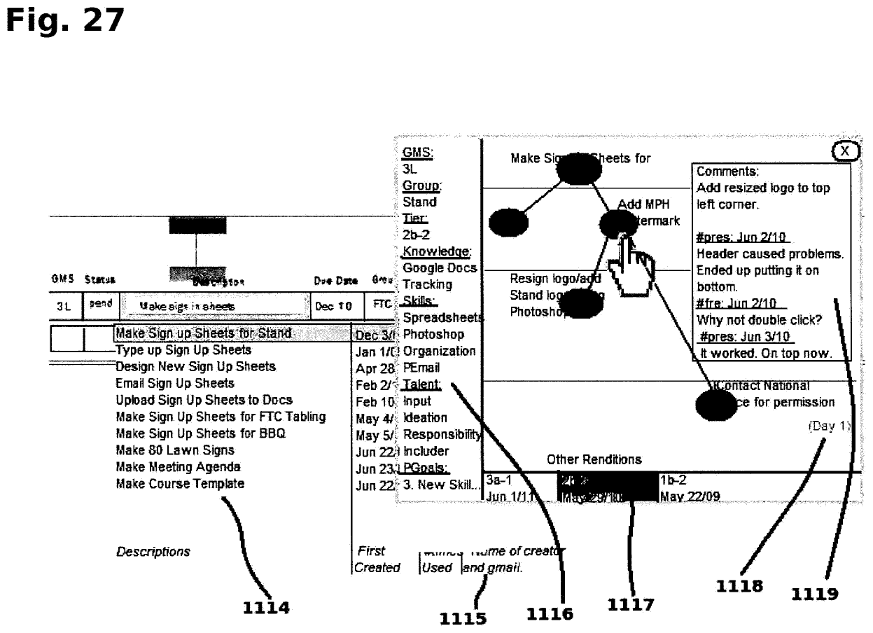

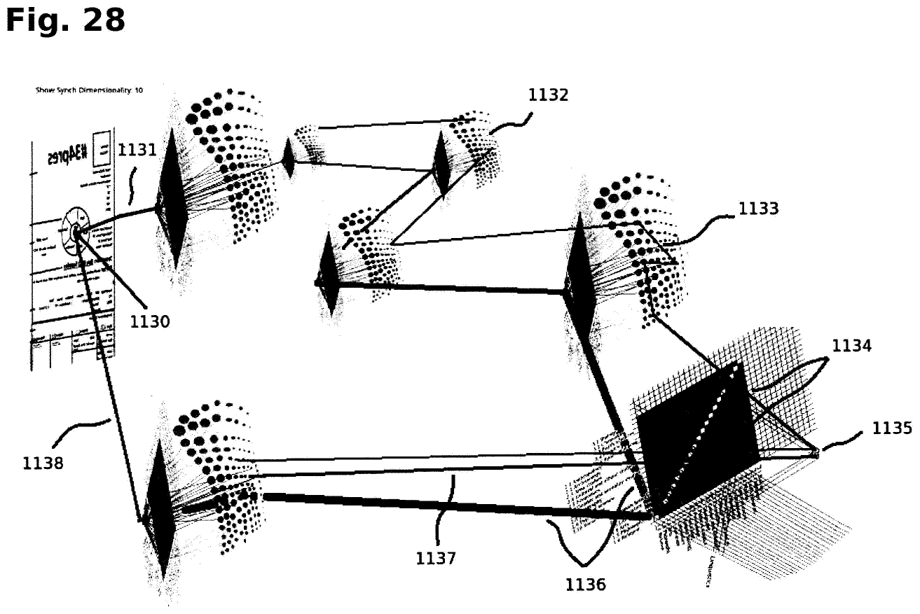

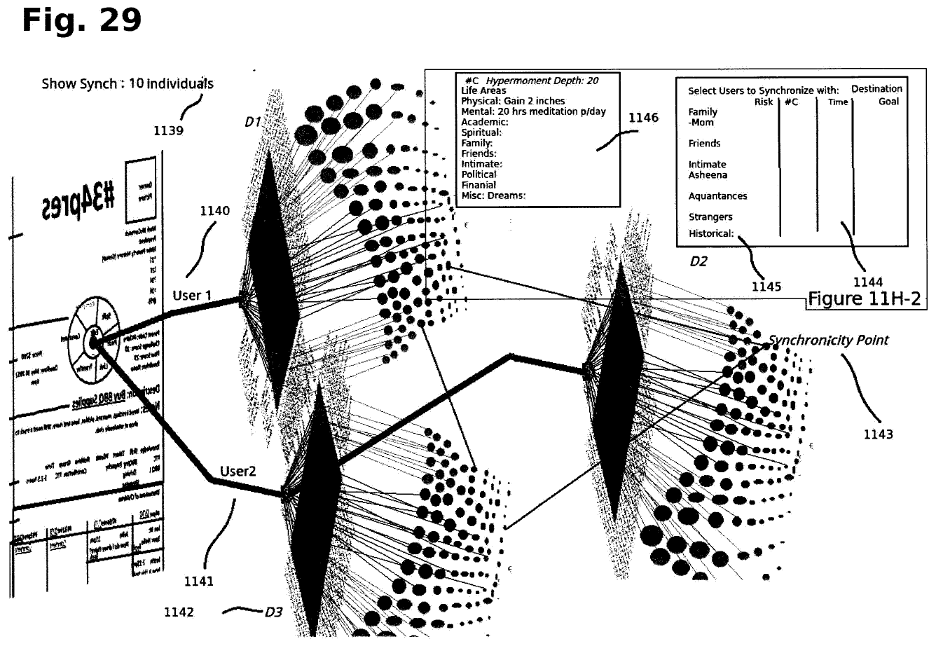

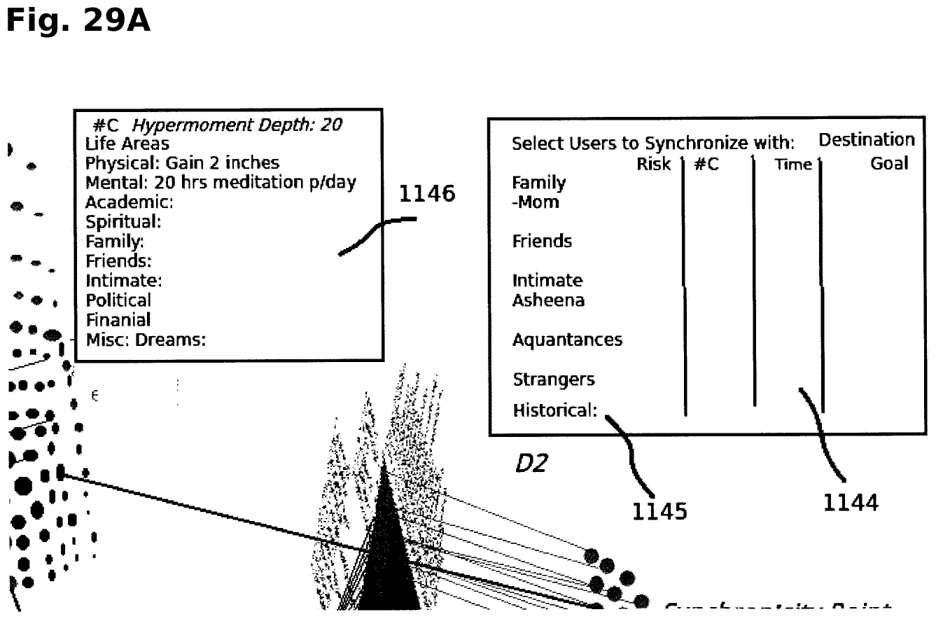

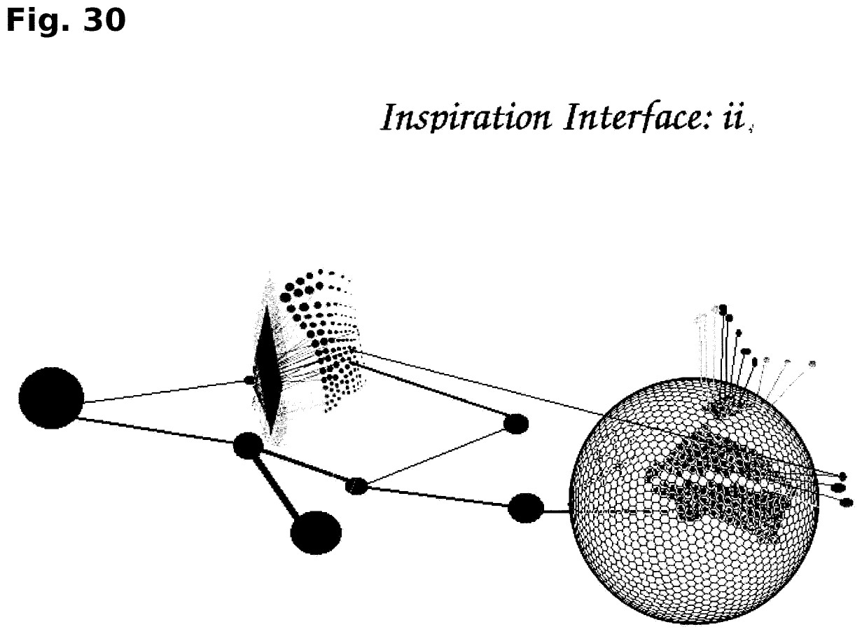

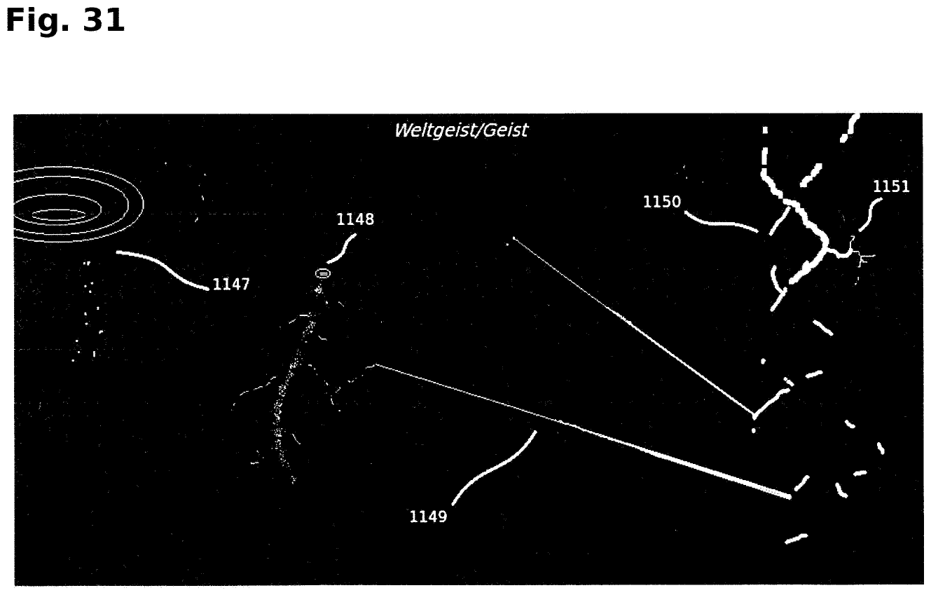

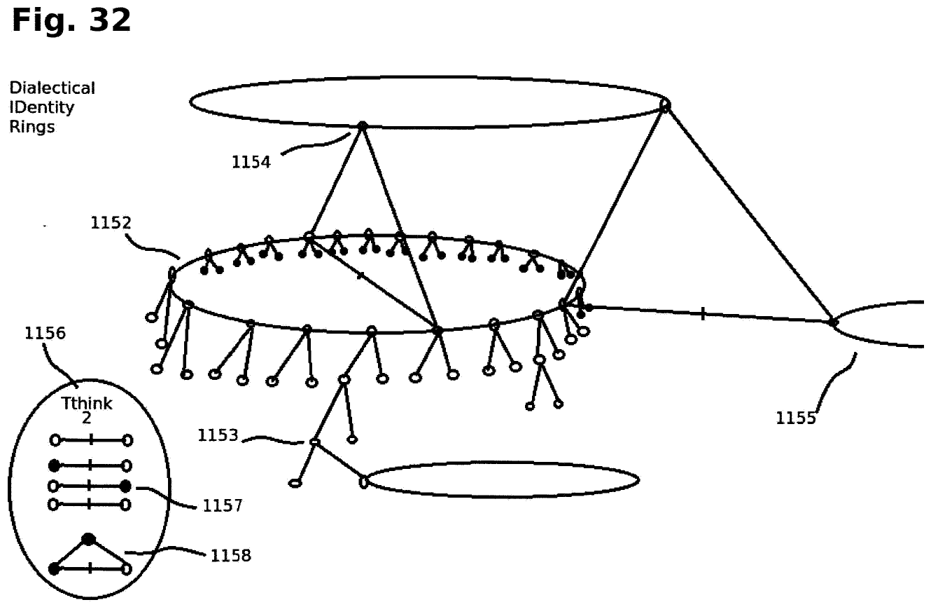

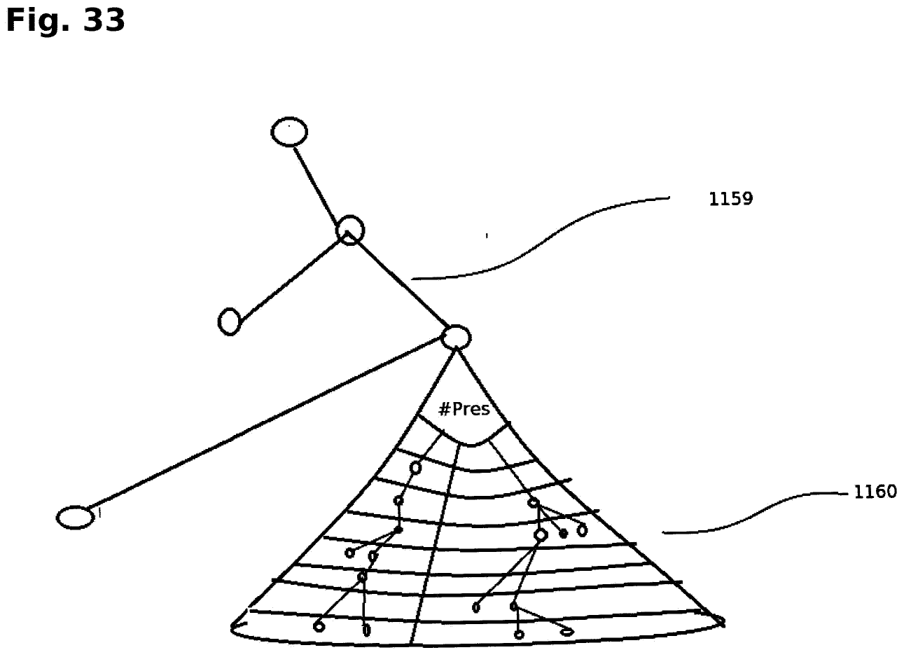

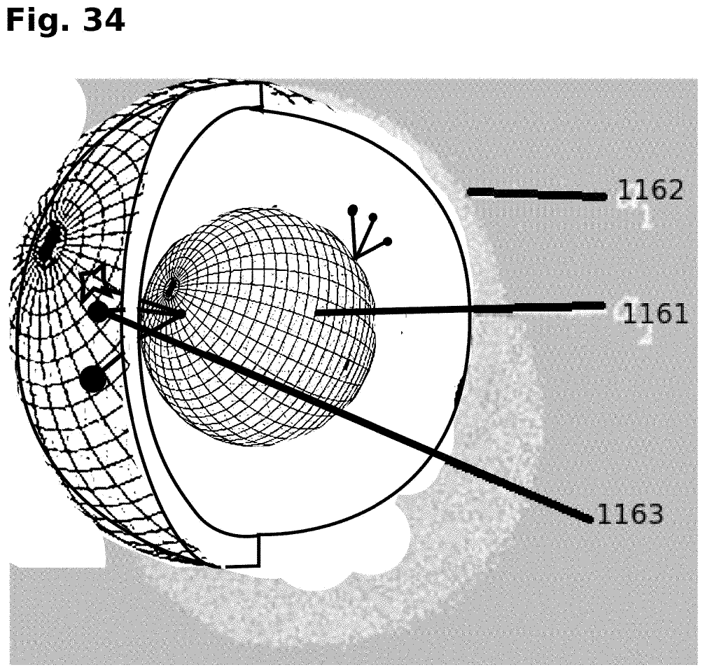

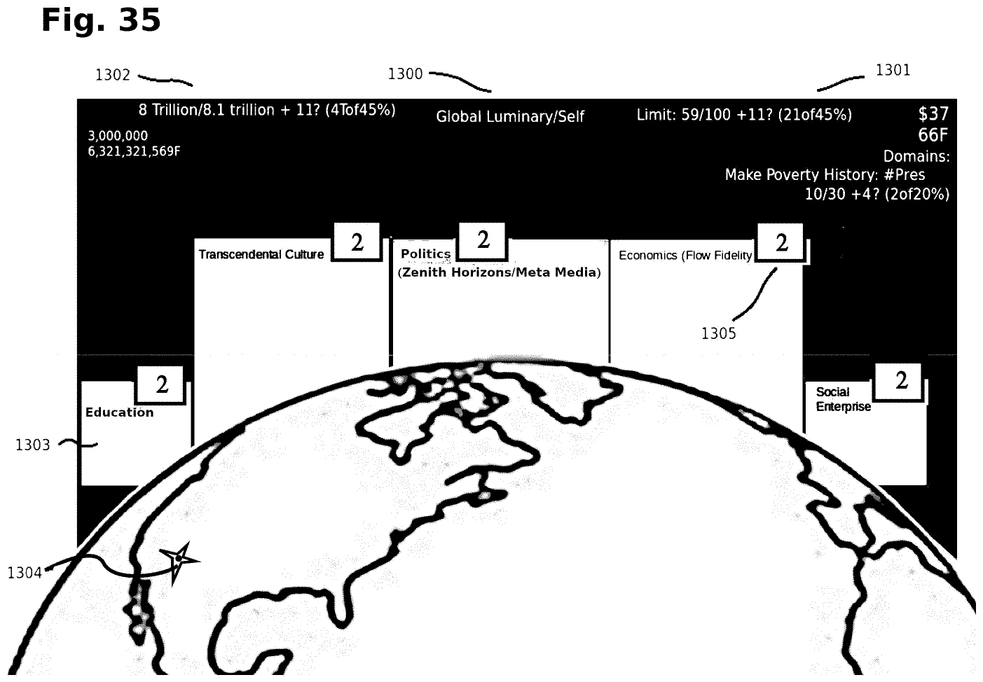

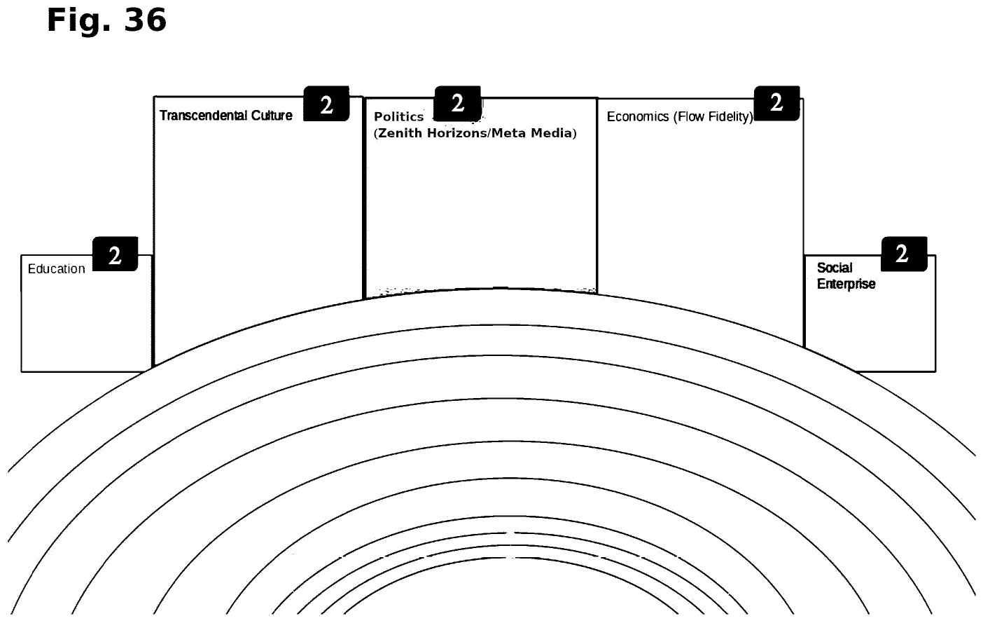

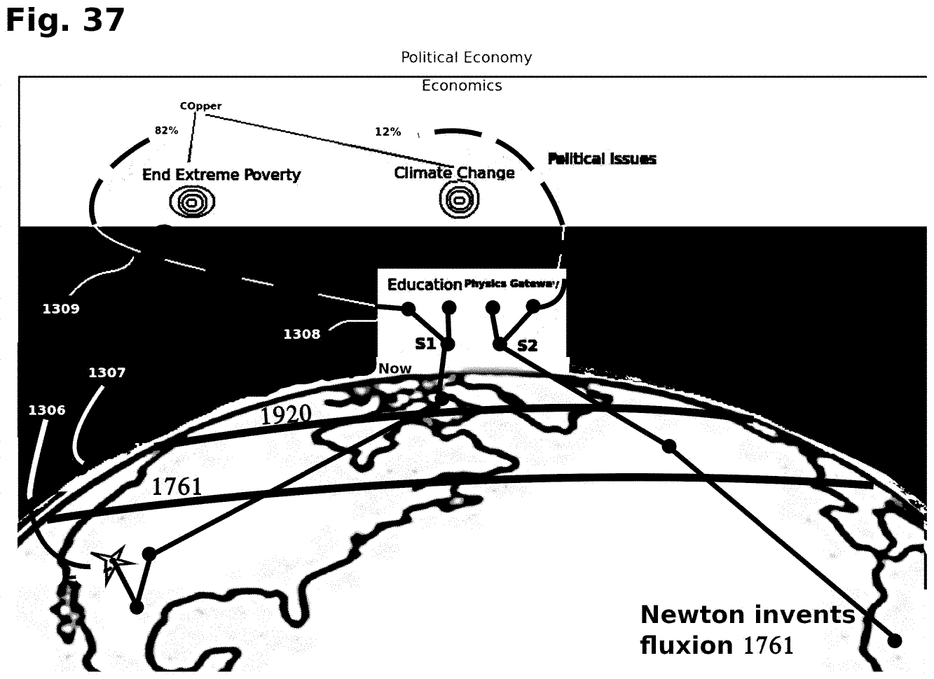

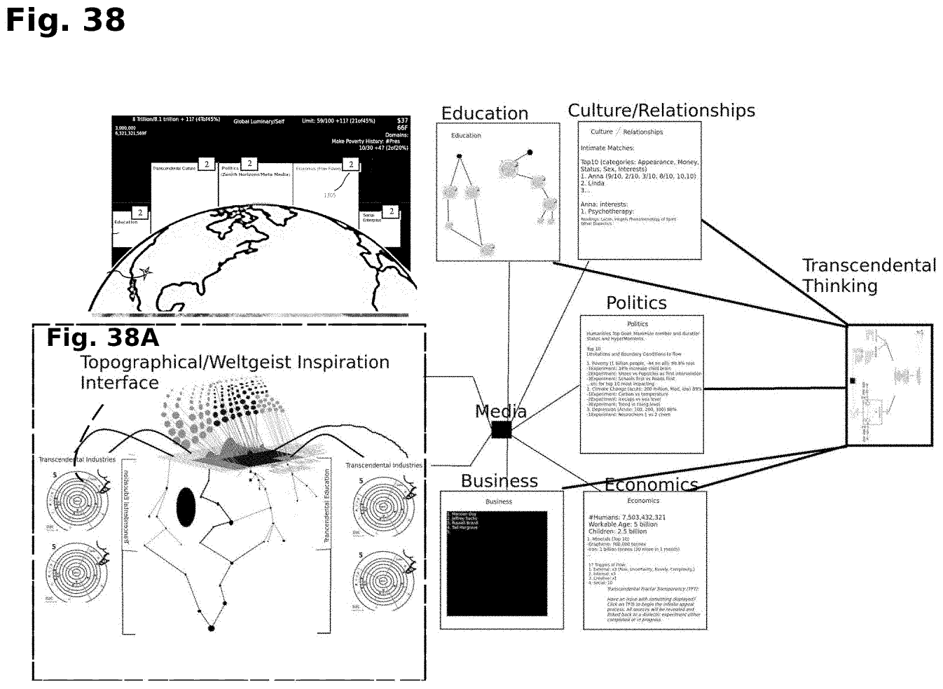

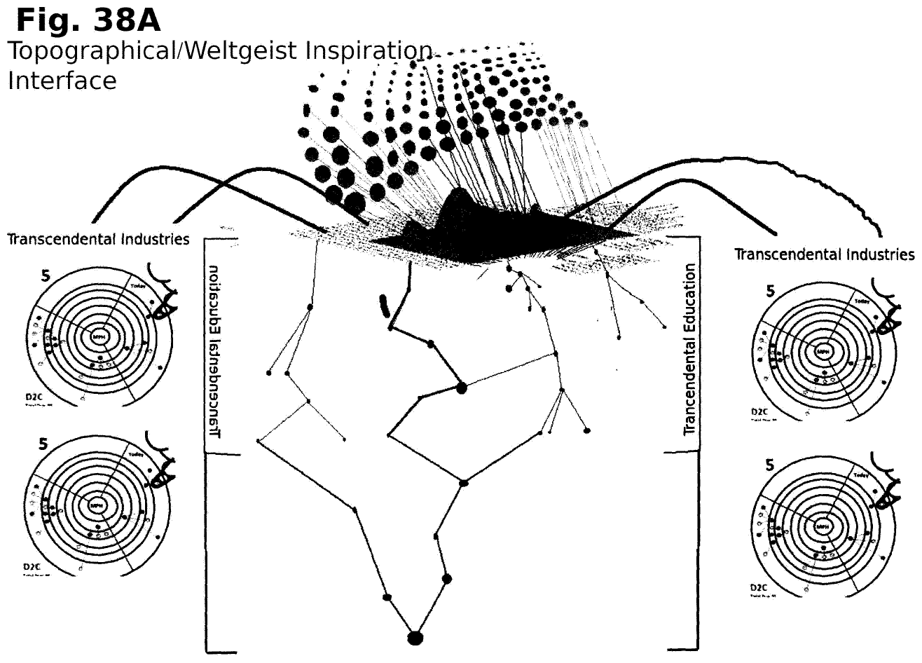

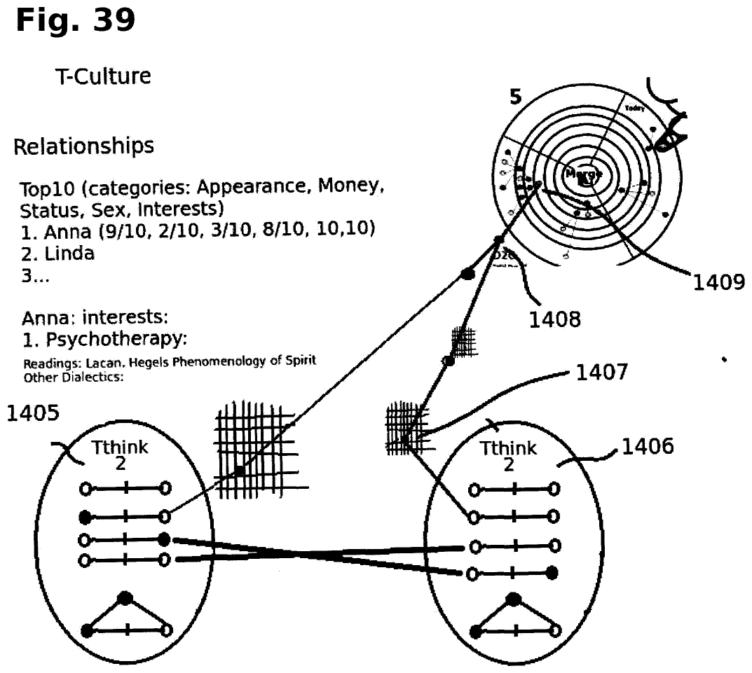

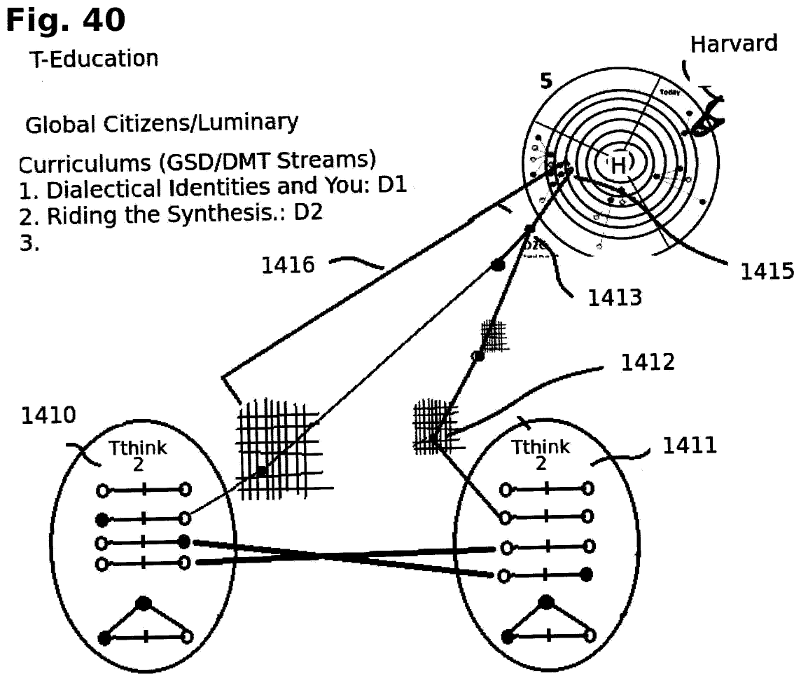

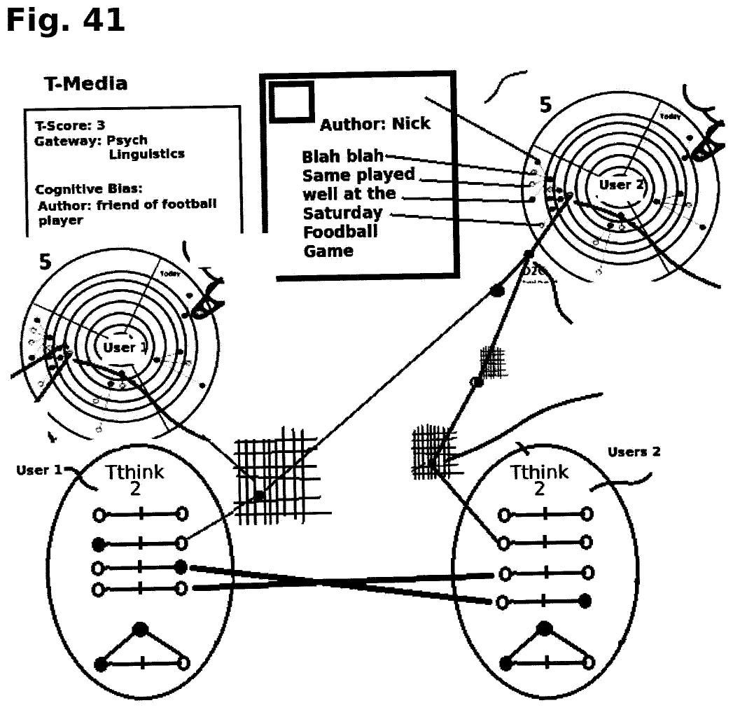

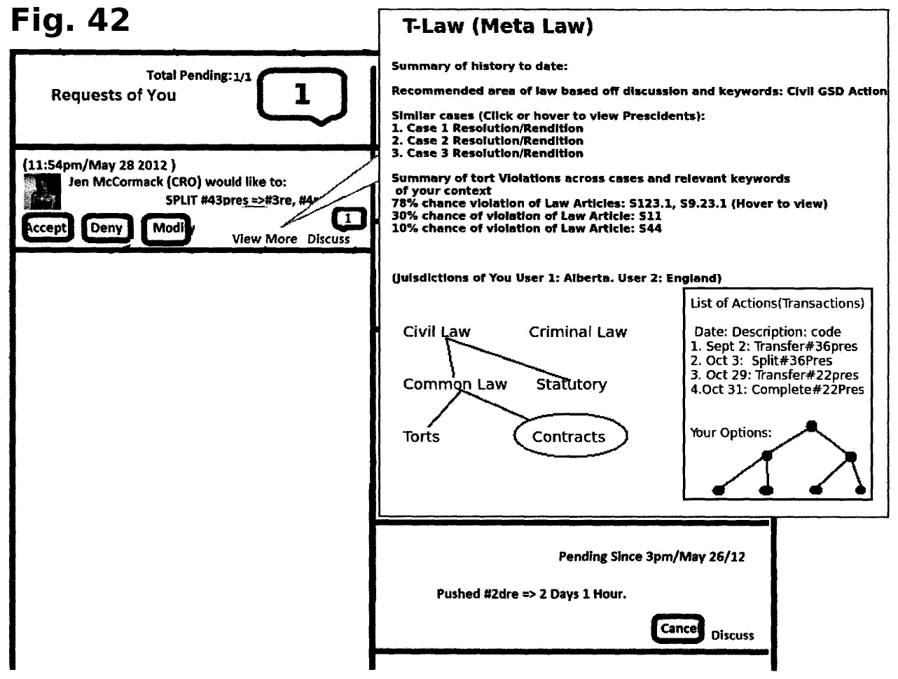

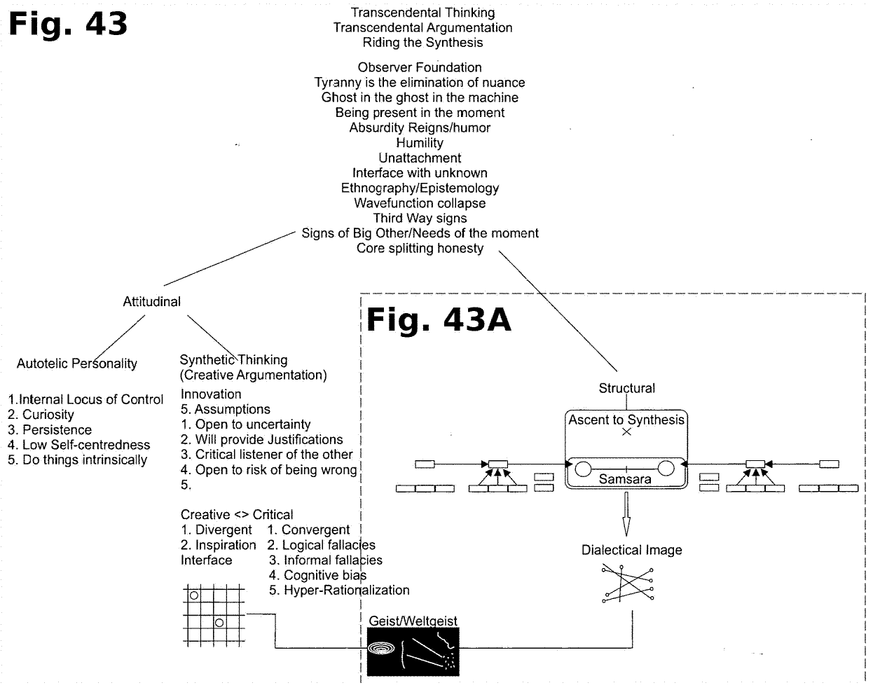

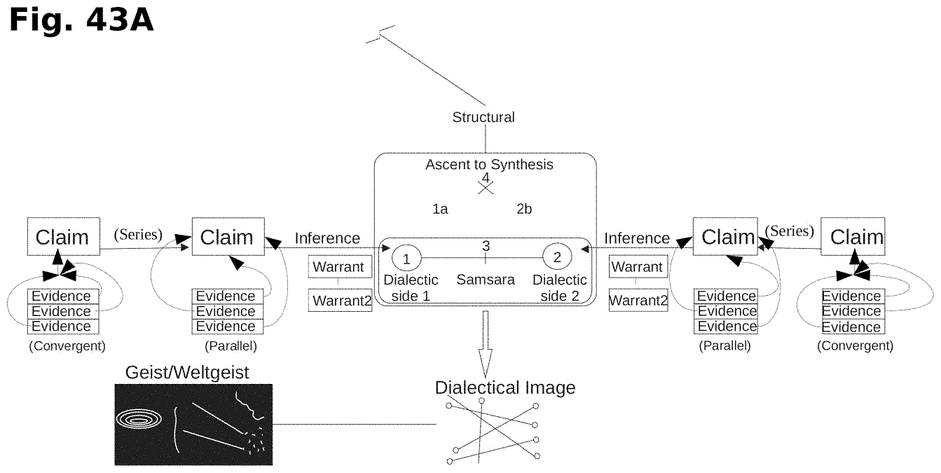

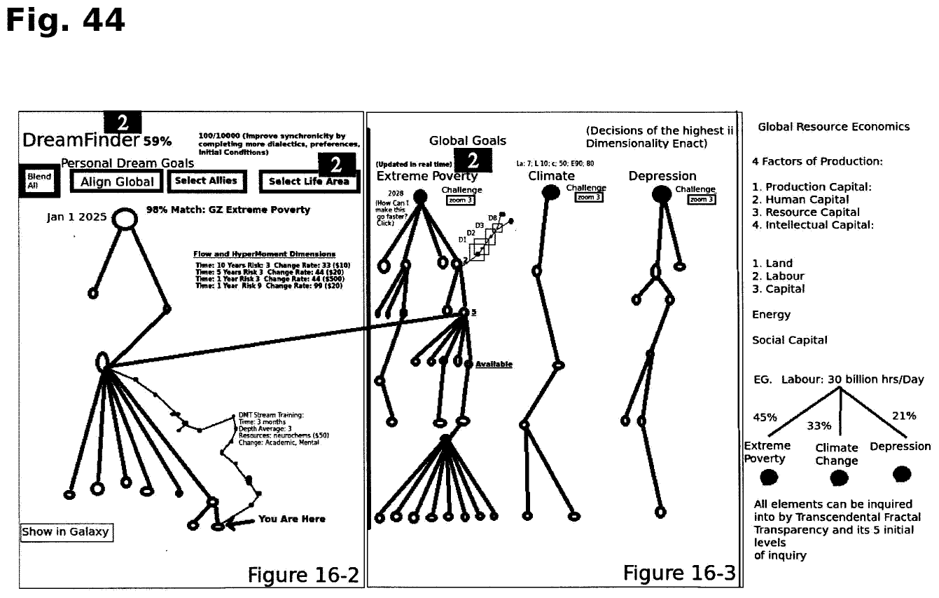

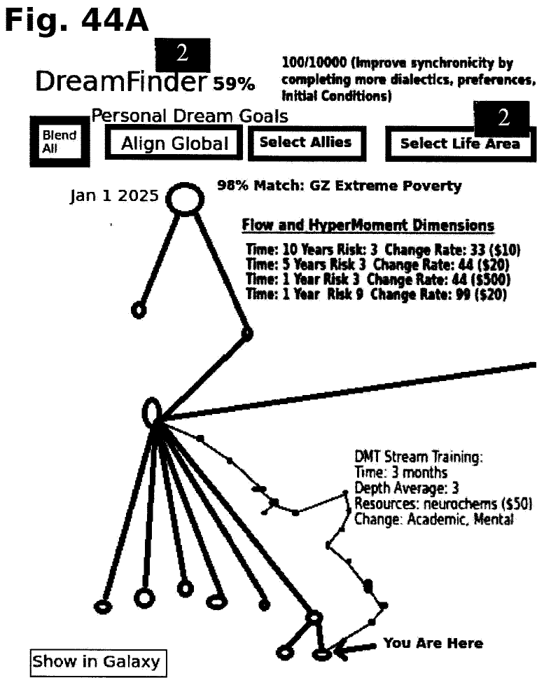

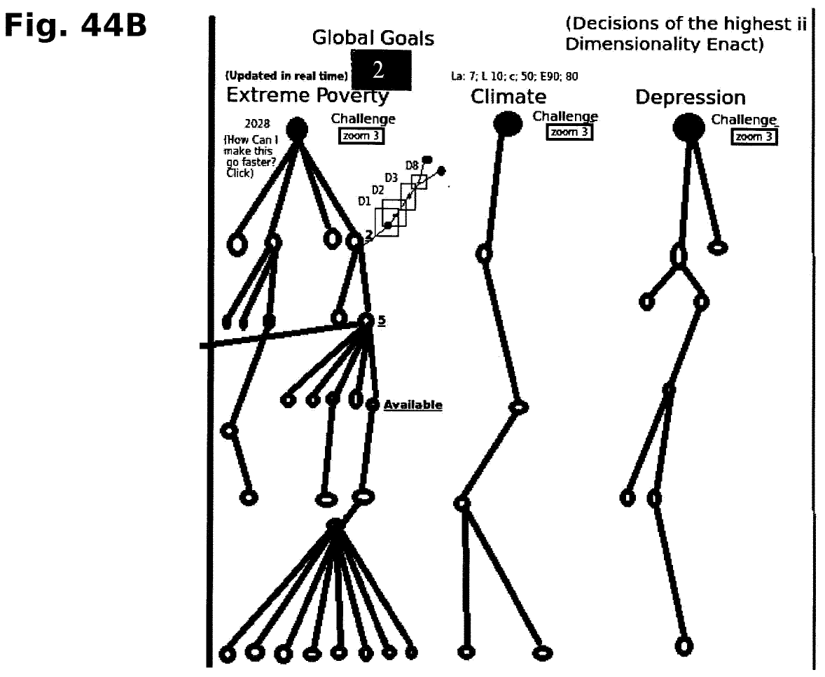

Additional information displays that might be available to a user are shown in FIG. 4 and include: a pie graph showing the proportion of various task types entered; a wellbeing tracking of the user based on certain inputs provided; a graph showing the user's tasks created numbers and tasks completed; and a superimposed graph of the wellbeing and task tracking graphs. FIG. 4 shows the analysis of a single user's performance statistics in terms of the five task types and the user's wellbeing score, based on five or more variables. For example, if a user performed sixteen splits tasks on February 8, then a line on the graph will show that as being a very active day for splits. Each day the user is performing some sort of task actions will be indicated and if no task actions are taken the lines will be flat at zero indicating there is no activity of that user on that day. Then the user can toggle “averages” or lines that indicate how many tasks per day of a certain task type were performed. So if the system calculates from the user's history that they performed about three splits each day, then it will draw that “average split line” across the screen. Then on the graph the user can easily see that sixteen 16 splits on February 8 is above the user's average performance line for splits. Averages can be calculated for each task type. The user can also see if their wellbeing (how they feel) on a given day changes based on how they perform against their typical average performance. If the user's wellbeing is very low on February 8th, then that may indicated that sixteen splits may be too many.

Pie graph 2 displays the total amount of energy or time in each task action type. If the user performs 100 tasks, the percentage will show for which task action types they are partitioned into. Graph 3 shows the wellbeing of the member measured on five variables (corresponding graphs for the organization galaxy at large can be made). At the entry point of the member into the task synchronicity system, users input whether they have done each one of the five variable tasks (such as get a good sleep (yes or no), eat right today (yes or no) etc. which can be customized to suit the potentiality, genetics, and idiosyncrasies of the user for optimal health. The system then adds up for that day how many yes or no's there are and then graphs the result. The system also takes the average of all days or other selected ranges and may also show the average organization galaxy wellbeing of any selected organization galaxy including ones the user is a member of, and also the global wellbeing which is the average across all members in the task synchronicity system as users, and/or within organization galaxies.

Graph 4 shows the user's average task performance across each task action type and also compares their performance to the organization and global averages in each task action type and number of tasks performed in each type. Lines can be toggled on and off to prevent cluttering at the user's preference. This graph can be separated or combined through toggle options available through pie graph 2. Timeline 5 allows for a time updated graph. The example shown provides Day 8 as the current day. No completing or creating or pushing can happen past this day even though it can be plotted as speculation curves. One of these important speculative curves shown is the tasks pending to be completed each day in the future by the user, organization, or global base. These curves will be influenced by transcendental Bayesian risk management practices based on overdetermining social, economic, political and other analyses.

Pending line 6 is a speculative curve. This line will look the same as the “tasks due for completion each day” except that if users complete the tasks early, then they are removed from the pending day and the pending line 6. If no tasks are completed early then the pending line will align perfectly with the “To Be Completed Speculative curve”. This provides a useful idea of performance ahead of expectations. The pending line becomes the failed line if the tasks constituting it are not marked complete by the deadline in real time. This line and all lines can be for personal, organization, or global sets.

Graph 7 is a superimposed version of graphs 1, 2, 3, and 4 i.e. the wellbeing and performance graphs. The bars are the wellbeing scores across the customized variable indicators (five variables being used an example) and the lines are the tasks performed in time and also the present day and the future. These lines can be toggled to suit the user information needs. This graph and data will be used to see if there is a recognizable trend in performance and wellbeing, their correlations and synchronicities in relation to flow state analysis and coordination.

FIG. 5 is a table available to users showing the status of tasks. Panel 8 contains the requests from other users to that user (also referred to as THistory). These requests can be acted upon by accepting, denying, modifying, or discussing. These requests can be for tasks that the owner owns or does not own. The opposite panel is for requests that the user makes to other users or parties and contains actions and updates on how their requests to others are preceding (also referred to as RHistory).

Section 9 shows a tally of how many unseen new requests from others to the user are available. In the fraction the first number is the unseen new requests and the second number is the requests that have been seen but not acted upon. Some requests can be blocked, removed from notifications, deleted, or sent to archives. In some embodiments these options may be restricted. Panels 10 are a notification for new unseen comments in the discussions across all the requests in the respective incoming and outgoing requests.

Buttons 11 contain accept, deny, and modify buttons for activation by the user. Accepting confirms the action and denying denies the action and activation of either is relayed to the requesting user's RHistory as a new notification. Modify allows editing of the request to allow amendments to wording, variables, task action type, extra splits, pushing of deadline and more, which are transmitted to the other users RHistory for confirmation, discussion, denial, or further modification. These will formulate the formal micro-contract negotiations which can be referenced in transcendental legal disputes.

Section 12 includes the request description. Each task action type has its own unique set of symbols to depict in a short sentence the action being performed including codes of the owners and specific tasks. Hovering over the description may produce a visual of the task tree(s) that the task or request may be associated with.

Section 13 allows for a user to view more by clicked to display all the information about the request, including all other variables and charts that may be of interest to the user including price, points, task market movement, skills, knowledge, talents, personality traits, love languages and more. Flow indicators 13B allow users to select to display flow indicators on the request cells directly. The left hand circle denotes a color of how the user may emotionally experience the task if the request were to be accepted as is without including formation of the current user's pending limits of task burden. The right hand circle contains the flow state color with all of the calculations of the left hand circle but including also the burden from the other user's tasks. The percentages indicate how accurate the prediction may be based on the completeness and accuracy of the information and filling in of variables for the task and user profile.

Discussion button 14 may be clicked to pop up and display all back and forth comments between users. Third parties may be invited into the log and may be citable in legal disputes over evidence of completion, or agreements on each task type.

Section 15 shows the total number of requests that have not been addressed by the other party and the number of new unseen responses that have been addressed. The number of new unseen responses returns to zero when the user views the responses of others and makes the corresponding corrections to the user's points, price, monetary resources, scores, pending limits, task trees and partners.

Panel 16 contains a sentence declaring that the other user to which the request was sent has now responded with an “accepted” which means that the linked action type in the description has been processed today at 11:30 am. Like THistory, these update tags can be accepted, rejected, or modified with the modifications being show in the description.

Panel 17 contains a flow indicator similar to flow indicator 13-B, except that panel 17 shows the flow score of how, for example, user # int would experience the request as designed by user # pres. The score is represented by the colors. The left hand circle designates how the user # int may feel about the task on its own and the right hand circle predicts how the other user may experience the task given their current pending limits and current workload. The percentages are based on the privacy settings and information available to both users. Low percentages could indicate a lack of reliable accurate information for synchronization. Designing requests and building flow scores for others can be done in request/task design panels or while performing task action types.

Section 18 shows an example of a modified request depicting the original request as “old” being a split action type and with the other user modifying the ownership for one of the splits such that, in this example, user # dre keeps ownership of one of the splits from #46pres. User # dre also modified PGoal Change and increased the price of the task action. Cancel button 19 allows requests made to be cancelled before requests are accepted by the other party. Once accepted negotiations are returned the task must be in order. Section 20 contains a marker of when and how long the request has been awaiting an answer from the other party.

FIG. 6 shows the “list view” of all the information transactions a user has. It functions as a To-Do list view divided into two categories: one category is of tasks that the user currently owns, meaning the user is responsible for completing them and will be penalized by losing points if the tasks are not completed; and the other category is of tasks the user could own, but are deferred while the user waits for others to confirm or deny the user's requests to them.

In a task galaxy there may be “roles” defined. Those roles are a set of rules that dictate what kind of attributes a task should have to “fit” with that role. So if a user is the Chief Financial Officer (CFO) then most of the tasks should have something to do with the Skill or Knowledge of “Money”. So most of the tasks of the CFO Role (i.e. the Domain of that role) will be defined by the Skill “money”. So in the example shown in FIG. 6 4/10 would mean that the user's Pending Limit (the number of tasks a user can have on the go that are not complete) is a maximum of 10 (as defined by the user's user level) and that in this example the user is using 4 of those 10 available. Now of those 10, 20% at most of them (i.e. 2) can be outside the domain of the role, meaning that they can be tasks that have nothing to do with money. So the “remaining” section indicates that out of 10 domain tasks 2 of them are in use and out of the 20%, 2 of them are use (which is 2/2 for this user in this example which is at 100% their maximum tasks allowed outside their domain (i.e. role)).

In the second category on the To-Do List there is also an equation which in the example says Ownership Pending: 4/6, which means that if the user only has a creation limit (pending limit) of 10, and 4 of them are being used already, then they can only ask others for a maximum of 6 more before they are at their maximum. Of the 6, 4 are already awaiting responses which mean the User can only make 2 more new requests to other users. Now back to the first category i.e. the Already Owned tasks, the 4/10+4? means that the +4? are the 4 tasks in the second category that are waiting ownership status. So what the equation says 4/10+4? Remaining (2 Domain] 2 of (20%)) is that this user has 4 of their max 10 tasks with 2 of those being inside their domain so they are already at 100% the max of what they can do outside of it while still having 4 more tasks on the go that they might soon be owners of The creation limit indicates how many tasks a user is currently juggling that need to be completed within or without a certain time frame. The request limit is dependent on the creation limit in that the remaining slots for tasks is what the user has space to request which in this case is further reduced by how many slots are already filled with pending requests.

Equation 21 displays which equations are in the domain of the user and any roles assigned to the user and the number of tasks that are outside that role (denoted by 20% in this example). The limit for tasks outside a set domain (for a role) can be denoted as a percentage of time from the total pending limit. In this example a maximum of 20% of the users maximum pending limit (here 10) can be outside the domain. In this example two tasks are outside the domain (the maximum) and two are inside the domain.

Table 22 represents the tasks that are current. It is displayed in a traditional list view showing an equation on top of what the user is responsible for completing, denoted by 4/10+4 meaning that the first four is the total number of tasks the user owns to date out of ten maximum pending tasks (designated with status pending). The addition of the +4 denotes how many tasks the user is waiting on confirmation to own but has submitted active requests suggesting that ownership will be determined in the future.

List 23 lists the tasks for which the user has made requests to own but have not yet been confirmed. The equation denotes how many total tasks have been submitted for confirmation out of a maximum of 6 possible requests. The 6 is calculated by determining what is left from the maximum pending limit once already owned tasks are subtracted, in this case 10−4=6.

Equation 24 denotes how many of the active requests are in the domain of a role and how many are outside of it (again assuming a limit of 20% for outside that role). Multiple roles may be held by one user under appropriate conditions. Column 25 indicates GMS which may be steps from an internal strategy of an organization.

FIGS. 1A and 8 show embodiments of action feed displays that may be available to a user by which the user can observe and change tasks. The action feed, when clicked on from the menu shown in FIG. 1, opens up and shows the “feeds” for a period of time, for example, a week in chronographic order. Each “feed” displays the type of task, a picture of the user entering the task, linked tasks and comments.

With reference to FIG. 1B, section 200 shows the “type” of action, which may include Comment, Split, Push, Complete, Create, Linked, News (e.g. reports on actions of a task or task tree), or fails (e.g. tasks not completed and past the deadline). Image 201 is an image of the person or organization that performed the action type. Time 202 represents the time that the action occurred. Name 203 identifies the name of the person or organization performing the action, and code 204 identifies both the code of the action and also the code of the tasks the action is linked to.

Box 205 displays a snapshot of a comment or description or action type itself and shows the content of the type of action. Hovering over the content or clicking it shows a snapshot of more descriptions and details. The content may be shown in the following presentation styles:

Push: show GSD code and old GSD date and time==>new GSDs time

Link: show # parentcode=># linkedcode

Comment: show comment in quotations

Split: show # parentcode==># childcode, # childcode

Complete: show just the # gsdcode

Created: show just the # gsdcode

News: show whatever criterion defined

Title 206, when selected, opens up all the feeds from a previously predetermined time period (for example the last 7 days). Feed 207 can be organized chronologically. Settings 208 allow user to customize colors and adjust other elements of the action feed.

FIG. 8 displays the settings that may be modified by a user with respect to the “Action Feed”. For example the user can change the colors displayed with the various task types; set filters to search the history of the user's tasks by various criteria; select whether or not to include certain action types; and add their own filters and search criteria.

By the user selecting “settings”, menu 209 pops down. Section 210 allows users to change the color of the news feed box that appears in the action feed. A color palette may open up for selection. Section 211 allows users to select an action type and choose whether or not to view them. Section 212 allows users to set filters that search all history and comments to match criterion and display the results in the same or separate news feeds, with each filter having a customized color set by the user. Users can add their own filters and set their own search criterion using keywords, flow states and variable searches (denoted by a sign).

FIG. 9 shows the rate ticker for display on a user's screen. The user will be able to observe the current point rate for completion and addition of various task types, and thereby know the value of the points received when a particular action is taken. The ticker may be shown scrolling at the bottom of the user's page. Global rates 300 are the number of points added to the stock of the user who performs the action type. Each symbol represents a task action type. For example, as shown, if a user performs the “complete” action type, they will receive the global rate 34 points. Global rates may fluctuate by equations, which for example may have two main functions that balance each other. When a user completes a task the system reduces the task complete global rate by the amount x/# of tasks of all users. But the system may also at the same time increases the create task action global rate by the same amount. The variable x is an arbitrary variable that is set by the administrator in this example.

Personal rates 301 (with each symbol representing shorthand for a task action type) are set of rates for each task type for that user. As the user performs the task type they receive “stock points” which level up each task type. The higher the level, the higher the rate that user receives. Whenever a user performs a task type they get their personal rate but also the global rate is added to the stock of that task type which helps the user to level up. Each user has stock for each task type but stock may only be added to a task type if that task type is performed. As an example, the user will only get “create” stock if they created a task, not when they push or split or complete a task.

At section 302 users can select, or hover over the titles to see menus of the global rate equations (as show in FIG. 16) and the past histories of global performance and trends as well as a fuller profile of their personal caps and scores (similar to that shown in FIG. 2).

FIGS. 10 to 12 show how the Administration Tab is used. There may be several levels of user privilege, for example five levels. A first level may be a preview user, i.e. a user that can only view the system but not create or change anything. A second level may be an individual user that can create their own personal task galaxy and tasks and link them to others but may not own organizational galaxies. A third level may be a user who has privileges of the first two as well as privileges to administer a section of a galaxy but not the entire galaxy itself or can create new sections in the galaxy or directly change other sections in the galaxy. A fourth level user may be one that has all the privileges of the previous four levels but now administers an entire galaxy and can create new departments in the galaxy. A fifth level user may be one that has universal privileges that apply across all galaxies whether personal or organizational and can make any changes within the system. A possible sixth level user may be an owner of the system who can make any changes to the system and within the system that any of the previous levels can.

FIG. 10 shows some of the options available if the user has the appropriate level. For example, they can change the formulas for the point values, or change menus that display options. FIG. 11A shows how users can assign awards to other users, either by selecting the user or by adding a rule used to select the award winning user. FIG. 11B shows how level four, five or six users can assign awards for achievements that the system tracks. Such users can even build their own award criterion in two categories: manual awards that do not require much automation by the system; and awards that can be calculated based off of performance metrics in the system. Users have the freedom to create their own awards using the system data and a “role designer” may be created whereby a user can create a title and select what criterion (skills, pgoals, knowledge, other task variables, etc.) will dictate the domain (that role may be assigned to users).

With reference to FIG. 10, section 400 is where an administrator can enter a number to set the global rate equal to a specified number. Section 401 allows an administrator to configure equations that govern the global rates for the task action types. In the embodiment shown there is a first function to govern the equations when a task is created and a second function to govern when a task is completed. See FIG. 16 for example equations where 15 is an arbitrary value set for x.

Button 402 provides help to analyze and edit personal rates. When “on” the view is expanded including all contents of the cells, making the list much larger but showing all details of the user or select details. This allows easy comparison between users in the database. List 403 provides a list of members that may be, for example, in an organization galaxy or even the entire system. All of the variables attached to a user may be displayed. These rates can be adjusted or altered by an administrator.

Section 404 is used to change settings on the action menu such as how many action types to display, or to add in new action types with custom variables such as but not limited to triple splits, or shortcuts.

With reference to FIG. 11, section 405 displays a list of awards that need to be assigned soon manually as they require human level cognition. It also provides a list of suggested members who may match some of the award criterion and an assigning box where an administrator can select “urgent” and the list of suggested make assigning the awards easy.

Section 406 tracks awards that have been assigned but not yet delivered (once awards are assigned they may need to be delivered). When “yes” is selected the award is removed from this section. An option to delete an award from the list may also be present. Number in brackets 407 indicates the number of awards being handed out that day. The system may also suggest the best days to deliver the award. Administrators can select the suggested date and change it.

The administrator can define functions 408 to check user profiles and assign awards automatically. The user will receive a notification or icon in their profiles immediately or when they login next. There may be different scopes for different awards such that awards of a certain function may apply to the entire universe or to a galaxy or a personal award depending on permissions.

List 409 provides a list of manual awards. Functions may not apply so a description field can be used (although variables can be applied later if desired). In the “criterion column” discussion may be had and recorded on why the award was given to a particular individual and may be revealed to all participants to assist transparency.

Log 410 provides a location for logging actions pertaining to awards set chronologically by default. Notes can be added to each line by admin. Bow 411 shows the time, recipient name, number of awards the recipient has received along with name of last award received. The time is of when the last award was received and also shows if there are any users who have not received an award for a period of time. Summary 412 summarizes the awards/rewards per time interval. Trends and other analysis can be shown over time. Increased awards may correlate with increased performance.

FIG. 13A show the use of “task galaxies” according to the invention. Task galaxies can be presented in any shape but in the embodiment shown a circular shape with concentric circles that form rings. At different zoom levels different information about the galaxy is displayed to keep information processing of the user intuitive and effective to prevent overload or underload of cognitive and sensory processing. Task galaxies may be updated either in real time or at intervals as selected by users with the appropriate administrative access. Users can own multitudes of galaxies depending on privileges of their user account and the statistics in their account (based on the rate ticker i.e. the personal levels of the user as built from the rate ticker rates) but can also be generalized into two, but not limited to two, categories: personal and organizational (Groups). Each ring in the galaxy can represent a date with the dates moving from the outer ring (the current date) inward to the future, or with the inner ring being the current date and moving the future outwards. Nodes or tasks can be created dynamically within the galaxy. The size and organization of the galaxy can update automatically to prevent too much cluttering. Tasks can be connected by visible lines showing dependency. The ring in which a task resides is its deadline date. Tasks that are closer to the present must be due before tasks in the future which have a dependency on them in order to have the task action of “Completed” performed on them. Types of tasks may be identified by color.

FIG. 13A displays a color bar referred to as the flow bar, which fluctuates based on tasks entered and completed. The more tasks that remain pending and uncompleted the more the bar will indicate anxiety. The user may set the flow motivation variable to “off1 in which case no anxiety will be indicated.

Each section of the ring may refer to a “department” or a portion of the galaxy that is sectioned off by those divider lines. In the embodiment shown the Stand/FTC/D2C are names of projects and departments from the “Make Poverty History” group. The ring also displays the tasks associated with the section. When a user clicks on a ring, statistics relating to that ring will be displayed. Tasks are represented as nodes “owned” by users. If a user moves over a node with their mouse cursor or other controlling device a profile of the task associated with the node appears. A user may drag a node from one galaxy ring to another, and thereby performs a “push” action on that task. Alternatively, if a user clicks on a node, and action menu appears, allowing the user to select an activity associated with the task. In a galaxy display, all nodes associated with the user will be differentiated, for example, by glowing.

FIG. 17 shows an alternative embodiment of a ring display showing how users can drag and zoom into portions of the ring to see the timing of associated tasks. Alternatively, rather than a ring, a three dimensional display can be provided.

The user may drag nodes along the date ring, in which case all linked nodes will move with it. If a parent node is selected, all children nodes (i.e. subtasks) are highlighted with it. A parent node cannot be pushed to an earlier date than its children and if the deadline of a parent node task is “pushed”, the children's node tasks will change by the same amount.

If a user clicks on an open spot in the ring, information about the date is displayed, and a “create” task option is made available. Users can move entire rings in their display at the user's convenience. If a user selects a “split” option with respect to a node (task), two new linked nodes (tasks) are created. They are indicated visually as “incomplete” for example by shading or the like, until the user completes inputting information for them.

With reference to FIG. 13 and FIG. 13A date ring allows a user to quickly view upcoming tasks: The outer ring may be by default the date of “today”. In this embodiment the default is for each ring to move into the future by the interval of time represented by each ring. All tasks move through the last ring and are either marked complete or pushed further into the future. The rings update as time flows with tasks, nodes and rings of the past not being shown unless a history view is selected wherein the user can extend rings past the “today” ring. All task notes and trees after the current day are added to an archived history list for referencing and the rendition system. The outer ring at midnight is deleted and all other rings shift out along with the corresponding task trees. Clicking on an empty space in a ring aside from highlighting the ring can also pop up the “create” menu option, create a new node and drag it through the ring into other sections.

Clicking on a ring 501 highlights it and provides information about the aggregate data of the ring such as total tasks, user specific tasks owned, potential interesting tasks, flow states of tasks, and any other variable or combination. Each ring can be divided into its smaller units of time. If the day ring in the example shown, represents a 24 hour day, then 24 hour rings can be drawn as the ring is expanded.

When a ring is expanded FIG. 13B-502 it divides into lower time intervals per ring. It also simultaneously can divide task trees. Different zoom views can hide smaller divisions of tasks such as in the example shown the today ring can be expanded by dragging the lines outward. The system will draw in extra “hour” lines and will split the task node with a “2” above it into its two smaller hour tasks. The other “Green” task will not divide as it did not have a number indicating smaller segments (this task is defaulted to midnight). Other embodiments to indicate number of “hidden sub splits” at a given zoom level may use node size or other attributes to convey number of child nodes in addition to or replacing the floating “2” indicator.

Group name FIG. 13A-503 of the section is displayed. The user can choose to organize the galaxy in different ways including sections defined by straight lines across the rings. In the embodiment shown the entity at the centre of the galaxy is an organization but these divisions can also be done for personal galaxies, for example to divide into potential life areas.

When a user clicks the section/group name a menu FIG. 13C-504 can appear with a display including group pictures, statistics of the group including tasks of all status and types, graphs, wellbeing and more. There is also an action feed which serves a function similar to the main action feed described previously, but is specific to the section/group/department.

Task nodes FIG. 13A-505 are connected to one another via lines referred to as edges. The nodes 505 closer to the inner rings are often parent nodes and those closer to the outer rings are more likely to be child nodes. Generally the challenge level increases in more inward (future) tasks. If a user hovers over a node, a pop up of the “profile” of the task node 505 is called. If a user selects and drags a task node to a new ring, it automatically performs the task type “push”, pushing the deadline of the GSD to the new date. If the user selects a node, an action menu is presented, which in one embodiment has the node at the center of the menu. All nodes that a user owns may be denoted in a visual marker such as but not limited to glowing. Rings expand as needed to ensure there is space to include new nodes and can shrink to accommodate deletion of nodes. Users can also rotate their view around the galaxy and nodes.

A head or parent node 506 when selected, displays information about the children as an aggregate of the task tree. When the head node 506 is dragged so are the children by the corresponding amount or by a push menu that provides customized moving options for children (such as moving some nodes and not others). Showing which head nodes 506 (sometimes known as projects) the user's task node is linked to can help convey purpose.

The entity 507 at the center of the galaxy may be either an individual or collection of individuals formed into an organization. Pending nodes 508 is in the process of being created but has not been finalized. These pending nodes 508 may be manipulated and moved without permanent alteration of scores for planning purposes. These pending nodes 508 can be hidden or viewed given specific privacy privileges.

Comment flags 509 indicate the presence of a comment made in relation to the indicated node. Such comments may be used to formulate a discussion. Flags 509 can be set to pop in real time or stay up until acknowledged.

All tasks can be assigned a color based on matching the task variables with the user profile variables. This is used to create flow scores represented by colors. Flow bar 510 shows which colors correspond to particular states and can be customized by the user. For example, green may also be used to denote “completed tasks”.

When a node is clicked action type circular menu 511 is invoked and appears with the node in the center.

With reference to FIG. 14, information overlay 512 corresponding to task node is shown. The top section provides a summary of details of the user who owns the task node including code, statistics and any variable not confidential due to privacy settings.

Embedded task action menu 513 may be in the center of the task node and in which all information in the overlay pertains. Task action types can be performed by selecting the quadrants, or alternatively by selecting and editing the task node information that will display in overlay 512 and in the database.

Task node details 514 including if this task node is connected to a parent task node and what its code is, challenge score, flow score in relation to variable matching between task node variables and user profile variables, if this task node is a part of a rendition, price to complete, and deadline. The description of the task node may be a short sentence 515 with keywords.

More variables 516 help the user see what skills, knowledge, talent, needs, group type and time is required to complete the task. Users may click on the required skills, knowledge, or talent and open a DMT Stream view as referenced in FIG. 34. A panel 517 of all child task nodes is shown attached to this task node. Each child node receives its own column for discussion and comments. The user can see how many new comments and how many total comments in each column are denoted in this embodiment as (1/10). A user may reply directly to each comment. Comments may be organized in many ways such as chronologically, by keyword, or by relevance. Child node comments are situated via creation date, keywords or other variables of interest to the user. Child nodes may be denoted by owner codes 518. Keyword MILT chains may also provide suggestions to other task nodes outside the parent task tree. A banner 519 of a business, social enterprise, or some other match that may help the user accomplish the task in question may be presented. This may be a paid spot for matches from the synchronicity database as described below.

A user may purchase or use renditions 520, or templates of similar tasks, projects, keywords from the database, friends or other users that have renditions for sale, or use. Licenses may also be provided. See FIGS. 26 and 27 for renditions menu.

A search 521 for another social enterprise, businesses, users in the users network (friends etc.) in the network as a whole or who may be able to help complete or perform other task action types may be presented. Examples 522 of other suggestions of providers either paid or from synchronized matching or both as words and picture depictions may be provided.

FIG. 2 shows the zooming and dynamic content process. Users can interact intuitively with the task galaxies and task universe by zooming in and out and having the system display more or less information depending on user preference and other settings. Rings in the task galaxy can assume different dimensions at different zoom levels for example each ring can represent an entire year, or a month, or a week, or a day, or an hour as selected by the user.

FIG. 1A-600. A User can zoom in and out of galaxies and even the task universe (also referred to herein as the Dreamscape) which can include many task galaxies in view (as shown in FIG. 18). When a user zooms out, finer details are hidden and more general details are enlarged. This is the dynamic view content. When a user zooms in the view becomes more defined as the picture of the owner, the code, the description and any other pending actions or variables are shown. As a user zooms out smaller task trees may coalesce into a single large task node with its aggregate color being determined by several techniques, one being the average of the flow variables amongst all the children nodes. The user can select how the color should be determined. The more challenging a task the further out a user can zoom and still see it. Date rings also become more defined as a user zooms in, smaller rings representing the smaller constituent time units (such as hours for days, and days for weeks, etc.). Zooming serves to show more details without the information overlay having to appear and without having to select or hover on a task node.

Each task node has a code 601 embodied by the owner code. The task action type is represented in symbol view 602 for brevity, which shows which task actions are still pending on the task node. Multiple symbols may be shown. A picture 603 of the owner may be presented and a short one sentence description 604 of the task node.

FIG. 15 shows the “Dreamscape” of the task universe (also referred to herein as the Tuniverse). This allows users to position galaxies of tasks, for example by moving them closer or further or organizing the galaxies using different filters or different variables (for example by the task galaxy itself, the users or the task).

Multiple organizations and personal galaxies 700 can be mapped in relation to one another depending on, for example, how the variables of their organization, people and tasks correspond. All variables can be used to match with similar groups migrating towards one another as if gravity is pulling them together. Galaxies can be arranged via this “gravity” caused by similar matching variables or by a custom arrangement by some users in unique circumstances. For example galaxies shown touching may be working directly together on tasks or projects. Typically larger galaxies indicate more active, productive and larger organizations and people. Users can search the task universe to view all galaxies although some details may be hidden due to privacy settings.

A task universe map 701 shows the layout of galaxies across the universe. Users can customize the display based off of which galaxies they wish to be viewable. A cluster 702 of galaxies can form indicating similar relationship in the zone. This zone could be, for example, a shared industry.

FIG. 15 shows the current view 703 of the screen within the task universe at the current zoom levels. Zooming out 100% can show the entire universe unless otherwise specified in special circumstances such as computational restrictions, or privacy. A task action type “link 704 can occur between task nodes in different galaxies forming a bridge. These bridges can be toggled on and off to make the map less cluttered or more informational.

FIGS. 17 and 18 show alternative embodiments of a task galaxy and a zoom thereof. Menu 901 allows a user to select the time unit represented by each ring in the galaxy. A change in zoom can be initiated with bar 902. The left hand screen is at 40% zoom and the right represents a change to 10% (zoom out). The galaxy is in the center is the same in both screens in FIG. 18. Option menu 903 allows a user to select rules for ring display. The user can also select a viewing orientation. Tasks can be linked to each other across galaxies. Organizations can use galaxies to split groups, for example by department.

The user can also select how far they want a view to extend into the future and into the past. The default of any view will be to show as many rings as needed to show all the tasks of the task galaxy. So if there is a task due two years away and the user selects the “Day” ring view level then the ring will show about 730 rings if there is at least one task on each day of the year for those two years. The task galaxy can omit rings that do not have associated tasks, so if there are no tasks between today and a day 730 days in the future, then the task galaxy will only display two rings unless selected otherwise: Today's ring with today's task and ring 730 with the task. The system will then display a line connecting the task in ring 1 to the task in ring 740.

FIGS. 19 through 21 show and describe how the system uses task strength levels. Basically the system calculates a task strength level (i.e. challenge level) and a user strength level. Both of these are calculated using the variables attached to the user and the task (for example, pgoals, skills, talent, knowledge etc.). Then the system matches them. This can also done with groups as well as individuals as shown in FIG. 21.

With reference to FIG. 19A, scale 1000 is used to measure flow between matching and unmatched strength variables between a task and user. End 1001, in the embodiment shown, represents an outweighing of unmatched variables vs matched. Task node FIG. 19B-1002 is an example of the same task in two different user flow frames. Due to different user profile variables, the yellow task is located in different areas of the graph. A flow channel 1003 is shown in FIG. 20 and two different tasks 1004 positioned in the flow channel gain a higher chance of flow despite being in different emotional sections of the graph. Global frame 1005 is superimposed with a smaller user frame using a percentage scale. Two user frames 1006 may be superimposed. These frames are used to calculate a curve of consciousness and hypermoment calculations. Alternate scales may be used.

FIG. 21 shows a task node 1007 outside the current frame 1008 of human knowledge. A task outside the zenith of human knowledge is not accomplishable by a single individual under natural circumstances or by the whole of human race at that time. Humanity's knowledge can grow its strength to eventually encompass this zenith goal. The global frame of human knowledge also known as the zenith. The sum of all knowledge, skills, talents of all humans and contributors to such powers create the outer perimeter and the global flow frame can serve as a psychological state of humanity as a single consciousness. Other emergent effects can be incorporated over time.

The human zenith grows along both axis 1009 as individuals, machines and the capacity of humanity as a whole increases to be able to take on greater and greater zenith goals that previously were outside its capabilities. Any subsets of humanity (groups, organizations) grow and expand and have a shared flow frame similar to this global example. All tasks within the human zenith parameter are theoretically achievable given current levels of human capacity across flow variables.

Each variable 1010 used to calculate the axis limits may have different levels. The number of skills, knowledge, talents and other variables play a role in determining the frame 1008 but so do the levels of competence and expertise, recency and other variables as shown here. A user or group may have talents but that the talents have varying levels of competence as shown by the bar length. The axis may then be calculated via averages, maximums, minimums or other combinatorial techniques.

### Example Use Case: Stand Against Poverty Mega Event

In this example, a user, Mark, wants to plan a large event. He wants 10 organizations from nine spheres to setup display tables and to interact with an estimated crowd of about 1000 people. The event is called the “Stand Against Poverty” and occurs annually. He decides to use the system according to the invention to plan the event. He then goes through the following steps:

He first goes to the appropriate web page where he registers an account using a social networking site or a new ID. He verifies the information through email or text and then signs into the web site.

The system opens and displays the user's personal task galaxy (PG) as completely empty and undivided as no tasks have been added yet. The system then goes through a training process, to show the user how to divide the PG into sections and create custom divisions or to start with a life areas template (which subdivides the PG into eleven 11 equal spaced Life Areas: Physical, Mental, Academic, Spiritual, Family, Friends, Intimate Relationships, Political, Dream/Global Citizenship, Financial, Hygiene/Misc./Travel). The system also shows user how to create a new task in their PG by clicking on rings. It shows the user the creation menu and goes through the variables in it (e.g., 146 Character Description, Deadline Date, Unique Task Code, Custom Strategy Variable, Section, Galaxy, Skills, Knowledge, Talents, Pgoals, Leadership, Follower and Life Areas.) The user is then shown the life graph analysis of each section of the task galaxy and the task galaxy as a whole and how it updates with each task, and then how to create additional task galaxies that they will own for different organizations. Finally, the user is shown their profile page and can begin taking tests and filling out personal and professional information. The system can provide updates from social networking sites such as FACEBOOK or TWITTER.

The user then chooses the Life Areas Template for his PG. He then chooses the “Create Organization Galaxy” option and is shown the Universe Dreamscape and can apply to place his Org Galaxy (OG) in a “cluster” of similar focused task galaxies or pick a spot to bring it into existence.

Once the Dreamscape location is set Mark is then given an option to: Name the OG. Mark names it Make Poverty History (MPH). He decides to divide MPH into four sections (one for each Project Group) and one for the Executive. He is automatically made the Owner and President (CEO, Leader etc.) and is then given the option to recruit people to the OG and to give them titles and roles. He then has the option to set the permissions on each role. Mark opens his network and recruits four people to four Executive Roles (Nikita: CSO; Conor: CMO; Robin: CRO; Melissa: CFO) and three Project Leads (Sam: D2C; Ian: Fair Trade Group; Connor: Stand Group). Permission settings include: what task they can see in that role; what tasks they can edit in that role; what task variables must be in their tasks if any and what percentage can be inside and outside their portfolio (defined by variables); and what notifications they receive.

Mark is given the option to set how open the task galaxy is to the public or other organizations, or other networks, similar to the Roles, he can decide who can view, edit the task galaxy and its sections, and how the recruitment process occurs (can anyone join, select a role, or is a role assigned in the task galaxy to review and approve and assign new members) and selects notification settings, and a custom Rate Scheme (points for users in the OG).

Mark then selects that any tasks associated with MPH are linked to his PG in the Dream/Global Citizenship Life Area. This means that when Mark creates a task in MPH OG, it is also displayed in the rings of his PG in the section he assigned during the setting of the Roles/Permissions for his role.

Mark then clicks in the Stand section of the MPH OG. The creation menu is displayed and Mark creates the first task for his Stand Against Poverty event. This is the Head Node. (Once finished updates spread across those with the correct permissions in the task universe). This node also shows up in his PG in the corresponding section and in his To-Do list. It also shows up in the Global List OG list. His statistics in his User profile (i.e. in this example his “Create” states) go up by one point. Anytime a transfer, link, create, complete, or push is performed it automatically updates the relevant Profiles and the Rate Ticker Globally, .i.e. Once Mark created this new Head Node it not only increased his Create score by 1 it also increased the Universal/Global and OG Create rates by 1.

While the Head Node is still highlighted, he clicks on a blank ring and a connecting line is drawn from the head node to the new node to create a link. This node also shows up in his PG. While Mark was making the link, he gets an update in his THistory saying that Connor has split his head node into two new tasks. He reviews them and confirms them and gives ownership of one of the tasks to Connor. Mark asks Nikita if she can take ownership of the other task and she does. Mark now only owns the head task and the first linked task.

Conor and Nikita complete their tasks and submit evidence. Points are awarded based on their personal rates and the Global Rate Ticker. Mark gets an offer from a member of a partner task galaxy in the same cluster. He transfers ownership to the other task galaxy. The node is replicated in the other task galaxy and linked in an inter-galaxy line. The partner task galaxy completes the task and submits evidence.

Once the event is over, Mark then flags the head node complete. Upon completion of the head node, the Rendition option is displayed. Mark decides to save the rendition. All statistics are updated and added to the Hero Profiles.

A year goes by. Mark clicks to create a node in Stand. He opens the rendition option and selects his old Stand Tree and implements the tree and begins assigning people and adjusting dates. Upon completion he saves this upgraded version as a new rendition on the same page.

Further features of a particular embodiment of the system according to the invention are described in Schedule A.

### Inspiration Interface

With reference to FIG. 22, the edge of one of the Task Galaxies and a 3 dimensional Cartesian plane divided into a few example knowledge and skill domains is shown. The same example domains are used to divide the X-Axis as well. Allowing a row and column for each domain, a grid divides the X-Y plane into grid blocks called “Gateways”. Each gateway is an intersection of the domains. It could be a “Pure Domain” such as when the same domain intersects (Math/Math) or an “Interdisciplinary Domain” in which two different academic fields intersect, or a “Transdisciplinary Domains” which include intersections with all remaining domains of skills, knowledge and talents outside academia (such as Mechanics in the example).

Each Gateway is attributed with certain keywords, vernacular, ways of thinking and other cultural items that are associated with the domains of the intersection. The more GSDs and Dimethyltryptamine (DMT) GSDs that a user completes in each gateway builds points in that Gateway to signify how familiar and skilled the User is in that Gateway.

The Inspiration Interface can be applied to a GSD Tree or a DMT Stream (a DMT Streams is similar to a GSD Tree except these tasks have a strong component of learning content) and an entire set of concepts can be learned from a certain Gateway.

Users can help build the cultural attributes for each gateway in a community contributed description so as to help others build the numerous micro-cultures that serve as the Gateways.

The inspiration interface also tracks other users with similar momentums in each gateway so that a user can connect and learn from other users if certain cultural items are not encoded into the system and a human tutor can takes its place. For example, if one is applying the Gateway “Mechanic/Math” to a concept in Math but there is a lack of entries to help translate certain concepts, then the User can scan the network for someone who has learned the concept before or who may have spent more time in the Mechanic/Math gateway and can ask that user for assistance.

### Use Case Example

User 1, Mark, signs up to GSD Synchronicity and creates a User profile and observes a blank PG (Personal Galaxy). Mark wants a more active life and wishes to find something meaningful to do on the side of his job. He just doesn't really know what he's really truly passionate about. He likes a great deal of things and puts those interests in his Hero Profile. He then clicks on the dream finder page to get started.

The DreamFinder scans his User profile with the Inspiration Interface and sees that Marks interests are uniquely transdisciplinary in two domains, Laminating/Volunteering. This Gateway has a low Global and Societal Momentum rating meaning that the Gateway is ripe with pioneering and minimal investment before reaching the zenith of the field (i.e. the cutting edge, the newest concepts and/or most complex problems). The GSD Synchronicity system then formulates a set of possible ideas and GSD trees for Mark.

Mark is presented with several options and notices a Laminating/Volunteering initiative. GSD Synchronicity notes Mark could start a Social Enterprise that provides high quality laminating to low income properties in his neighborhood and the city.

This excites Mark and feels right particularly since Mark's skill level and time investment in both areas provides substantial resources that were previously unemployed. Given the current census numbers Mark quickly calculates with GSD Synchronicities help that he could assist approximately 400 low income families

Mark then selects a Dream Goal of helping those 400 families by starting his Social Enterprise. He creates a new GSD tree in his PG under the Dreams life area but has no idea how to fill in the tree. His settings are open for this GSD tree and a Social Entrepreneur from the next town over sees his initiative and splits his “Start Social Enterprise” GSD into two subtasks “Contact Social Enterprise Fund” and “Create business plan from www.SEF.com”.

Mark accepts these changes in his Thistory. The next day Mark embarks on completing the first of the split GSDs and downloads the business plan. Upon downloading the plan asks him what kind of business model he wants. Unfortunately Mark has no business experience of this kind. His flow score is indicating Anxiety. A suggested DMT Stream for training is offered on this GSD and Mark clicks the option.

The DMT Stream option opens and the Inspiration Interface presents the most relevant, easiest, and other Gateways to begin the training to upgrade the Strength Variables so that Mark can complete the task in flow and not in anxiety and to complete the task at a higher quality.

The GSD Synchronicity system also calculates an approximate time that the DMT Stream will take to reach certain points of strength upgrades, and provides suggestions on new timelines for the GSD Tree by factoring in the DMT Stream additional time.

According to the DMT Stream time, in order for Mark to finish the business plan task to a high quality, the inflow will push back the GSD twelve hours if Mark chooses the easiest and most relevant Gateway of Linoleum/Business. Other Gateways have longer DMT Streams making the interval longer than twelve hours.

Alternatively, if Mark does not wish to do the twelve hours, the Synchronicity system opens up the network to see if anyone else or an organization in the dreamscape can provide the service faster, at a higher quality and for a price that is less than the cost of the twelve hour linoleum/business Unfortunately/fortunately for Mark, there is no one able to teach such a customized field since it is a relatively undeveloped Gateway and because similar services cost too much which outweighs his twelve hours and is why low income families cannot support the GSDs or tasks in the first place. So Mark opts for the twelve hour option making the relevant trade-offs in his other life areas.

Upon selecting the gateway, Mark is taken to the first concept which goes through the meta-relations and appropriate labels, lexicons and linguistic conventions which are applied to resonate with Marks current awareness level to find the start, i.e. the HMC SP (HyperRational Meta Conversation Starting Point) . . . HMCs are like dialogs around DMT Stream concepts. As the user explores and connects concepts, that organic connecting is the HMC that is wrapped around and threaded through a more structured set of concepts in the DMT Stream.

The Inspiration Interface connects Mark from concept to concept by identifying the thesis Mark carries and begins to guide Mark via Rational Behavioral Therapies and Cognitive Behavioral Therapies and Dialectic Therapy to the anti-thesis, then to No-Mans-Land and then ultimately to the hidden variable for synthesis. From the hidden variable the system constructs a new thesis and anti-thesis through Master Training, which is guided by responses from Mark through spaced learning techniques and evaluated through Blooms criterion and through dialectic scaffolding that measures the psychological distance between hidden variables and synthesis to prevent information overload, identity fracturing and other undesirable characteristics of non-flow. Flow State criterion is also utilized to build the DMT Streams.

After 12 hours of HyperLearning, Mark finishes the DMT Stream and the system is updated with the new skills, knowledge and possible business talents.

Mark then performs the necessary Task Types on his Dream Tree, splitting it, linking it, and pushing it into creation via enhanced planning from the DMT Stream. Part of the action orientated exercisers of the DMT Tree may have already had Mark build parts of the Dream tree.

With a more detailed Tree (plan), Mark begins completing the tasks including building the business plan with his new strength and potential.

While Mark was on the DMT Stream he uncovered other Gateways and Dream Projects in helping to push forward the Social Enterprise Revolution with the Linoleum Social Enterprise, as well as Sustainability practices by investigating more recyclable material with which to make the linoleum. Galaxies with similar missions and potentiality begin migrating closer to Mark since his privacy settings are open and allow this. Through other Galaxies Mark begins to meet more people with the Strength and vision to release the potential of the Linoleum Social Enterprise and to support him so that he can quit his old job to give more energy and time to the GSD tree while keeping all life areas strong.

Mark builds the Linoleum Social Enterprise and helps 400 low income families build more empowering environments for them and their children that are sustainable. Mark Checks this Dream Tree off as Complete with the Strength he learned during the process mapped in his User profile and Renditions. Appropriate Momentum in each Gateway is updated.

This process of inspired action repeats as the Inspiration Interface finds deeper connections for Mark's potential as he grows, creating more complex GSD Trees, deeper personal and organizational relationships, navigating longer DMT Streams and striving for his dreams as they ebb and flow in potential and through different interlaced gateways of perception. Flow State System and HyperMoments.

Flow States are states of consciousness wherein a user is fully immersed in a task, and time is forgotten along with the Self as the activity is intrinsically enjoyable. These are powerful states that human beings long for as their full potential is being released. The Goal of the Flow State System inside the GSD Synchronicity System is to aid the user in finding and building Flow States for their lives and Group Flow States, HyperMoments, with those around them. There are 4 major requirements that need to be satisfied that the GSD System and in particular the Flow State System and HyperMoments try to meet:

1. Clear and Concise Goals

2. Clear Rules

3. Perceived challenge levels and perceived skill levels in a task are balanced

4. The activity must be intrinsically enjoyable

5. Immediate feedback

The GSD Synchronicity system meets each one in the following way:

Clear and concise Goals: The nature of the GSD Trees requires users to clearly define goals and link them together in a clearly visible and intuitive way via the Galaxy and rings. All GSDs must have concise descriptions, due dates and other variables clearly defining the GSD and where it is going.

Clear Rules: The Ticker System, Point System, Money Transactions, Task Types along with the Thistory and Rhistory transaction pages list out the numerous rules by which the system operates. All users are subject to the same rules to generate a fair game atmosphere. All users will be acquainted with those rules through orientation and training of the system and general use.

The activity must be intrinsically enjoyable: The DreamFinder and Inspiration Interface works to find “roots” or inspiring starting points for users to get into activities and GSD Trees that are already meaningful to them and their Egoic Preferences (See Dream Variables as referenced below in this document).

Immediate feedback: The analysis systems including the Gdata (Group data for Org Galaxies) and Pdata (Personal data analysis for Personal Galaxies) are built to provide immediate feedback on the user's performance. Through the Rhistory, Thistory tabs in particular the users actions are tracked and update their User profile in real time. Pie charts on how they spend their time, how much they perform task types, nodes switching colors in GSD Trees as they are completed along with all other Users linked to the task are updated all in real time provides the feedback to the user to see how they are performing personally especially in their life graphs as well as to their friends and global performance averages of the membership. The Awards systems can also be used to mark achievements but not to the point that it overshadows intrinsic enjoyment.

Perceived challenge levels and perceived skill levels in a task are balanced: The FSSH system in particular focuses on this requirement. It tracks and matches GSD Demand Variables with User Strength variables and creates a “Flow Score” particularly by utilizing the Strength variables. It then plots the results on a Flow Frame or Flow Graph that is personalized to each User. The FSSH is explained below.

The Flow State System and HyperMoments (FSSH) generate two Flow Scores for a User. The first is a Life Flow Score and a GSD Flow Score.

GSD Flow Score: This Flow Score is generated relative only to the Variables and sub-GSDs of the GSD a User is interacting with. It does not take into account other unrelated GSDs in the Personal Galaxy, other Org Galaxies (unless they are linked), or Life Areas. This Score literally represents how the user would feel if they took on the task as if this was the only GSD they had on their plate basically assuming the user has time to take on such a task given their other Life Areas.

Life Flow Score: This Flow Score is generated by taking into account all GSDs that a User owns in their Personal Galaxy, Org Galaxies, and Life Areas. When a user is looking for new tasks to add to their Life Stream they will see the GSD Flow Score for each GSD (represented also by color of the nodes in the GSD) but as the user selects or builds (but does not confirm) a new GSD, the Life Flow Score will generate a Hypothetical score by combining the overall challenge across all GSDs the User currently is responsible for completing on the timeline show in their Galaxies, as well as all the skills and strength needed from the user. Essentially, the Life Flow Score is giving a Score for one ultimate GSD: Living and Releasing the Potential Beauty of the Moment through the Human Life that is the user with deadline of upper bound 110 years. The Life Flow Score essentially treats your entire life as a series of connected GSDs, or mini-Flow States, that interconnect into a larger contiguous Flow State across one's life. It would be wise for a User to take the Life Flow Score into consideration before confirming ownership of a GSD.

The FSSH generates Flow Scores through a process of matching between the User Hero Variables and the GSD Demand Variables and meeting the three major requirements for flow. Both the GSDs and the Users share the same variables in order to match them. There are essentially three main variable categories each with their own sub-variables: Dream Variables, Strength Variables, and Complexity Variables. Flow Scores are generated through, but not limited to, the equation:

Flow Score=a(DreamVars)+b(StrengthVars)+c(Complexity Vars)

wherein

Flow Score=(High Curiosity+Persistence+Low Self-Centerdness+Internal Locus of Control+Need to Achieve)+(Myers Briggs+OCEAN+Love Languages+Tony 6+Life Areas)+((Skills(((*Task/User)×100)/n)+Knowledge(((*Task/User)×100)/n)+Talents(((*Task/User)×100)/n)+Total Strength((TaskZenith/TaskStrength×100)+(UserTotalStrength/UserStrengthUtilized×100)))+(Tier+Performance Pressure+Channel Bonus)+Expectation (Positive Affect,Life Stage)

Each category can be defined to contribute a certain weight to the equation to help govern their contribution to the overall score. These weights can be configured after user data reveals the best configuration. Of studies thus far the Dream Variables will be set to 50% contribution, Strength Vars will be set to contribute 35% and Complexity Vars will contribute 15%. Dream Variables (a(DreamVars)=50%)

Dream Variables include variables that measure what the GSD Synchronicity system calls Egoic Alignments. With each User comes an Observer and an Ego. The Ego can only see the world through a certain lens and thereby distorts reality and develops preferences that align with its needs. That lens is defined by several other sub-variables that define the ego, its interests and needs, what motivates it and other personality traits that have been correlated with higher levels of Flow States in individuals. Some of these personality traits are called Autotelic Personality traits and those who have them are significantly more likely to generate flow states through their perception abilities. The Variables are explained below:

### Autotelic Personality Traits and Transcendental Thinking

High Curiosity: Curiosity can be tested for through the Virtue Test. It is a simple match variable. If the Users User profile has it, the system will give every match score on every GSD an additional score of 10.

High Persistence: Curiosity can be tested for through the Virtue Test. It is a simple match variable. If the Users User profile has it, the system will give every match score on every GSD an additional score of 10

Low Self-Centeredness: Curiosity can be tested for through the Virtue Test. It is a simple match variable. If the Users User profile has it, the system will give every match score on every GSD an additional score of 10

Internal Locus of Control: It is a simple match variable. If the Users User profile has it, the system will give every match score on every GSD an additional score of 10. If users say they are “half internal and half external” even better.

Need to Achieve: This is a simple match variable. If the Users User profile has it, the system will give every match score on every GSD an additional score of 10 Egoic Variables

Myers-Briggs: Each letter of the Myers Briggs will match up to give a percentage match. If percentages match the user will get a higher chance of scoring 100%.

OCEAN: This personality test has 5 variables that can be called for in the task and can be matched up with the Uses Hero Profile. This variable allots 20 points per matching item.

Love Languages: This is also a match variable. Up to 3 of the 5 love languages can be assigned to the task. If the order of the three align with the User profile the user receives 20 points per match and an extra 10 for the ordering.

Tony 6: These are the 6 human needs as outlined by Tony Robbins. They are Uncertainty, certainty, significance, Love/Connection, Growth and Contribution. Each variable will have 5 levels. If 3 of these variables match the top 3 needs as defined in a Hero Profile, then 20 points is allotted to each match for a maximum of 60 points.

Life Areas and Keywords: Tasks can be organized in terms of life areas. Each task will be assigned a primary life area in which the task addresses, and then other synergistic effects on other life areas. The Creator of the GSD can assign certain interests and keywords to the task in each life area. For instance, if the task involves helping the elderly it could be in the spiritual life area. For each interest listed in the GSD that matches with the interests listed in the User profile an additional 10 points will be added. A Maximum value of up to 10 interest matches is allowed for a maximum of 100 points, i.e. if a user specifies a certain musical artist as an interest for Spiritual life area, then a task with that artist will receive more points. The life areas are listed below:

Physical: Any interests or keywords related to physical conditioning: diet, food, exercise. Physical health issues fit here as well.
Mental: Meditation, brain exercises, sleep and other things good for mental health fit here.
Academic: All interests having to do with formal learning, accredited learning, certificates, diplomas, federal education or DMT Streams
Spiritual: Interests having to do with exploring the Unknown, Creativity, answering life's bigger questions such as why are we here, who are we, identity, personal philosophy on life, morals values.
Family: Anything to do with your family network, their GSDs, values, interests and goals and how you can participate in them synchronously.
Friends: Anything to do with friends in your network, their GSDs, values, interests goals and dreams
Intimate: Anything to do with finding a mate(s)
Political: Social media, rallying, increase ones voice, status or power amongst groups of people, and society. News stories, podcasts, current events.
Financial: Interests having to do with monetary means, accounting, book keeping, budgeting or any items that may cost money, including Bills, payments, reminders, shopping.
Hygiene/Basic Needs/Time Management: Cleanliness, chores, laundry and general aesthetic fashion and image attributes. Anything to do with traveling also fits here
Dreams: Dreams are projects that generally tend to be longer term and have to do with contributing to a purpose greater than one's self. Maximizing profit and other such selfish narcissistic motives should be discouraged as projects. Social entrepreneurship and social enterprises should be encouraged as future organizational structures. All For Profit entities pay a significant premium.
   Strength Variables (b(StrengthVars)=35%)

Synthesis Variables: These variables target certain logical skills involving Argumentation, Scientific Method, Truth Finding, and Dialectic Synthesizing.

Dialectic Synthesizing: This variable measures how many dialectics one has discovered.

Immersion Vars: There are two Immersion Variables, one for the GSD and one for the User.

GSD Immersion: All GSDs should be linked to a Dream Tree or a Zenith Tree to the cutting edge of an initiative (dream) or Gateway (Zenith Research). The level of difficulty in comparison with the Zenith percentage wise will result in a percentage. That percentage is converted into points. Max: 100 for example
User Immersion: The GSD a User will engage in will require skills from the user but rarely if ever will a GSD require all the skills of a user. The GSD may elicit a certain percentage of the skills and their complexities of the user total Strength and this percentage is used as points in the equation. A more immersive experience that utilizes more aspects of a User will result in stronger flow states. Max: 100

Skill: Each skill a User obtains has a Complexity level attached. Many scales could be used by the GSD Synchronicity system but in this case a Skill will have a Beginner (10), intermediate (20) and Advanced (30) level to start. Only the skills demanded from the GSD will be factored into the flow score. Depending on which is greater, the demand skill and the user skill will be divided into one another with the greater one always the denominator (otherwise the ratio will be above 1 throwing the percentages off). The ratio is multiplied by 100 and the percentage is added to the score. Note: skills that the GSD demands but that the user has no skill in still factor into the overall percentage which will dramatically lower it. Notice that Skills that the User has but the GSD does not demand do not play into the Flow Score of this task. To rid the possible inflation caused by numerous demanded skills, the score is normalized by dividing the addition of all the skill percentages by the number of skills. This should give a single average percentage which will then factor in as points. Skills are also attached to Gateways as momentum. The maximum number of points is 100.

Knowledge: The same scores are calculated for knowledge as for Skills. They are normalized in the same way as well for a maximum of 100.

Talent: Talent is slightly different from Skill and Knowledge in that often the user cannot change or choose the talent such as the amount of natural fluid intelligence via IQ tests, or physical size for football, or fast twitch muscle for running. In terms of temperaments and attitude, the Strength Finder test will map out percentages that can be used to match and generate a score max of 100. Physical measurements and IQ can also be factored in to match up with GSD demands (such as a football task requiring certain physical build)

Fluid Intelligence and IQ: It is well known that IQ is more of a talent than a skill. It is very hard if not impossible to increase ones IQ. Categories of intelligence generally move in 10s, so those Users that have within 10 IQ points of the GSD demand IQ will receive additional flow points (100 max with 10 points less for each IQ point less

Physicality: Size and physical measurements are also more of a Talent than a skill. They are very hard to change until genetics advances. This can include weight, limb measurements, center of gravity, fast twitch muscle fiber, height or other measurements.

Recency: This is based on one of the Laws of Learning. With every Skill and knowledge domain learned or Talent adapted or worked upon, is a dampening effect. For every day that goes by without repracticing the Strength of the Skill or Knowledge Domain, the Complexity goes down until it is effectively halved which represents having the knowledge readily releamable but not immediately applicable. Relearning may induce flow but time should be factored in. This Recency is hypothetical and generates two ratings. One as if no forgetting has taken place and a second flow score with the hypothetical Recency reductions on applicable GSD demands. The Law of Recency will help regulate suggestions on what DMT Stream or GSDs a user should re-visit minimally to maintain a certain Recency rating that determines what level of skill you are at. Using the 5 level system, the GSD Synchronicity system times when to retest a user to validate their skill level on those 5 levels. Those GSD renditions or DMT Tree concepts in category 5 are virtually guaranteed and the Flow Matching system can rely on them long term.

Complexity Variables (c(ComplexityVars)=15%)

Experience Tier:

GSD Tier: This indicates the number of sub-GSDs connected to the head GSD. The more vertical and horizontal sub-GSDs the greater the tier level. Different Tier Schemes can be used. The default is that each additional GSD forms a new Tier which essentially serves as a counter of the number of GSDs.
Tier Experience: every time a user completes a GSD the system logs it and tracks what tier level the GSD was at. The GSD System tracks how many GSDs were completed at each tier level. The more GSDs at each level performed the more points are added to the Flow score. So if it is a 15 tier GSD and the user has performed a 15 tier GSD 10 times in the past then they receive Maximum 100 points to the flow score. Note: in a GSD Tree, the highest node the User owns is taken as the Tier, not all the sub-trees within it (i.e. A Tier 15 might have 3 Tier 3's that comprise it but do not get all 3 of the 5 Tier, just the 15 Tier). In the future the Tiers can indicate groupings and allotment of points can go up with however many repetitions is set as maximum.

### Performance Var:

GSD Density: Often a GSD tree will take as much time as is allotted to it. Shorter time frames often increase the challenge level of a task particularly if more tasks are crammed into the space of that time. GSD Density has to do with how much time per unit GSD a GSD and its GSD tree has. It is calculated by dividing the time in hours from the start of the GSD (and its tree) to its end deadline, by the number of GSDs. If a Tier 15 GSD takes 7 days then the GSD Density=(7×24)/15=11.2 hr. This is using Objective time. Waking time only includes 18 hours per day working time with 6 hours of sleep. This limit of 18 hours and minimum 6 hours sleep can be changed to suit labor laws or different cultural values. In terms of the example above, Wake GSD Density=(7×18)/15=8.4 hr.
GSD Horizons: Each GSD can have an estimated time for completion. A GSD tree may have 15 GSDs due in 7 days but each one could take only 0.5 hr. for a total of 7.5 hr. out of the total Objective time 168 hr. Percentage wise that is only a horizon of 4.5%. For Waking Horizon it is 5.6%. At some point called the Event Horizon A single user will not have enough time to complete a GSD of a high enough Tier without support because the Horizon is at or greater than 100%. This is too great for a single person. Theoretically this Event Horizon is met when all the estimated times for each GSD in a Tree exceed the allotted waking time of 18 hours per day for more than 3 consecutive days. A single user should be advised not to take on this task until they can find users in their network who can aid them.

Note with GSD Density Per Person, as a User assigns others to sub-GSD branches in the GSD tree, the Per Person Density should be reduced by the corresponding amount for each person. Initially the GSD Density was entirely applied to the owner of the Tree, but as tasks are delivered the pressure on the Tree owner decreases. This does not factor into the overall complexity of the task, but is useful when the user begins to implement the GSD.

Planning Fallacy Elimination: The GSD System takes into account the current User Horizon levels across all their life areas and Personal Galaxy. When a user seeks to take on another GSD, the GSD Synchronicity system, perhaps by an Artificially Intelligent Avatar, notifies the user of risks and possible approaches to the Event Horizon of their personal potential which warns against the planning fallacy and prevents overbooking without proper attention to dependencies on other resources.

Laws of Learning and Weights: There are eight Principles of learning that the FSSH tries to satisfy. Satisfying these principles has shown higher and more enjoyable states of learning and action.

Law of Readiness: The Dream Variables and DreamFinder System and the Linking Task Type try to provide the “why” motivation as to why a user should learn or perform a GSD by linking the GSDs to solving a meaningful global problem, to a greater goal and to the Users Dream Variables. Satisfying this “why” motivation is the first Principle of Learning called “Law of Readiness”. The Inspiration Interface

Law of Freedom: Because the Dream Variables are defined by the User and because the DreamFinder Program is self-directed, it satisfies the Law of Freedom. The Inspiration Interface can provide suggestions and HyperRational Meta Conversation Starting Points (HMC SP or “roots) but the user ultimately picks where they feel most inspired to start.

Law of Effect: The gamification and immediate feedback mechanisms such as GSD nodes marked as complete, updating of statistics, personal bests in action types, changing colors, automatic awards that flash on the screen upon a GSD action type, a new leveling or cap achieved along with novel comparisons showing the Users progress to others including DMT streams and performances of other notable people in history. An Al fairy may also give consistent feedback as a user progresses through GSD and DMT trees.

Law of Exercise: The recency variable along with reviewing GSD streams and GSD streams aid in predicting the strength of remembrance. Adoption of Leitner Model metrics to retrace GSD or DMT streams in novel combinations with other points in the Inspiration Interface at different dimensionalities will also help reinforce. Hyperlearning may also be improved by measuring neurochemicals needed per GSD node and consequently GSD Trees, DMT trees at different dimensionalities.

Law of Primacy: First exposure is intensified via the spatial reasoning that the intuitive layout of GSD trees and DMT trees lays. The building of trees with cultures familiar and custom defined to suit the leamin needs of the user enhance accuracy and fidelity of first exposure. Teaching using a net ensures the student not only understands the concept in isolation but in a greater perspective and context given the concept of dimensionality and hyperconnectivity of all nodes in the dialectic image. Transcendental thinking allows the student a firm logic to base learning patterns on.

Law of Intensity: Immense amounts of information are conveyed using the spatial context of nodes to provide perspective. Links to videos and other users on highly structured but also very flexible GSDs along with linking to purpose based learning heightens the realness of potentcy of information particularly in connection with all gateways and domains of knowledge and skill towards

Law of Requirement: also part of purpose driven learning. Dream Trees, Zenith Trees and head nodes can embody the “root” and the step by step learning that results that guides learning with the GSD Synchronicity system being inherently goal based. GSD trees can specifically embody the root or objects of attainment that guide DMT trees.

FIG. 22: Button and Axis 1101 show the alignment of knowledge domains within the Inspiration Interface, trades, skills ordered along the X and Y axis so as to create intersections and Button 1101 shows traditional language translation such as between the world languages like German English. All knowledge domains can be listed in a transdisciplinary way with new domains being added upon discovery. Section 1102 points to a shaded portion called a “field” which describes a chunking of similar or closely related domains around specific phenomena, methods or other variables of organization. Section 1103 is an intersection of the domains listed on the axis and can be called a “Gateway” with its own properties and cultures which the user can interact with and click on. Section 1104 is a unique Gateway created by the intersection of the same domain with itself creating a “specialized gateway” of a more traditional or “pure” discipline of knowledge, skill or culture that does not incorporate as many or any elements of interdisciplinarity or transdisciplinary as other gateways. Section 1106 can also serve like a button and is a close up view of one of the Gateways displaying additional characteristics of the culture of the Gateway such as “ZH” which stands for Zenith Horizon otherwise known as the measure of the sum total of the domains maturity and development from start to the cutting edge (Zenith Horizon) and “ZR” (Zenith Relative) being the Users measure of the sum total of the maturity and development of the User in that Gateway either in relativity to the absolute Zenith Horizon or as a measure on its own, “D” being the dimensionality or the measure of complexity factoring in the number of intersecting domains and the “E” representing the traditional language or dialect which can be clicked on and changed for that Culture resulting in a menu showing the users maturity in the current gateway vs the maturity and development of the same gateway in the new language. For instance, if the user selected “French” but the user had no history of development in French then a DMT stream or GSD Stream could be plotted with an estimated time and desired level of understanding.

FIG. 23 depicts a higher complexity and dimensionality of a Gateway in 3 dimensions showing the intersection of more domains and higher dimensionality domains along the axis.

In FIG. 24 users can branch DMT Streams or streams with a stronger component of learning and training that the user may wish to keep separate from the main GSD Tree in 3D space from a Galaxy. Section 1107 depicts a GSD Tree with the Inspiration Interface and its translating abilities applied to GSD task nodes in rings. Area 1108 shows a DMT stream (non inspiration interface but consistency based) branching off in 3D space from a GSD Tree but may also be incorporated in 2D with the GSD Tree if desired. Section 1109 shows a DMT node in the inspiration interface.

FIG. 25 depicts a rear view behind a Task Action Menu which can be centered around a task node in a Galaxy or planning session with button 1110 showing the task node either GSD or DMT and Button 1111 showing a node before being projected through the inspiration interface. Area 1112 shows the projected Gateways in which the node is translated into the cultural parameters of the domains as they intersect and may help inform multicultural and cultural competence.

FIG. 14 depicts options for creating DMT Streams and GSD trees by clicking the GSD in the center of menu FIG. 14-513: Menu FIG. 27-1114 showing when typing in a description a menu showing rendition options using similar keywords pops down. FIG. 27: Hovering over each option in menu 1114 results in another pop up menu 1115 showing how many times the rendition has been implemented starting with the implementation dates (first created), and name, code and contact of creator. FIG. 27-1116: task variables assigned to the head node. FIG. 27-1117: Number of types of renditions organized by complexity and difficulty with easiest challenge level on the left and consecutively more challenging moving towards the right. Complexity code is listed along with first rendition create date. Numbers in brackets may also show how many times each rendition has been implemented. FIG. 27-1118: the date ring organized not by specific dates but by differences in time between nodes. These can be changed to custom fit the timeline of the user. FIG. 27-1119: Hovering over nodes pops up a comments window showing all comments, attachments and materials around said task node. Area FIG. 26-1120 shows options for creating a new rendition or building off of ones shown as templates. This includes an input for the name and search of the rendition or template life areas to be assigned or affected, global luminary data to be synchronized, merged, or incorporated and various flow metrics in area FIG. 26-1121 to help measure the likelihood of the design on the users experience of the rendition. Also appended to Area 1120 is a menu for designing DMT trees in combination with GSD trees starting with specific historical figures or people in the network and their resulting stream, estimated time until arrival at the end of said Stream, the complexity, challenge and dimensionality along with the amount of energy nodes or other relations of people you may like to include as some examples variables affecting the stream design.

FIG. 27 depicts a close up of the Rendition display as shown in FIG. 26.

Users can also use the inspiration interface to aid in designing GSD and DMT streams and trees as shown in FIG. 28. Area and line 1131 depicts the first trajectory of the Relational DMT stream (also known as the Dialectical Image relation) branching from the menu centered around node 1130 which serves as the starting point for the DMT Stream. Area 1132 shows a user may view and interact upon the DMT node through an entry Gateway and leave from a different gateway immediately without a connecting stream showing the user has a previous knowledge of the leaving gateway not needed to be traversed again but serves as the new starting point to interacting with the next DMT node through another gateway either the same or different. No change in gateway is necessary upon entry and exit of a DMT node. Area 1133 show inter interface travel along the same DMT node showing different cultures of learning around the same general concept, phenomena or idea in which the node represents. Area and lines 1134 depict the two different DMT Streams the same user can take from the same start point to the same finish point. Area 1135 depicts the end node as translated through the cultures represented by a higher dimensionality inspiration interface. Lines 1136 show the two dialectical relational streams (also known as the Unspeakable). Line 1137 depicts a DMT stream another user or historical figure took as compiled from events in history for comparison of users style. Line 1138 depicts the second trajectory that can be used among a plethora of possible paths, streams and trajectories from the rendition system, users and history.

FIG. 29 and FIG. 29A shows a user viewing, interacting and designing a DMT Stream or GSD tree with multiple users with menu 1139 showing the number of users and their streams in comparison to one another (here 10 is not accurately representative of the amount of users in the drawing as 2 users). Line 1140 depicts the Dialectic Relational path of the first user and Line 1141 depicting the Dialectic Relational path of the other user User 2. Button 1142 depicts the dimensionality of the inspiration interface which can be changed in designing paths or used to view historical paths. Area 1143 depicts a point where two users DMT Streams merge on the same gateway which is then called a Synchronicity Point as both Users view and interact with the same Dialectical Relational Node from the same culture. Menu 1144 depicts additional options to interact with or design the DMT streams and their Dialectical Relational counterparts showing the network of people to the left organized by life area in this example but any organization helpful to the user may do. These is/are the people being designed for with a Dialectical Relational Stream and DMT Stream being mapped for each one. Users can use Risk analysis corresponding to calculations between the user and nature of the other parts of the stream in terms of potential losses or sacrifice of other choices, # C represents the degree of change to the identity of the user as they traverse the streams, Time depicts how long it may take or has taken selected users to reach the Destination Goal from a selected Starting Point. Clicking on each one allows users to calibrate and design. Note: users may take different times to travel similar streams due to identity and profile differences. Area 1145 makes special mention of being able to select Historical Figures that may no longer be living to learn from their streams or make hypothetical paths based on artificial intelligence calculations of models of that individual identity. Area 1146 depicts an editable menu of options pertaining to if the User clicked the “# C” option for a user in the left hand list of 1144. At the top it mentions a calculation of the HyperMoment Depth as the rate of phenomenological information processing required given the design constraints of the Stream across all life areas affecting the identity.

FIG. 30 shows a different spherical embodiment of the Inspiration interface projected along the surface of a sphere with a Dialectic Relational Node at the center.

FIG. 31 depicts a three dimensional area called Weltgeist/Geist. The space may represent different configurations of task and user variables as they Traverse DMT, GSD Trees with one notable example being one of showing the history and current and future trajectories of human travel through the Dialectic Relational Nodes which constitute all possible make up of streams and collections of streams called worlds. Weltgeist refers to spaces that include many or all users and may refer to the collective overlay of awareness of humanity over phenomena in all configurations. Area 1148 depicts an embodiment of a World of streams along the Dialectic Image (dialectic image represents the set of all permutations and combinations of relations between subjects, objects and any combination of the two or with themselves) corresponding to the Objective Stream as the most common set of phenomena and relations of the objective universe through human experience. The top may have a topology of GSD Trees in a Species galaxy or org galaxy depicting its movement through space. Area 1147 depicts a potential Virtual (or unknown) World of streams which may represent a combination of relations not seen in the objective world but in the pure subjective virtual, computational and fantasy worlds of human or machine consciousness as it traverses DMT streams learning and absorbing said relations one chunk at a time (Tasks). Line 1149 depicts a Dialectical Relational stream between nodes in objective and virtual worlds. The distance between nodes can be measured by frequency of travel, psychological depth and distance of travel, probability, scientific method and other variables. These distances may change as awareness levels and capabilities of humanity increases pulling previous virtual hypothetical phenomena into an objective proximity. Area 1150 depicts a break in a line showing that Dialetical Relational nodes and DMT Streams may not be complete or connected to other nodes and phenomena or forms of perception as mediated and coordinated by the inspiration interface. Area 1151 shows that some streams may be fainter than others depicting time, dimensionality and connectivity, and strength of traffic travelling or to have once travelled the stream. Geist may serve to show the history of an individuals travelling or of all Weltgeist. Welgeist/Geist may also be an extension of the Dreamscape under different variable combinations.

FIG. 32 shows how nodes can be configured structurally via a dialectical variable as a task property representing the hegelian inspired Ascent to Synthesis as shown in Figure about Transcendental Thinking. Ring 1152 shows the synthesis' of individual dialectics along the same ring depicting close relation or an identity that can be studied via GSD tasks or DMT tasks. Identities and their corresponding studyand manipulation can be connected to other dialectics and dialectical identities via the DI, D2, D4 dialectical points as synthesis connecting points that mediate the manifestation of the dialectics in any context and specifically any goal directed context. Structure 1153 shows a dialectic structure branching away from one identity ring to another connecting the two. Dialectical Relational nodes and streams may follow or be mediated by this pattern. Node 1154 depicts a synthesis node D4 resulting from two opposites in the same Identity ring which connects it to another identity ring in close dialectical proximity which may help in calculating dimensionality of understanding of a phenomena by a User in the Inspiration interface. Area 1155 depicts another identity ring being connected by one of the other DI or D2 nodes. Organizing relations in this way helps show the interconnectedness, rates and patterns of change mediated by such interconnection and provide insight into Dialectical Relational Nodes and their DMT Stream configurations. Some dialectical points such as DI, D2 or D4 may not exist in the objective stream but may be undiscovered as hidden variables or exist in virtual, uncommon or currently unknown realities/streams in Geist and Weltgeist maps such such as an anti-apple (where all or most dialectical properties are inverted including charge of electrons etc). Area 1156 depicts an oval encapsulating D1-D2 lines. This oval can represent a human identity with profile variables being listed in dialectical form of opposites and paradoxes and contradictions. The system uses these dialectics to connect the identity with the dialectics attached to task nodes to help inform flow scores and relations to gateways etc and all other permutations and combinations of relations in Weltgeist. In the identity area 1157 depicts the list of ordered dialects most closely related in the identity with the sticking points marked back black filled nodes. Sticking points are the part of the dialect that the identity embodies with the other node node not consciously incorporated into the awareness, knowledge, skills or talents of the identity (as well as identity of Users). The dialectics only have 2 nodes as opposed to the dialectical 3 showing that the identity has not consciously reconciled intentionally or with full awareness both sides of the dialectic through the mediation of the synthesis (mediation means determining which side to be in any given context consciously). Triangle 1158 represents a fully resolved dialectic that the identity in their User profile has consciously resolved via wisdom and riding the synthesis (Riding the synthesis means being able to move and mediate through dialectical structures intentionally through mediation and goals). Users may turn unreconciled dialectics into resolved dialectics through DMT Streams, Transcendental Thinking and general consciousness raising.

FIG. 33 depicts another embodiment of a user traversing a GSD Zenith tree in 3 D with their personal or organizational galaxy warping upwards with the GSD Zenith (or any tree) tree depicted by 1159 passing through the center. The warping by pulling the center of the galaxy to a node in the future can have the effect of showing the future by the traditional moving inward of rings of a galaxy and also moving forward in 3D space simultaneously. This can have the effect of showing time and the direction.

In another embodiment of the invention, the galaxy and universe can be portrayed in a “3d” sphere and space (respectively), which reduces clutter if too many GSDs are in a ring. As the 2D galaxies or rings are cross-sectional views of a sphere showing the dependencies of tasks in time, the surface of each sphere represents a moment in time, a day or other period corresponding to the zoom level. The surface would display all the GSDs for that moment with the surface organizing the GSDs by a host of variables that the user may define, such as forming clusters of GSDs with similar variables. The dependencies in time can extend in and out of the screen as the user navigates across the surface. There could also be GSD trees displayed on the surfaces. Similarly, the Task Universe can also be viewed three dimensionally, with Galaxy Spheres moving away or migrating towards, or merging or interacting in dynamic ways across three axis with various variables defining the space and axis according to user information and management desires. FIG. 34—1161: The inner sphere surface representing a moment of time in the future. FIG. 34—1162: The outer sphere surface representing a moment of time closer to the present or past. FIG. 34—1163: The task nodes on the surface of the outer sphere surface connecting to task nodes on the inner sphere. This process repeats infinitely inwards and outwards for as many nodes as there are to display or the user wishes to see in the past, present or future.

FIG. 35 shows an embodiment of a 3 spatial dimension task galaxy as a sphere with its outer sphere later (ring in 2D form) having an image of earth mapped along it and represents the Global Org Galaxy represented as the sum total of all human tasks and actions along its surfaces. It can serve as a visual representation and coordination of the genome of human activity and coordination with future tasks represented by inner layers, fade in's or markers. Switch 1300 depicts switching between Global Luminary (coordinating or interacting with the global galaxy) and its relevant data and the individual Self as a unique user with a personal galaxy. A unique state of blend exists between coordinating one self through the luminary lense as an individual consciously aware of the organic whole. Area 1301 may depict the Self statistics and data relevant and customized to the users dialectical preferences and goals. Here the limits of creation of task action types and pending tasks is shown for the individual Self along with number of flow states, points or dollars (may or not be present in some embodiments and economies) and other roles and domains in other galaxies. Area 1302 shows the pending limits and creation limits with task action types using global data showing free self directed (of 45%) and the others as domains coordinated with the goals of the luminary. Box 1303 depicts a clickable and moveable box representing interests of the user, Gateways of interest or other variables. Users can add several boxes and may coordinate them with the Action feed. Interacting with these boxes can change the information displayed on the galaxy. Area 1304 depicts a task node on the surface corresponding to the geographical location of the creation, completion or other variables of the task node at the moment in time represented by the surface layer. Other mappings can be used to organize different categories or organizations of tasks. Notification bubbles 1305 show new information in related area of interest, gateway, or variable. Multiple notifications can be assigned and coordinated with the Thistory, Rhistory transactions for personal economy, organization economy or luminary or actions including Task Action Types in some other domain and/or Gateway.

FIG. 36 shows a simpler embodiment displaying the galaxy as rings (empty) with boxes and may represent the Personal Galaxy of the Self or the Luminary.

As the user interacts and creates GSD Trees and DMT streams along the dialectic image and geist/Weltgeist their choices may be informed by dialectics mediated and coordinated by the Inspiration Interface. This abundance of information can be viewed using the 3D spatial galaxies (concentric spheres) where roots (or starting points) of streams of knowledge chunked into historical tasks in each gateway can trace their Geological origins on the surface of the 3D galaxy as depicted in area with node 1306. As time moves from the past to the present a user can see nodes migrate across the surface in coordination with their future tasks moving into the center of the 3D sphere galaxy or if the order is reversed (each ring surface moving into the future outward as depicted by the black lines representing surface edge cuttings in 1307) then the user can choose to make certain layers transparent seeing the entering GSD and DMT stream geographically and temporally as it works up to, informs and connects to the cutting edge Zenith studies at he top of the gateway shown as S1 and S2 in 1308. These studies work to uncover dialectics hidden identites that can later be traversed as a Dialectic Relational stream and consequently DMT Streams mediated by the Inspiration Interface in interaction with a users identity and profile. These studies go to inform decisions in other GSD trees or Streams as shown by the line 1309 connecting the zenith studies at the top of Dialectical Relational streams and their DMT Stream counterparts. All elements and relations in the system can be traced back via this interplay between identities, Dialectic Relational nodes and streams, DMT Streams GSD trees to find roots and reasons behind all things to the extent of collective human awareness and individual awareness in interaction with the unknown parts/relations of the dialectic image. This gives rise to infinite connectedness and ability to learn about all connections and potentially influence and manipulate them using tasks called Transcendental Fractal Transparency. Developing GSD Trees for the Luminary is informed by the connection to the zenith horizons and transcendental elections (experiments) on how to mediate resources to improve opportunities for flow, meaningful lives, and hypermoments for all identities and are manifested as global tasks (goals). Using Zoom levels and dynamic information display allows Users to handle such vast amounts of information and goals to the level of detail that is meaningful to them in an intuitive way that incorporates the vast information spatial processing powers of the human mind. Individual Self Users can then interact with the Luminary tasks and galaxy using all tools including task action types based on this information. The degree to which one can connect DMT Streams, GSD Trees is limited only by human ability and understanding to investigate and transparency and openness of Users.

FIG. 38 and FIG. 38A shows the interconnections of the system with 1401 showing the dialectical methodology users may use to interact with GSD and DMT streams called Transcendental Thinking. Using this methodology allows Transcendental Fractal Transparency between all elements of the system and all gateways in the Inspiration Interface at faster and more optimal rates of flow and flow states. Boxes like that shown in 1402 are built upon this same methodology in that it is the same process of building DMT streams and resolving dialectics and their interconnections around differing Dialectical Relational nodes and identity rings that defines the culture of the gateways and domains. Box 1403 shows how all events and GSDs through all gateways and Galaxies can be examined using Transcendental Fractal Transparency by tracing their connections until a synchronicity point in awareness is reached by which time understanding and higher degrees of certainty can be reached about the objectivity and state of a something. Studies are task nodes and can be broken down into GSD Trees and Nodes. Section 1404 outlines how the Zenith Horizon topology of a Master Inspiration Interface can inform the goals of an individual in their Galaxy shown by lines connecting to GSDs in the top Left corner, and also to form other goals which spawn org galaxies as the task is broken into smaller GSDs through Task Actions and alotted to users for completion as industries producing goods. The roots of the policy decisions or any decision tasks can be traced through the Inspiration interface to their roots via the DMT streams as Transcendental Education (T-Education).

FIG. 39 Circle 1405 shows an Identity of User 1 with dialectics listed and Circle 1406 shows User 2 each with their own Task galaxies connected to the resulting DMT stream that is motivated by the lack of knowledge around the second listed dialectic line where user 1 has stickipoint DI and the other user has the opposite D2 or a different dialectic order. Either one can spawn a conflict between the two identities but DMT trees can be bom 1407 for both users that lead to a common understanding (Synchronicity point 1408) that can inform and link to a common goal (GSD node 1409) in their merged galaxy. The process uses Transcendental thinking and the goal (GSD nodes) determine the context of the resolution of the dialectics. Area between starts of DMT Streams and the synchronicity point can be calculated as the length of time need to resolve a conflict or misunderstanding or to design better common GSD nodes and trees that will better generate flow for both users and the community. The Transcendental Culture is based off of this Transcendental Thinking methodology of how best to synchronize relationships harmoniously along common goals through increasing awareness and resolving dialectics (thus needs) via synthesis points (discovery of hidden variables) as a synchronicity point in the DMT Stream and in some cases GSD Trees.

FIG. 40 shows Transcendental Education as a result of the same process of Transcendental Thinking across GSD and DMT streams of different galaxies and identities where all the steps are the same but the goal may be different defining a different context.

FIG. 41 shows the examination of an article on a webpage about a football player that was created as a result of a GSD tree in User 2 with User 1 wanting to know the motive behind the task of creating the article and creates a DMT tree to find the synchronization point that whre User 1 can understand the original lead up to the GSD written as it was. This DMT tree could manifest via a program that scans media and articles and applies different analysis via different gateways (such as tracking the source of the GSDs that created the article to a specific gateway and thus identity and thus dialectical structure) which a User may quickly read as shown by the cognitive bias report. If a user wishes to know more about the results, they can perform Transcendental Fractal Transparency and open up the DMT streams and GSD Trees uses to perform the analysis on the Football article.

FIG. 42 shows the T-History and R-History panels where a user can apply the Transcendental Thinking process to start Transcendental Fractal Transparency to trace back DMT and GSD nodes, comments etc to find the roots of a conflict to build a stream for a synchronicity point. This conflict management can spur resolutions of dispute between micro-contracts and agreements if knowledge and awareness did not result in predicted flow or meeting of flow needs or other expectations of performance. Resolution and a set of task nodes to reallocate resources via the # C (change parameter) can be used. This change can be conducted due to the severity of loss of resources and the evidence required from Transcendental Fractal Transparency.

FIG. 43, and FIG. 43A outlines the Transcendental Thinking methodology using attitudinal and dialectical structural (Ascent to Synthesis) categories to generate and help inform flow scores to help perform synchronicity points and more flow states for users. It shows structurally how claims and argumentation can be used to resolve dialectics that may be obstructing flow and to help find the hidden variable to mediate the dialectical interaction of identities.

FIG. 44, FIG. 44A, and FIG. 44B shows an embodiment of the Dreamfinder where a users personal goals can be aligned with the goals of other users or to the Luminary by the users own analysis using allies, their own scores, profile, dialectics and goals with those of the global issues or goals.

The Dream finder may generate GSD and DMT trees for each life area based on the cutting edge Science and studies pertaining to flow in each life area. As these studies are resolved and hidden variables are used to mediate the dialectics pertaining to the life area the system updates any GSD trees or DMT streams to incorporate the new variable in mediation and creation of optimal flow inducing or optimal opportunity for flow or meaningful experiences for the user (seen in the red notification bubble). The blend all button can have the system create an optimized GSD tree across all life areas (including luminary and other galaxies) that satisfy all needs in those life areas based on user goals, potentiality or preferences. The luminary global goals may appear at different dynamic zoom levels and chunking to prevent information overload of the Self individual user who may not be at a dimensionality of awareness to deal with that kind of information and maintain flow instead of anxiety or other emotional states. Users can also track to see why certain resources and goals are set at global levels and by other users if privacy settings and openness allow.

In the methods taught herein, the various acts may be performed in a different order than that illustrated and described. Additionally, the methods can omit some acts, and/or employ additional acts.

Changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions. The Dream finder may generate GSD and DMT trees for each life area based on the cutting edge Science and studies pertaining to flow in each life area. As these studies are resolved and hidden variables are used to mediate the dialectics pertaining to the life area the system updates any GSD trees or DMT streams to incorporate the new variable in mediation and creation of optimal flow inducing or optimal opportunity for flow or meaningful experiences for the user (seen in the red notification bubble). The blend all button can have the system create an optimized GSD tree across all life areas (including luminary and other galaxies) that satisfy all needs in those life areas based on user goals, potentiality or preferences. The luminary global goals may appear at different dynamic zoom levels and chunking to prevent information overload of the Self individual user who may not be at a dimensionality of awareness to deal with that kind of information and maintain flow instead of anxiety or other emotional states. Users can also track to see why certain resources and goals are set at global levels and by other users if privacy settings and openness allow.

In the methods taught herein, the various acts may be performed in a different order than that illustrated and described. Additionally, the methods can omit some acts, and/or employ additional acts.

Changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

Further and in addition to the disclosure provided above, it will be readily apparent to one of ordinary skill in the art that the various processes and methods described herein may be implemented by, e.g., appropriately programmed general purpose computers, special purpose computers and computing devices. Typically a processor (e.g., one or more microprocessors, one or more microcontrollers, one or more digital signal processors) will receive instructions example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth M., and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of a system include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

The present methods, systems and articles also may be implemented as a computer program product that comprises a computer program mechanism embedded in a computer readable storage medium, which may be a non-transitory storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of examples. Insofar as such examples contain one or more functions and/or operations, it will be understood by those skilled in the art that each function and/or operation within such examples can be implemented, individually and/or collectively, by a wide range of hardware, software, firmware, or virtually any combination thereof. In one embodiment, the present subject matter may be implemented via ASICs. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

### Schedule A

System Feature List

In an embodiment of the invention, the system may have the following features:

1. Secure Login Module: Login on a Website Domain
1. User Secure Registration. May use Facebook Credentials
2. User Authentication
3. User Recovery system

2. User Accounts
1. Guest User: No profile. Can only view public information.
2. Registered User:
   1. Privileges: Has User Profile
   2. Privileges: Has a Personal Task Galaxy that they can create new sections on.
   3. Privileges: Can change account settings on privacy of their own account and tasks they own unless an Org Galaxy Owners privacy settings are set to usurp personal privacy settings.
   4. Privileges: Can apply and be assigned roles and membership in organizational Task Galaxies. Cannot create Org Galaxies
3. Section Manager: An upgrade to the Registered User
   1. Privileges: Same as Registered User
   2. Privileges: Has Role Assigned by Org Galaxy Owner
   3. Privileges: Can assign roles in their section and see all stats
   4. Privileges: Can create new roles and modifications in their section.
   5. Privileges: Can set Privacy setting on any tasks in their section.
4. Organizational Galaxy Owner: Upgrade to Sectional Manager
   1. Privileges: Same as Section Manager
   2. Privileges: Assumes Title of CEO or Equivalent automatically
   3. Privileges: Can assign Section Managers and any roles across Galaxy. Can create, and modify all roles and titles.
   4. Privileges: Can modify permissions of Managers to change roles or create new ones.
   5. Privileges: Can also create organization specific variables and awards only applicable across entire galaxy.
   6. Privileges: Can set privacy settings of any task inside Galaxy. This includes whether or not Org privacy settings
5. Sub Admin/Audit Accounts:
   1. Privileges: Same as Org Galaxy Owner
   2. Privileges: Can view all users across entire TUniverse and make alterations or corrections to people's statistics or data, or privacy.
6. Admin:
   1. Privileges: Same as Sub Admin
   2. Privileges: Can alter Admin privileges and any accounts/roles anywhere.
   3. Privileges: Can alter Global Rates and any algorithms in the system.
   4. Privileges: Can make system design changes.

3. Privacy Functionality:
1. User Profile Privacy settings: Permits as to who can see profile details
2. Privacy settings of Social Network: Different groups defined by user can have different privacy configurations. Over the following variables:
   1. Can other users see Profile (skills, talent, knowledge, personality traits)?
   2. Can other users see user owned tasks?
      1. Tasks with a certain due date
      2. Tasks with certain keywords
      3. Tasks with certain defined variables
   3. Can other users see user Personal Galaxy?
   4. Can other users see users
3. Privacy Negotiations: Personal Privacy settings and Organizational privacy settings may clash. A function and a space for new members of organizations to stipulate or agree to the privacy settings of the Organization must be checked off. In some situations, Individual Users may make it mandatory that all tasks they own, whether in an organization or not, be kept private or public. An organization can, in the Negotiation Message, decide to accept these terms. If this Organization makes it mandatory that its settings usurp personal settings, then the Individual User can choose to accept or not. In many ways this will serve as the terms of employment and confidentiality agreement for employment in an Organization or staff membership. This could also work for individual tasks
4. Privacy Negotiations Per Task: When organizations wish to import or take on tasks from individuals, then individuals can define privacy settings per task.
5. Privacy settings on Task Trees: Head Tasks of a Task Tree can have privacy settings to set a blanket privacy across all tasks underneath it. Any task that has tasks under it can have a blanket privacy for efficiency. All tasks are default public tasks.

4. Knowledge Economy: Skills, Knowledge, Talent Database (SKTD)
1. Similar to LinkedIn Skills Beta
2. Allow Users to define definition of
   1. Skills: Soft and Hard Skills, Technical skills.
   2. Knowledge and courses: Include formal and informal knowledge. Formal Knowledge includes accredited academic courses based on the grade scale (Grade 1-12, post-secondary, Diploma, Undergrad, Masters, PhD), informal could be non-professional or new budding fields of knowledge from the grassroots (like emergent interdisciplinary or trans disciplinary fields based out of hobbies etc., that could later be turned into accredited formal knowledge domains). Organize database in terms of organization of Interdisciplinary knowledge: Phenomena, Data, Theory, and Method.
   3. Talent: Use the Strength Finder Talents from which those users can select Top 5.
3. Testing Centre: Allow users to test their skills and knowledge through tests

5. WellBeing System
1. The System can deliver a survey once per day for the user to take on default variables such as: Did you do 10 minutes of Meditation today? Did you get 7 hours of sleep last night? (Yes or No). Did you exercise today? (Yes, No, Rest Day). Did you get 12 hugs today?
2. System will add up responses across the user but also globally to provide an average over time of how that user's wellbeing is on those variables.
3. Wellbeing can then be compared to other performance variables.
4. Users can toggle whether or not survey pops up once per day. They can also edit their answers up to a week.

6. Task Industries or Task Action Types (TATs)
1. Task Action Types: There are 6 main TATs: Creating, Completing, Splitting, Linking and Pushing. These are actions that can be universally performed on tasks in the Task Universe.
   1. Creating: A menu opens up when a user clicks on an empty space in a Task Galaxy that allows the user to set variables for the Task such as:
      1. Non Automatic Variables:
         1. Status: Whether it is completed, Pending or Failed
         2. Description: What the task is about in 10 words or less
         3. Due Date: When it is due and what Date Ring it is in.
         4. Org Galaxy: Does it belong inside an organization? Must be a member of the organization and have correct permissions from either Org Owner or Section Manager.
         5. Section: What section or department of the Task Galaxy the task resides
         6. Skills: What skills the task needs to be completed
         7. Knowledge: What knowledge domains are needed to complete the task
         8. Talent: What talents may be needed to achieve the task
         9. Goals: What goals will be satisfied if the person owns the task and completes it (This can have defaults and also Org Specific.
         10. Strength Pillar: Which of the 4 Strength Leadership pillars is needed: i.e. All, Executing, Influencing, Relationship Building, and Strategy.
         11. Money Value of Task: Owner Willing to Pay.
         12. Owner Points: How much the value of the task is based off users Complete rate (Users who take on ownership get the creators rate if it is higher but get their own if it is lower)
         13. Custom Org Variables: These are variables that organizations can apply specifically within their organization. The System will track the variable within that Galaxy, e.g. strategic variables. Sector or Org Owners can set which variables are mandatory and optional.
         14. Privacy: User can set the viewability to No One; Friends; Acquaintances or other custom defined groups.
      2. Automatic Variables:
         1. Creator Ownership: When a User Creates a task, the “Creator” variable is automatically set to the User who created the task. The Time of creation is tracked.
         2. Unique Account Identifier Code: This is automatically assigned to the task. The system scans for the account's unique code (an abbreviation of sorts with a number sign denoting it is a tag, e.g. # pres for President or # MMcCormack for the account under Mark McCormack).
         3. Unique Task Identifier Code: The system automatically assigns a code to a task when it is completed. The system scans the account for its Unique Account Identifier Code and then scans how many tasks that user has created already or owned in total. If a task is, for example, the 34th that that account (for example # pres) has owned then the new task would be #34pres. It would be the account code plus the number.
   2. Completing: This TAT occurs when user wants to mark the task as finished. They get the Global Complete Rate and Personal Complete rate. User must click on task and select this option.
   3. Evidence Box: When a user completes a task an evidence box pops up wherein the user can submit evidence, either a written statement, a reference to an email or document, or upload a document, picture video as proof. The Evidence box pops up when a user clicks on a task and selects the Complete TAT.
      1. Dialog box: This is where User types in an explanation of why the task is considered complete and can reference to the attachments.
      2. Attachments: User can upload and attach documents like pdf, Microsoft word and other documents, image files, video, sound.
      3. Submit Button: User clicks this and it sends the description and attachments to the following:
         1. Previous Owner or Creator for verification in their THistory
         2. To People in that persons Network for several verifications.
         3. To People connected to this task in a Task Tree
      4. User does not get to select or know who gets referenced for the verification. User only knows who actually confirms from their THistory but does not know who gets notified.
      5. Auditing: The evidence can be contested if someone reports it or if no one endorses its completion with a good reason.
      6. Anonymous Rating: After a Task is marked as Completed, other users who may have been connected to the Task, or witnessed it can rate the quality of completion from 1-20 and must provide an explanation for their rating. This is also sent to the Audit Committee. User can either do it non-Anonymously or anonymously but then have to provide explanation.
      7. Rendition System Saving: When a user completes a Task that has sub-tasks that were also complete, the option to save the Task Tree with all associated comments and documents can appear. The User can then save the Tree in the Rendition Encyclopedia. (All Tasks must be accomplished and verified by Audit Committee or have a high peer ranking through anonymous or non-anonymous ranking).
      8. Evidence Caveat: User does not get points or money associated with task until both Audit Committee and creator of task confirm that evidence is sufficient. If not, user can make a modification in their THistory when the Complete TAT comes from this user for verification. Instead of hitting the Verify button, they can modify and make a comment in the discussion.
   4. Splitting: A User clicks on a task and Split can be selected. This will open a sub-menu for task creation on two tasks that will be linked to the main task.
      1. Sub-Creation Menu: Two blocks appear that are identical to the creation menu where users can select the creation variables (skills etc.) of the two tasks. Another button with a “+” sign can be clicked to split the task into more than just two tasks.
   5. Linking: Users can link their task tasks to other tasks.
      1. Random Task to Task Tree: a floating task with no children tasks can be linked into an existing Task Tree.
      2. Parent to Parent: Parent tasks may be linked
      3. Interlinking Task: An option to create a link between two tasks can come with an option to create a task that links the two together that can serve as a parent node.
      4. Pushing: Users may change the due date of a task either further into the future or earlier.
         1. Push Menu: Users can enter in a different calendar date with a miniature pop up menu.
         2. Points: Pushing tasks further into the future should be discouraged so users can lose points if they push too far.
         3. Appeals: Users can send an appeal to the Audit Committee if they have to push a task or task tree further into the future.
         4. Pushing Past Parent Tasks: Tasks inside a Task Tree cannot be pushed further into the future than their parent node.
         5. Transferring: Transferring allows ownership of tasks to change.
         1. Owner to New User Offer: If the original creator decides a better candidate should complete the task, or that they are overloaded, or want to free up their pending limit, they can make a request to someone in their network or in the Public Universe Pool.
         2. New User to Owner Offer: If a User has a filter for certain variables in tasks, a task may pop up in their Action Feed or news feed and they can click and make an offer to the current owner for ownership.
         6. Comments: Comments can be made on a Task. They are added to any previous comments. Users can see the entire conversation when they contribute a comment. Each Comment is assigned a “comment number” so that the system can track it for keywords using the Search function. (e.g. Comment #34454)

7. Personal and Organizational Galaxies and Ownership
1. There are Personal Task Galaxies and Organizational Galaxies
   1. Personal Galaxy: When a new account is made, it comes automatically with a Personal Galaxy. When a User creates a task (using the Create TAT) in their Personal Galaxy, then they are the automatic owner and the creation information (code, timestamp, area) is recorded under that user. The task shows up in that persons Personal Galaxy and may be viewable to the Public in the Task Galaxy or not depending on the privacy settings.
      1. Any Tasks that a user owns shows up in the Personal Galaxy (PG). Users that own a Parent Task will also have all the connected tasks show up in their PG in a way that collapses or is faded.
      2. PG Task to OG Task: A tasked created in the PG can be made to show up in an Org Galaxy by the following steps:
         1. Clicking on a blank spot in the appropriate section of the PG and selecting “create” from the TAT menu.
         2. Selecting the appropriate Organization from the organization variable (A list of all public organizations will drop down. The user can only select organizations that they have membership in and a title. Subscribed members cannot create in those Org Galaxies. Users can apply for membership from the list and submit the proposed task).
         3. A preview window of the Org Galaxy will pop up and the User can click where in the Org Galaxy they want the pending node to exist.
         4. Once the creation is finished, the node will be shown as pending orange in the PG and also in the OG. A notification is sent to the THistory of the Org Owner or Section Manager depending on the privileges set by the Org Owner
         5. The org owner will be shown the Pending Task placement and can confirm or deny, or amend the request or grant membership.
         6. Once confirmed the nodes will change from orange.
   2. Organizational Galaxies: A User can create in an OG and then place it in their PG with the following steps:
      1. Click on open space in OG and select “Create” option from TAT menu.
      2. An automatic pop up shows a view of your PG and you can place where you want the task to end up by clicking or dragging.
      3. Notifications are sent to THistory of Section Manager or Org Owner depending on settings. SM and OG may turn off notifications so that some members can create freely.

8. Task and People Matching: Flow State
1. Flow State in Tasks: Flow State is a conscious state that all human beings seem to enjoy tremendously. In the System, we want to give a quick intuitive way of helping people choose experiences that have a higher chance for flow. The Flow Score is based off of matching the variables in the User Profiles with the variables in the Tasks. There are two types of variables: Strength Variables which are predominately Skill, Knowledge and Talent and Dream Variables which are Personal Goals (PGoals), Myers-Briggs, Love Languages, keywords.
   1. Task Flow Algorithm: Match up Skills, Knowledge and Talent and then match up level of expertise needed in each one. Determine what percentage of the skill level that user has and add one point to the Flow Score for each percentage point closer to needed level until it passes needed level. If passes needed level subtract points.
2. Flow State in People: Some of the most meaningful and rewarding experiences occur in teams. The system will also match User Profile to User Profile to determine a People Flow Score much the same way of matching Strength Variables to Dream Variables.
   1. Algorithm: The same as in Task Flow Score except you match up variables and expert levels and dream variables and personality types based on user profile variables.
3. Flow State in Groups: Groups of people (Masterminds) will come together to form strong microdatabases of skills, talents, knowledge.
4. Macro Flow State for Task Universe: The System will aggregate all together all skills, knowledge, Talents and Dream Variables across all users and compile them in the SKTD and Dream Database on both the User Side and the Task Side (i.e. The Supply Side and the Demand Side) and calculate a match Flow Score across the entire system. This is also the basis for revolutionizing advertising from spam to resource allocation.

9. Social Network, Masterminds, Resource Mapping and Advertising
1. Every user account can have a social network built as a subset from the Global Mastermind (the entire network on the System). The Social Network is based around the idea of the Mastermind group, a group of people who use their skills to invest in each other's goals and dreams. Different levels of trust can be developed and organized into different Mastermind groups (i.e. Family, Close Friends, MasterMind Group #1, Acquaintances).
   1. Reputation Variables: Every time a User performs a TAT on another users task it adds a point to the reputation score between that User and the other user.
   2. Synchronicity Coordination and High Value Moments (Satori Moments): The System will compute all the Strength Variables and Dream Variables (based also off Keywords) in your network and develop suggestions on who the user may wish to work with (based off of Flow Scores), what they may wish to work on, and what team would be most likely to be a high performance team (team with a high flow score based off Myers Briggs, strength finder matching in particular). This can enhance a user's ability to find more meaning in the people they interact with and events they create and experience.
      1. Suggest individuals from all user defined groups and also people from the Universal Mastermind Network.
      2. Suggest teams: suggest people who would work best together, not just with you.
      3. Suggest Tasks: suggest things you may wish to work on with others by combining data on trending articles that match keywords in users Dream Variables and Strength Variables.
      4. Suggest Adventures and High Value Moments (HVM): calculates and meshes together recommendations of people and tasks.
      5. Suggest Orgs (Advertising): Each organization inside and outside the system can apply and pay to be in the “Resource Synchronization” or “Supernatural Aid” program which basically provides exposure to organizations who provide highly credible, and high quality service.

10. Task Trees, Inheritance and Emergent Complexity
1. What is a Task Tree? A Task Tree is three or more nodes generally with a single top node defining what all the connected tasks are trying to accomplish. The top node is called the Head Task or the Main Parent Task or Project Definer. Task Trees are essentially projects mapped out in terms of tasks. Other than a bottom limit of three tasks (1 Parent with at least 2 Children), Task Trees do not have a maximum number of tasks. Some may be incredibly large with several hundred or thousand tasks. The More tasks and Parent Nodes there are in the Task Tree, the greater the complexity of the project.
   1. Complexity Algorithm: More complex and challenging Tasks generally get broken down into larger Task Trees. The complexity is calculated through two main variables: Horizontal Complexity and Vertical Complexity. Horizontal Complexity has to do with the number of tasks in the tree and Vertical Complexity has to do with the number of Parent Nodes Chained together (how deep the tree is).
   2. Leadership variable: Highly Complex tasks add a dimension to the Challenge score outside the SKT Variables. Users develop experience in certain complexity types. There will be different levels of complexity that tasks fit into and users get “leadership points” on a certain complexity level every time they perform the Complete TAT on that complexity level. This develops a picture of how experienced the user is at certain levels of complexity.
   3. Inheritance: A task becomes increasingly complex the more it is split into other tasks. The Strength Variables and Dream Variables in the children tasks are inherited by the Parent task. This is to ensure that the owner knows that in order to complete this task they need all the strengths necessary to achieve all children tasks.
   4. Collapsible Annotation of tasks: If a user or Org only owns 1, 2, or 3 tasks but not the whole Task Tree, then an annotation beside the tasks can be clicked to de-compress the node and show the entire task tree that it is a part of. All Task Trees can be collapsible.
   5. Editing and Updates to Children: Updates or changes to any tasks, whether being pushed etc., updates all other nodes in the task tree.

11. Point System, Rates Ticker, Game Dynamics and Rules
1. The System is essentially an economy of tasks and this is where much of the control over incentives comes into play.
2. There is a default of five tasks “Industries” or Task Action Types: Creating, Completing, Splitting, Linking, and Pushing. Users can generally perform all of them or specialize more in one than others.
3. Each Industry has its own rate (Global Rate) that applies across the entire Task Universe and is public to all users much like the NASDAQ or other market identifiers. The system needs to stay balanced between creating and completing. If there is not enough interesting work to do, people become “unemployed”. If there is too much work to do, people burn out, hypertension sets in, health care goes up, and the stress epidemic continues.
4. Balance Algorithm: Each User has a “Creating Limit”. Therefore, theoretically the system can calculate the maximum amount of tasks that can be created and pending at any one time if all users created to their max limit. Let's say, for example. 100 users have a max limit of 150 tasks when added all up. We want it so that if everyone creates to their limit, then the Creating Global Rate goes to zero when all creating potential is used up, but it maximizes the Completing Global rate. For each task created, 1/150th of the points are reduced from the Creating Global rate and 1/150th is ADDED to the Completing Rate. The other Global Rates for Splitting, Linking, and Pushing are related to this balancing act.
5. Personal Rates: Each user has their own individual rates for each industry or TAT. When an account is new, it begins at the lowest rates with the lowest Creating Limit which is 3 (i.e. that user can have 3 uncompleted and pending tasks at any one time).
6. Stock: Stock really just means the total amount of points a user has built up in each TAT. The user gets a total amount of stock for each TAT based on their personal rate and global rate. So if they create a task and their personal rate for Creating is 5 and the Global rate is 9, then the total amount of points added to their Creating Stock would be 5+9=14.
7. Caps and Leveling: As the user builds stock in each TAT they reach different Caps or Levels that are set by the Admin. These Caps are universal for all users. When a user reaches the next cap, their personal rate goes up also by a set amount determined by the Admin.
8. Organization Specific Stock: Some Task Galaxies may have the CEO define a variable that can be assigned to tasks created in their Galaxy that they system will then track and add up for users in their “Reputation Section” in their User profile. This Stock on these variables does not apply outside the Galaxy like the TAT Stock.
9. Set Point Rule: It is very difficult to start users off with a creating limit, especially when they may already have a great deal of tasks they want to create. Instead of starting everyone off at the bottom rung, the system should give users a chance to create as many tasks as they want and try to achieve over a month. The system will track their performance and determine a set point create limit for that user. (This limit may be limited to organizations and only apply inside their Org Galaxy as set by the Sector Manager or Org Owner.)
10. Org Title Rules: Sector Managers or Org Owners can attach rules to each title they assign. Such that each title may come with a set of skills that must be included in 100% or perhaps 80% or another set percentage of tasks that this user creates within that task galaxy. For example, the VP Finance Role may come attached with a demand that 80% of their tasks include “Finance” in them and 20% can be without it.
11. Org Pending Limits and Set Points: Sector Managers and Org Owners can set their own point scheme for how users advance in their organization. Org Owners can also set the Set Point for any users.

12. Filters, Action Feed and Notifications:
1. Users can set many filters for their notifications and how information is displayed in the Task Galaxy. A filter could theoretically apply to any variable over any scope of Galaxies within the TUniverse.
   1. Color of Task Nodes: The color of the nodes can be controlled by the user to display information quickly on any variable.
      1. Flow User and Tasks: Is default set to convey the six emotional states from the Flow Diagrams based on the Flow matching of User with Tasks. Users can custom set which colors represent which emotional state.
      2. Flow User to User: Calculates the 6 emotional states a User might experience with Owners of the Tasks of the nodes.
      3. Match of Keywords: Colors of nodes can be set to relevance on a specific keywords defined by user (like search) over task description or comments within the task.
      4. Match on Complexity:
      5. Match on PGoals:
      6. Match on Skills
      7. Match on Talents
      8. Match on Knowledge
      9. Match on all available variables etc.
      10. Match on Number of Comments
   2. Shape of Nodes: Shape of nodes can be used to convey variable information as well.
   3. Color or glow of Connecting Lines: The lines between task nodes can indicate information between the owners:
      1. Reputation (trust): Level of reputation between users
      2. Gantt Progress: Users can click on the line and drag to make the line glow for how much progress they feel they are making on the task (or by default system calculates how complete the tree is and glows more of the line. When the line is fully glowing, it means all the tasks below the parent task are done.
   4. Annotations: Users can assign certain variables to pictures or annotations that can float around task nodes.
2. Action Feeds: A User can have multiple feeds collapsed at the bottom of their screen that can be filtering a certain variable (including organizations), or a combination of variables. (I.e. One list could be for watching tasks from MPH Galaxy, and Comments on a specific task).

13. Task Brokerage THistory and RHistory
1. The System has operating functionality like that of the Stock Market. Users can trade tasks and these transactions must be coordinated much like an Online Stock Brokerage. This is where the user manages requests to them and their requests to others:
   1. Brokerage Page: This is where both the THistory and RHistory are side by side on the screen showing what tasks are being asked of the user and which ones the user has made requests on.
      1. THistory: This is the page where the user manages all the requests others make to them. Initiated by others. Every time another user performs a TAT on a task that this user owns, a notification is sent to them to accept, deny or modify.
         1. Top Summary Page: Shows in a notification bubble all the new requests still pending, and new requests or changes since last looking at the Brokerage page.
         2. Cell Color: Cells will be a different shade if they have not be acknowledged or looked at or clicked on.
         3. THistory Cell: each request to the user shows up in a square cell that contains
         1. Time and Date of Request
         2. Picture of requester
         3. Name and code of requester
         4. TAT Requester is asking to perform
         5. The Task Code being acted on and the new resulting task codes if any.
         6. Accept Button: If User accepts, then TAT is performed and RHistory of other user shows “accepted”
         7. Deny Button:
         8. Modify Button: User can suggest a modification of any variables or tasks that would result of TAT. Other user is then notified and can accept or modify changes.
         9. View More Button: The variables of tasks involved are hidden for simplified view of cell. User can click this and expand cell to show all variables in tasks.
         10. Discussion Button: Essentially a chat session that gets saved to task. Users leave comments to one another.
         11. Discussion Notification: When one user makes a comment the other user is shown that a comment is pending in a bubble.
         12. Money Show: Shows if you are offering money.
         13. Points: Shows how your points and their points will potentially change if TAT transaction is accepted.
         14. Rate Task: On “Completed Tasks” this option shows up where a user can rate the quality of completion if they saw it.
         15. Report Task: On “Completed Tasks” this option allows a user to report a task to the audit committee that was fraudulently reported as complete.
         4. RHistory: This is the pane where a User tracks his requests of others. This is requests initiated by them.
         1. Top Summary Page: Shows in a notification bubble all unanswered new requests still pending, and new requests or changes since last looking at the Brokerage page.
         2. Cell Color: Cells will be a different shade if they have not be acknowledged or looked at or clicked on.
         3. Status: this shows if the other person responded and how they responded. Either by a Green Accept, a Red Deny, a Modify claim, or Pending.
         4. Date Request was made: Shows when you made request and how long it has been pending.
         5. TAT and Codes: Shows what TAT you are requesting and what task codes are involved.
         6. Modification Table: shows what modification to which variables or descriptions the other user made. User can accept or remodify and send back.
         7. Cancel Button: User can cancel request.
         8. Discussion: User can send messages back and forth about request.
         9. Discussion Notification: User is notified if other user made a new comment since they last checked in to Brokerage.
         10. Money Show: Shows if you are offering money.
         11. Points: Shows how your points and their points will potentially change if TAT transaction is accepted.
         12. Verified: On your completed tasks, those referenced for verification can show when they verified your task.
         5. Down Bar: There will be a “down bar” which when clicked or scrolled down to will load further history all the way back until user created account.
         6. Search Bar: User can search for a certain transaction based on variables such as date, other user, codes, status, discussion keywords, prices, points.

14. User Profiles
1. (User View and public view may differ)
   1. Uploadable Picture
   2. Pictures/videos from user being involved in and tagged in Tasks.
   3. Social Network
      1. Show number
      2. Allow to categorize into Close Friends, Friends, Acquaintances, Colleagues
   4. Skills List.
      1. Allow user to input list of skills from the SKT Database
      2. Other users can endorse skills
   5. Knowledge List:
      1. Allow Users to input list of skills
      2. Other users, institutions of learning and governments can endorse
   6. Talent List: Allow Users to input list of talents.
      1. Other users can endorse
   7. Privacy Settings: Users can adjust the privacy settings of individual elements on their profile including:
      1. Privacy of Profile
      2. Privacy per task
      3. Privacy of Analysis
   8. Monetary System Settings: User can set funding source and funding amount to hold in their System Account.
   9. Incomplete Manifestations: Where user can open up the Manifestation edit Panel and continue any Manifestations they saved.
   10. Analysis:
      1. Life Graph: Shows a chart with number of tasks on the Y-axis, Days on the x-axis and toggle buttons for lines on the graph that represent each section of the Users Personal Galaxy. The Default Sections are: Physical, Mental, Academic, Spiritual, Family, Friends, Relationships, Virtues/Dreams/Global citizenship, Politics, and Finances.
      2. Org Macroeconomic Analysis and Charts: For each Org Galaxy a User Owns, there is tab dedicated to analysis to it. There is a “Master Summary” across entire Galaxy, and then a break down analysis of each section.
      3. Analysis numbers should be displayed
         1. All Current Rates: Completing, Splitting, Linking, Pushing, Creating
         2. All Current Stock: for all Task Action Types (TAT)
         3. Next Cap Levels
         4. How many times user has performed each TAT
         5. Organization percentages: How much of the TAT were performed in each organization in percentage and number (e.g. MPH has 68% of all Creating, or 136 of 200 creations)
         6. Universal Pie Graph: How much time spent in each TAT since join date (Not Org Specific)?
         7. Universal Performance Line Graph: Shows history of daily performance with a line for each TAT. The following can be toggled:
         1. Show user performance per day in each TAT. Each line on the graph represents a TAT that can be toggled on and off.
         2. Show Averages of user across each TAT per day since join date.
         3. Show Global Averages across each TAT of all users since their join dates.
         4. The graph can show history of user since join date up to present day and user can also set how far in the future the graph draws as well (to show pending tasks).
         5. All graphs and lines can be toggled.
         6. Future visible variables: There are 2. On the graph there will be a moving vertical line showing the present day. Past the present day only the Total Pending Line and Still Pending Line show. Total Pending Line is what is “PLANNED” to be completed on that day and Still Pending Line is what is still left to do out of what was planned. Because users can Complete Pending tasks before their due date, the Still Pending Line can be lower than the Total Pending Line (Total pending line is unaffected by user Completing performance but can go up or down depending on how many people create tasks for that day).
         7. Well Being Bar Graph: The user's wellbeing per day is superimposed onto the performance graph.
         8. Well Being Line Graph: Is a graph showing the user's daily answers to the 5 default variables and the average line since join date, and also the global wellbeing.
      4. Reputation Analysis: areas for each organization that user has been a part of
         1. Display Join Date and length of Membership to date
         2. Display Title(s) User has had and for how long in each organization.
         3. Display Analysis Numbers: For all TATs performed in that Org Galaxy, show stock, TAT numbers
         4. Graphs: Pie Graph showing how time has been spent per TAT,
         5. Line Graph: Showing users performance across each TAT in Group in comparison to group average of other users (i.e. User might have completed 5 tasks on average per week, and group average across 100 users is about 7 tasks per week, so this user is under performing the average.
         6. Supply Chart: This is a 4 column table that numbers from ascending to descending order the most abundant skills, knowledge and talent in the group. One column for rank, Skill, Knowledge and Talent. Each rank row shows the skill, talent or knowledge with a number beside each one that displays how many of the users in the group have such skill, knowledge or talent in their profile. This table continuously updates.
         7. Demand Chart: The same as the Supply Chart except instead of scanning across members skill, knowledge and talent variables, the system scans the task skill, knowledge and talent variables and adds up how many tasks demand each variable.
   11. Sector Manager Extended Profile Privileges
      1. Spider Match Chart: Matches up Supply and Demand charts for that sector and then scans across users who are not at their creating limit (i.e. they have enough free time to take on tasks) and matches them up to the top 10 tasks in demand in a spider chart. So you get the top 10 free people who have the most free time and the skills, knowledge and talent needed.
      2. Admin Page Limited to Section
      3. Rewards page for section.
   12. Organization Owner Extended Profile Privileges
      1. Admin Page for entire galaxy
      2. Rewards page for entire galaxy

15. Rewards and Awards
1. Rewards are manual awards that must be given out at a physical ceremony or something of that sort. They are not automatically assigned to user profile.
2. Awards are automatically added to user profile.
   1. Admin define criterion for awards. The system makes the calculation based off of variables in the system and are automatically assigned badges to User Profiles.
3. Rewards Page: This is where both Rewards and Awards are managed across the System. Organizations have the same page except only confined to members within their organization.
   1. Reward Summary: Shows how many rewards were delivered in certain defined chunk of time: last 2 weeks, this month, last quarter, half year, year, all time etc.
   2. Time since Last Award (Per Member): A list of all users across the System (for Orgs it is members in their organization) with those who haven't received an award in the longest period of time at the top and those who most recently received an award at the bottom. (Can be flipped).
      1. Shows days since last award given to that user account
      2. User Name
      3. Last Award given
      4. # of awards User has in total since join date.
   3. Love Threshold: When a user falls below a certain defined date since an award is delivered to them it sends a notification to the history log and to the Audit Committee or in the case of an organization to the Org Owner.
   4. Upcoming Awards that Need to Be Assigned: This is a section that shows when the next scheduled awards are needed to be defined in terms of manual awards in a defined period of time (Default is within 2 weeks). This section is a list that shows:
      1. Rows: Top row is the most recent upcoming date of award. Going down list shows those further and further in the future within defined period of time.
      2. Columns: Are variables listed as such:
         1. Latest date needed to assign winner for award:
         2. Name of Award
         3. Group of people needed to decide the award (Can choose people from a list across System or in case of Orgs within that org) to be on deciding committee
         4. Date of Committee to meet (and make decision). User can input a date after consulting others or have a group discussion.
         5. Suggested list of winners
         6. Winner: Admin user can select this box and menu of all members pops down with their name and codes where they can select 1 member or a few members. When the selection is made, this row goes in to the next section defined as “Award That Need To Be Delivered Manually”
   5. Awards that Need to Be Delivered Manually: This section is similar to “Assigning the Award” but now that a winner or winners have been assigned, someone needs to deliver the award. This section is also organized in rows and columns with the top row with the closest upcoming date of award to the latest.
      1. Rows: Each row is a new award that needs to be delivered starting with the closest to deliver date at the top.
      2. Columns: Each Column contains a variable about how to deliver award:
         1. First and Last name of Winner
         2. Delivery Date: When the award should be delivered
         1. Can select an occasion and date.
         2. Shows how many awards are being delivered that day.
         3. Award name and description
         4. Award type: types include plaques, trophy, engraving on trophy, shout out, certificate, gift etc.
         5. Protocol: this is the protocol or steps and context for delivery such as who should be in attendance, speeches, timing etc., and place. Who delivers.
         6. Days since Award Should Have Been Delivered: Shows how many days left until deliver and if delivery day passes how many days have passed.
         7. Been Delivered: Has two check boxes.
         1. Once Yes has been checked off, award is removed from this section and added to the Award Log.
         2. Yes
         3. No
   6. Set Rewards Section: This is where the Admin or Org Owner can set the criterion for Awards in one box and Rewards in the other. This is a comprehensive list. For Automatic Awards there are 3 columns per row with each row being a new award. Here are the three variables:
      1. Automatic Awards:
         1. Award name: States name to show in User Profile
         2. Award Criterion: Can define an equation that the system uses to sort out and filter variables of all users in the system. Organizations can set awards from their own custom variables.
         3. Award Description: Tells what award is in layman's terms.
         4. Add New: Can click on this row and create a new Award
         5. Modify Cell: Admin can click on any cell to modify it. Modification is recorded in Award History.
      2. Manual Rewards:
         1. Award Name
         2. Award Criterion
         3. Award Description
         4. Award Delivery Protocol
         5. Award Suggested date
         6. Create new: Can click on this blank row and add a new Reward to define.
   7. Reward History Log: This just compiles a list of all awards assigned, created, modified, and delivered. It sorts history with most recent activity time stamped at the top. Each row is an event described in the following variables
   8. Award History Log Search: Can search the Reward History log for certain keywords.
      1. Time Stamp of Event
      2. Even type:
         1. Delivery: To who
         2. Assignment: To Who
         3. Creation: Award Name
         4. Modification: Award Name and variable change
         5. Love Threshold trigger: who dropped below

16. Monetary System
1. Every user can get points for TATs and transactions but in addition, each account can be hooked up to online banking or a payment system where they can offer money optionally for completion of a task.
   1. Money as incentive to sell: Users may wish to assign money to a task to increase the incentive for ownership transfer. There are two ways to do this:
      1. User can select amounts from the “Money Variable” when they create a task. This is if they want to encourage someone to take up the task for them so that they can transfer ownership.
      2. A User may see a task in a galaxy, or in their action feed and click on it. They can then select the Transfer TAT and select “Offer Money” to pay for the task ownership. Once the Current owner clicks the Accept button in their THistory, the ownership transfers and the money and point transactions occur.
   2. Funds: Users can fill their account with funds directly from their bank.

17. Auditing
1. The functionality of the system depends a great deal on trust. Auditing is a way to ensure users aren't trying to cheat the system and to ensure it remains fair.
   1. Auditing for completion: The most important part of auditing will come from completing the tasks. Users are asked to provide evidence for their task completion in the way listed below, but after this, if a dispute is found, then any user can report the task to the Audit Committee.
   2. Evidence Box: The Evidence box pops up when a user clicks on a task and selects the Complete TAT.
      1. Dialog box: This is where User types in an explanation of why the task is considered complete and can reference to the attachments.
      2. Attachments: User can upload and attach documents like pdf, Microsoft word and other documents, image files, video, sound.
      3. Submit Button: User clicks this and it sends the description and attachments to the following:
         1. Previous Owner or Creator for verification in their THistory
         2. To People in that persons Network for several verifications.
         3. To People connected to this task in a Task Tree
   3. Reporting a Task To Audit Committee: Users can report a task that is marked for Completion from their THistory or from looking up the History of Completed Tasks from that user and clicking the report button there. A dialog box pops up when a User wants to report a task
      1. Task Code: Shows the Unique Task Code being reported
      2. Description Box: Gives a place for a user to describe why they are reporting the task.
      3. Uploading Evidence: User can upload supporting documentation.
   4. Received Reported Tasks: The Audit Committee will get a notification when a new report comes in. There are two section in the Audit Committee Area:
      1. New Reports: Shows reports with the newest reported at the top or bottom. These reports haven't been looked at.
      2. Reports Under Investigation: These are currently under investigation.
         1. A Panel for this page allows Auditors to send private notifications to Users THistory and revives the discussion from the old Cell of the task. A discussion can ensue about the evidence provided for and against the task. User can then provide even more evidence that task is completed. Auditor can then make a decision on what they are going to do and get confirmation from both sides if this is ok. Auditor can then mark the Case as Closed and send it to be archived in the Resolved Reports.
      3. Resolved Reports: This is where the appropriate money, or points or punishment is assigned and the Audit Committee takes action.
         1. Punishments: Those users who did not complete a task adequately can have points removed, point penalties applied, other users can be rewarded points, and money can be awarded back. In the case of money, Lawyers may need to get involved. The System may be able to recommend lawyers through the Resource Mapping Advertising mechanism.

18. Rendition System
1. The Rendition System is an archiving system to save Completed Task Trees that have no outstanding reports on them to the Audit Committee. Any User can search the Rendition Encyclopedia and select trees to implement.
   1. Rendition Encyclopedia: Is the database that stores all the Task Trees.
      1. Rendition Page: All the Task Trees are saved on independent “pages”. The pages contain statistics on the Task Tree such as the complexity rating, overall average quality rating (by adding up all the ratings of the tasks), how many users were involved, date the head task was implemented, number of parent nodes, and tasks altogether. On Each Page can be multiple Rendition Tabs. Each Tab is essentially the same Task Tree with relatively minor alterations.
         1. Colors: When a user is looking at a Page, all the tasks are filtered and matched through that Users profile. Colors can convey variable information such as Task Flow Score (See annotations).
         2. Task Variables: User can click on a ask and see all the variables of that task as it was when the Tree was made including creator, previous owners
         3. Task Comments: User can click on tasks and view all the comments and discussion on that task. Users can also see the history of the task in terms of TATs it was a part of or had performed on it. Any modifications can be seen (modifications show up in the comments section.)
      2. Rendition Tabs: Each tab contains the skeleton of the same essential tree with minor alterations. Perhaps a new task was added.
         1. The Base Skeleton is shown in a slightly different shade, and extensions or additions to create the new rendition are shown in a different color. This clarifies what changes were made to the original implementations on the first Tab of the Page.
         2. Rendition History Chain: Each time a user implements one of the renditions, that rendition is saved under the appropriate tab or the tab that spawned this user's version.
      3. Implementation Box: A User cannot implement any Task Tree they want. The System tracks a User's Profile and points and experience before they are able to implement a Task Tree.
         1. Resiliency Check: Users cannot implement a Task Tree that is of Complexity that is beyond their Skill, Strength, Dream Variables and Pending Limits. This Resiliency Score is displayed on the Tab of the Page. The can enter the Manifest Edit Pane to try and meet the Resiliency but they cannot create the tree until it is met.
         1. Strength Lack: If a User lacks too many skills, knowledge domains and expertise, or the right talent, then the system will reduce their Resiliency score for each missing attribute.
         2. Dream Lack: If the dream variables do not line up it reduces the score slightly due to risk of lack of sustained motivation.
         3. Inadequate Pending Limit: When a User has a pending limit of fewer tasks than the tree is comprised of, then they cannot or are severely hindered from taking on the Task Tree. If a Task tree is 35 tasks large, then the user needs to have a pending limit of 35 tasks. There is an Exception.
         2. Acceptance of Task Tree Implementation: For example, if the system detects adequate pending limit with skill 80% skills then user can click on “Manifest” and a pop up box of their personal galaxy occurs and the Task Tree superimposes in a faded manner on the PG. User can then drag the Head task around to determine where, what section, and what dates the tree will start. User can also drag and select different date rings for other tasks.
         3. Manifestation Editing Pane: After the Manifest Button is clicked the Manifestation Pane Pops up with the Users PG with the Task Tree superimposed on it.
         1. Edit Due Dates: The Task Tree superimposes with the same distance between Due dates as the initial implantation (so if distance between Head Task and the Second Tier Task was 5 days, it would be 5 date rings difference in the PG superimposition). User can click and drag to new dates
         2. Edit Strength Variables: User can click on any task and delete or Modify it by opening a new menu that shows all the variables of that task. Changing variables in one task will change the inheritance of parent tasks.
         3. Adding to Tree: If the user wants to make the task even more complex, they can add more task if their pending limit allows. When user adds more than 5 tasks (variable to change), the system can save it under its own Rendition tab rather than just a Rendition in a Tab History Chain.
         4. Allies Function and Getting Past Personal Pending Limits: If User does not have the Proper Pending Limit, then they can use the Allies Function to invite friends to certain tasks. If Friends or people from the TUniverse take up enough ownership of the Parent Tasks, then he User can Create the entire tree.
         1. Reputation Caveat: Even if user can get enough people to transfer enough ownership, there must also be a certain aggregate level of reputation points between the people to meet the Resilience score. User cannot invite random people because social bonds may not be strong enough to meet the risk. Also, if user does not have a strong Reputation with another person, but that person has a very high Completion Rate and very low failure rate, then this can factor into the Resilience and allow the creation of the Tree.
         5. Editing and PG and OGs: When Changing the Organization Variables on Tasks, user must be a member of those organizations. When changing org variable, the Org Galaxy pops up with the task superimposed on it. If the Task Tree is successfully implemented, it is created in Users PG but the individual task or tasks will show in OG (with a collapsible annotation that can be clicked to show the entire tree the tasks are linked to).
         6. Incomplete Editing: If a User puts in time to a manifestation, then they can save it in their Manifestation section in their User Profile.

19. Search
1. The System will generate an incredible amount of information. It will be crucial to be able to sort through it.
2. Search on TUniverse Screen: When a user clicks in the search bar on the TUniverse home screen it will search for the keyword entered in a drop down menu. A User can select what they wish from the drop down and the system will zoom there. Or the user can click on the menu and open the full list of results. The Home Screen Search searches through and provides results in 3 areas:
   1. Tasks: Will search through Task Variables and return the ones with the most amounts of occurrences across multiple variables with the Task code and description and which variable matched keywords.
   2. Realtime Discussions/Comments: keyword is searched through all the comments and discussions (except THistory and RHistory of others). Results are returned with Task the comment is attached to and the Comment Number and a preview of the comment. These comments are real time comments, i.e. comments that aren't marked completed yet.
   3. Archived Tasks and Discussions: Searches through and returns Task Codes and Comments and one line preview. (Comments include attachments.)
   4. Users: Can Search for Users and returns user names and codes except users who wish to remain private.
3. Search in Admin Master List: Can search list of all Users by any variable with any privacy setting.
4. Reward List Search Organization: Organization can search their list of rewards by name, keywords, and dates.
5. Master Admin Reward and Award Lists: Can search any all awards in system.

20. Task Galaxy
1. A Task Galaxy is a set of concentric circles. Each space between circles (rings) can hold variables (default to dates). Nodes can be created in the rings with the placement being the due date of the task. Tasks can be connected in Task Trees (as explained above) and can span he same ring or across strings. Users have two main types of Galaxies: a Personal Galaxy (PG) and may have one or multiple Org Galaxies that they own or are the leader of (given by an assigned title). Functionality across Galaxies are the same and are as follows:
   1. Zoom Views: Users will have zoom options on the side of the screen that change the scope of each ring. I.e. Each ring can represent 1 Year, 6 months, 3 Months, 1 Month, 1 Week. 1 day, 1 Hour. As each view is selected, the Task Trees are either collapsed, shrunk, expanded. At the furthest viewpoint, only the most complex Tasks will show up in the ring. As the user zooms in, the finer details and the smaller children tasks appear. At the Hourly View all tasks are visible.
   2. Dynamic information display: Users will see different levels of information depending on the zoom level. More significant and larger tasks are more visible as the zoom goes out.
   3. Sections: Users can divide their Personal Galaxy and Organizational Galaxy into sections. Each division opens a new analysis section in the Users Profile. Default Sections for the Personal Galaxy is the following Life Areas.
      1. Physical
      2. Mental
      3. Academic,
      4. Spiritual
      5. Family
      6. Friends
      7. Relationship
      8. Politics
      9. Dreams/Virtues/Global Citizenship
      10. Finances
      11. Hygiene, Basics
   4. Interactivity: Users can be very interactive with Task Galaxies. They are very intuitive and convey a large amount of data intuitively via colors, lines, shapes
      1. Zooming: As mentioned users can select zoom level
      2. Border Dragging: When users click and drag a boarder out, it breaks into smaller rings that represent the next smaller time interval (i.e. if we were at the Year View, then a ring would break into 12 smaller monthly rings). User can then click one of the smaller rings and expand it into its smaller rings (Weeks), then expand one of those rings (into days). Meanwhile all the connections to the Tasks and Task Trees remain intact.
      3. Border Clicking: Clicking on Boarder Highlights it.
      4. Multiple Ring Expansion: If a user holds down Ctrl and selects multiple rings, then all rings will expand if you drag one. If you Hold Shift, it selects a range of rings.
      5. Border double clicking: Ring collapses back down.
      6. Spin Galaxy: If a section is upside down, you can rotate Galaxy
      7. Centre Of Galaxy:
         1. Personal Galaxy: Person Name, Number of Total Tasks Pending: Number of People in Network.
         2. Org Galaxy: Org Name, Number of Total Tasks, Number of Members in Org.
      8. Clicking on Centre of Galaxy: if it is a PG it will pop up the Users Profile. If it is an Org Galaxy, it pops up he Org Profile page as follows:
         1. Group Action Feed:
         2. List of Group Members
         3. List of Users outside the Group working on tasks but no members (e.g. Contractors).
         4. Org Logo
         5. Group Statistics: People, Sections, Number of Tasks pending, Number of Tasks Completed in time frame, Group Wellbeing.
         6. Apply for Membership Button (Request is sent to Org Owner who can reject, accept, or comment back from their THistory to this Users THistory)
      9. Dragging Task Trees: User can click and drag Head ask around and children task will follow it in a fluid way.
      10. No Tree Mixing: Each Task Tree will have an invisible barrier where connected tasks can be a maximum distance from any other task in the Tree. This keeps the Task Tree together and elastic while moving it.
      11. Detail Toggling: Users can toggle whether or not descriptions show above the task nodes.
      12. Node Resizing: As views change and rings are dragged, node size changes. More complex tasks can get larger relative to children, but smaller in regards to space in the ring.
      13. Dragging to different Section: Pop Up notification warning member of Section Change.
      14. Automatic time update: At midnight the rings update and shift out hiding the most outer ring and replacing it with the next ring.
      15. Node Hovering: A “task profile” pops up when a user hovers over a task. This Task Profile Displays:
         1. Task Code
         2. Picture of Owner
         3. Picture of Creator
         4. Owner Title in Organizations
         5. Owner Statistics and TAT Rates
         6. User to User Flow Score
         7. Parent Node Code (if any)
         8. Challenge Score
         9. Task Flow Score with User Profile
         10. Rendition: Shows if task was created from a rendition and where in Rendition Encyclopedia.
         11. Price: If owner has a price for completing.
         12. Due Date: Shows Due Date
         13. Description: Description of node
         14. Notes: User made notes on node.
         15. List of All Variables attached to node: Strength, Dream variables.
         16. Discussions and Comments of Children: Shows several columns. Each Column is one of the discussions in a child node or discussion on that node. User can scroll through the discussions in any of the columns.
         1. Search: User can search the columns for keywords. Comment blocks have date and time of comment, user who made comment, and comment itself, and any attachments. Comments are zoomed to and highlighted.
         17. Clicking on Node: Opens Action Menu with TATs listed and clickable.
         18. Clicking on Node: If it is a parent node, it highlights parent node and all children nodes.
         19. Moving a Parent Task: a notification asking if user wants to just move that one task to a new date or move all connected tasks by same time period or if only certain children nodes should move, pops up. Parent Nodes cannot be pushed ahead of their children nodes.
         20. Colors of Nodes and shape of Nodes: Can change depending on variables set by user.
         21. Annotations Menu: User can select what variables are represented by which attributes (colors, shape etc.)
         22. Clicking on Connecting Task Lines: clicking on a line with initiate the Link TAT and user can create new task on the line connecting two other tasks. Both users who Own the Tasks get sent verifications to their THistory. If they both accept, new node is created.
         23. Pending TAT Nodes: If a task is still awaiting an accept from other involved users, this task glows orange showing other users that it does not exist yet.
         24. Splitting: User can create two new nodes. Until they are confirmed, they are shown linked to Parent Node that was Split, but are orange. Others can still interact with it, but take on the risk that I could be denied.
         25. Open Space: When a user clicks on open spot in a date ring, it automatically highlights that ring displaying information about that date, the number of tasks due that day etc. It also opens the create menu for user to create a new variable if they are not over their pending limit. User can then drag node horizontally in date ring to relocate it. When user drags it over another node, it pops up task profile of other node as it goes by.
         26. Owner In Org Galaxies: Tasks that the User is directly responsible for achieving through direct ownership are glowing in a special way so that user can immediately distinguish which are theirs in the foray.
         27. Toggle Certain Lines: User can toggle whether or not it wants to see immediately connecting nodes (Within A Task Tree), Cross Sector Connections (shows how asks are connected across sections), Galaxy Connections (Shows links between tasks of different Galaxies). Can Toggle to show lines with a maximum amount of ring separation (only show links spanning 3 rings etc.)
         28. Automatic Galaxy Resizing: If there is no free space to import a rendition Task Tree, or to create a new task, the Galaxy will calculate he minimum new space needed and expand the Galaxy by that to ensure no cluttering or overlapping occurs.
         29. Realtime Message bubbles: these are little red bubbles that pop up for 5 seconds or so above a node when a user leaves a comment at that moment that the User is looking at the Galaxy.
   5. 3D Galaxy: A Galaxy can be extended by an extra variable into 3rd space.

21. Task Universe
1. The Task Universe is the space where all Galaxies can intermix and relate to one another and move around in relation to one another.
   1. Migration: Galaxies move closer or further from one another depending on how their Galaxy Flow Scores synchronize. If they are similar and are working on tasks shared somehow, then they migrate closer. If their tasks begin to diverge, they begin to move apart.
   2. Universe Filters: A User can view the universe through certain filters, seeing how close galaxies are in terms of only one or two selected variables for example. Or to separate personal galaxies from org Galaxies. Custom Grouping is where a user can select Galaxies and move them into a grouping to see how they relate relative to that space (Clusters).
   3. Perpendicular Superposition: Galaxies can be directly compared by overlapping them. User selects two Galaxies and clicks superimpose, where one is layered horizontal and the other is perpendicular vertical with the centres aligned.
   4. Navigation Menu: Users can navigate across the Universe using a map with a small view window to show how much of the Universe they are seeing relative to the whole. It also shows where in the Universe they are given their current filter.
   5. Boarders: Different industries or cultures can form between Galaxies that can define a space that can be easily identified.

22. To-Do List:
1. Users can select the List Option to show all their tasks that they own or their Org Galaxy Owns in List format. He list shows the status of each Task as a Row and each column as a variable of the task including pending Task Actions that have yet to be confirmed or denied or modified in THistory.
   1. Personal List: showing all asks user owns
   2. Org Galaxy: A list for each organization user owns.

23. Admin System
1. Shows entire List of Users in the System or in Org
2. Action Menu Settings: Can control if new variables will be implemented into Action Menu

I claim:

1. A computer implemented method for aiding a user of a plurality of users in achieving a flow state while using a scheduling system in real-time, comprising:
receiving information from the user over a communication network;
creating a user profile in a database based on the information from the user;
determining one or more user variables based on the user profile;
storing at least one task on a server, each task having one or more demand variables associated therewith and
matching the user with a suggested task of the at least one task using task flow rules that maximize a flow score as a function of at least the one or more user variables and the one or more demand variables associated with the at least one task to increase the probability of the user to achieve the flow state,
wherein each of the user variables and demand variables are defined by a set of dialectical points comprising a first point representing a specific user or demand variable, a second point representing the opposite of the specific user or demand variable, a synthesis point representing the synthesis of the first and second points, and at least one intermediate point representing intermediates between the first and second points; and
wherein the task flow rules maximize the flow score as a function of at least a first set of dialectical points associated with the one or more user variables and a second set of dialectical points associated with the one or more demand variables.

2. The method of claim 1, wherein the one or more user variables comprise strength variables having data regarding the user's skills, proficiencies, intelligence, and talents, and dream variables having data regarding the user's personality, preferences, and interests.

3. The method of claim 1, wherein the one or more demand variables comprise data regarding the required skills, complexity, difficulty, and urgency of the corresponding task.

4. The method of claim 3, wherein the synthesis point can form the first point of a new set of dialectical points associated with another user variable or demand variable.

5. The method of claim 1, wherein the at least one task is created by the plurality of users.

6. The method of claim 1, further comprising the step of administering an incentive system for encouraging the user to perform task actions in the scheduling system, wherein the task actions comprise at least one of the following task action types: creating a task, completing a task, providing evidence of task completion, splitting a task, linking a first task with a second task, transferring ownership of a task to another user, pushing back a deadline of the task, or commenting with respect to a task.

7. The method of claim 6, wherein the step of administering an incentive system further comprises awarding points to the user for performing task actions.

8. The method of claim 7, wherein the step of administering an incentive system further comprises adjusting a point award value associated with each of the task action types if real-time based on the number of each task action type performed by the plurality of users.

9. The method of claim 1, wherein the step of administering an incentive system further comprises adjusting a point award value associated with each of the task action types in real-time based on the number of times the user has performed each task action type.

10. The method of claim 1, further comprising displaying to the user a plurality of concentric rings, each ring corresponding to a time period, and a plurality of nodes, each node corresponding to one of the at least one task and located on a corresponding ring associated with a deadline of the task.

11. The method of claim 10, wherein the rings closer to the center of the plurality of concentric rings represent time periods further in the future.

12. The method of claim 11. wherein the plurality of concentric rings comprises multiple pluralities of concentric rings.

13. The method of claim 12, further comprising visually associating nodes corresponding to related tasks.

14. The method of claim 1, further comprising displaying to the user a plurality of concentric spheres, each sphere corresponding to a time period, and a plurality of nodes, each note corresponding to one of the at least one task and located on the surface of a corresponding sphere associated with a deadline of the task.

15. The method of claim 14, wherein the spheres closer to the center of the plurality of concentric spheres represent time periods further in the future.

16. The method of claim 15, wherein the plurality of concentric spheres comprises multiple pluralities of concentric spheres.

17. The method of claim 16, further comprising visually associating nodes corresponding to related tasks.

18. The method of claim 1, further comprising suggesting a group to the user, the group comprising the user and one or more suggested users of the plurality of users, using people flow rules that maximize a people flow score as a function of the at least one or more user variables of each of the plurality of users to increase the probability of the user and the one or more suggested users to achieve flow states.

19. A scheduling system for aiding a user of a plurality of risers in achieving a flow state in real-time, comprising:
receiving information from the user over a communication network;
creating a user profile in a database based on the information from the user;
determining one or more user variables based on the user profile;
storing at least one task on a server, each task having one or more demand variables associated therewith; and
matching the user with a suggested task of the at least one task using task flow rules that maximize a flow score as a function of at least the one or more user variables and the one or more demand variables associated with the at least one task to increase the probability of the user to achieve the flow state;
wherein each of the user variables and demand variables are defined by a set of dialectical points comprising a first point representing a specific user or demand variable, a second point representing the opposite of the specific user or demand variable, a synthesis point representing the synthesis of the first and second points, and at least one intermediate point representing intermediates between the first and second points; and
wherein the task flow rules maximize the flow score as a function of at least a first set of dialectical points associated with the one or more user variables and a second set of dialectical points associated with the one or more demand variables.

20. The scheduling system of claim 19, wherein the computer system further comprises machine-readable instructions for administering an incentive system for encouraging the user to perform task actions in the scheduling system.
